(19) United States
(12) Patent Application Publication
(10) Pub. No.: US 2026/0288159 A1
(43) Pub. Date: Sep. 24, 2026

(54) MOVEMENT AND MANAGEMENT OF PILED GRANULAR MATERIAL

(71) Applicant: Grain Weevil Corporation, La Vista, NE (US)

(72) Inventors: Cole Oswald, Aurora, NE (US); Travis Vanderheyden, Omaha, NE (US); Ryan Baker, Bennington, NE (US); Preston Parmley, Valley, NE (US); Benjamin H. Johnson, Omaha, NE (US); Chad E. Johnson, Omaha, NE (US)

(73) Assignee: Grain Weevil Corporation, La Vista, NE (US)

(21) Appl. No.: 19/686,660

(22) Filed: May 23, 2026

Related U.S. Application Data
(63) Continuation-in-part of application No. 19/077,443, filed on Mar. 12, 2025.
(63) Continuation-in-part of application No. 19/078,006, filed on Mar. 12, 2025.
Application No. 19/078,006 is a continuation-in-part of application No. 18/923,554, filed on Oct. 22, 2024.
Application No. 18/923,554 is a continuation-in-part of application No. 18/800,047, filed on Aug. 10, 2024.
Application No. 18/800,047 is a continuation-in-part of application No. 18/316,393, filed on May 12, 2023, now Pat. No. 12,576,374.
Application No. 18/316,393 is a continuation-in-part of application No. 17/195,021, filed on Mar. 8, 2021, now Pat. No. 12,037,185.
Application No. 17/195,021 is a continuation-in-part of application No. 17/982,590, filed on Nov. 8, 2022, now Pat. No. 11,858,145.
Application No. 19/078,006 is a continuation-in-part of application No. 18/317,072, filed on May 13, 2023, now Pat. No. 12,564,138.
Application No. 18/317,072 is a continuation-in-part of application No. 17/195,021, filed on Mar. 8, 2021, now Pat. No. 12,037,185.
Application No. 17/195,021 is a continuation-in-part of application No. 17/982,590, filed on Nov. 8, 2022, now Pat. No. 11,858,145.
Application No. 19/078,006 is a continuation-in-part of application No. 18/317,074, filed on May 13, 2023, now Pat. No. 12,576,526.
Application No. 18/317,074 is a continuation-in-part of application No. 17/195,021, filed on Mar. 8, 2021, now Pat. No. 12,037,185.
Application No. 17/195,021 is a continuation-in-part of application No. 17/982,590, filed on Nov. 8, 2022, now Pat. No. 11,858,145.
Application No. 19/078,006 is a continuation-in-part of application No. 18/317,998, filed on May 16, 2023, now Pat. No. 12,642,187.
Application No. 18/317,998 is a continuation-in-part of application No. 17/195,021, filed on Mar. 8, 2021, now Pat. No. 12,037,185.
Application No. 17/195,021 is a continuation-in-part of application No. 17/982,590, filed on Nov. 8, 2022, now Pat. No. 11,858,145.
(63) Continuation-in-part of application No. 17/983,505, filed on Nov. 9, 2022.
Application No. 17/983,505 is a continuation-in-part of application No. 17/195,021, filed on Mar. 8, 2021, now Pat. No. 12,037,185.
Application No. 19/078,006 is a continuation-in-part of application No. 18/377,471, filed on Oct. 6, 2023, now Pat. No. 12,269,168.
Application No. 18/377,471 is a continuation-in-part of application No. 17/982,590, filed on Nov. 8, 2022, now Pat. No. 11,858,145.
Application No. 19/078,006 is a continuation-in-part of application No. 18/377,414, filed on Oct. 6, 2023, now Pat. No. 12,269,167.
Application No. 18/377,414 is a continuation-in-part of application No. 17/982,590, filed on Nov. 8, 2022, now Pat. No. 11,858,145.
Application No. 17/982,590 is a continuation-in-part of application No. 17/195,021, filed on Mar. 8, 2021, now Pat. No. 12,037,185.
Application No. 19/078,006 is a continuation-in-part of application No. 18/650,523, filed on Apr. 30, 2024, now Pat. No. 12,566,457.
Application No. 18/650,523 is a continuation-in-part of application No. 17/195,021, filed on Mar. 8, 2021, now Pat. No. 12,037,185.
Application No. 19/078,006 is a continuation-in-part of application No. 18/652,204, filed on May 1, 2024.
Application No. 18/652,204 is a continuation-in-part of application No. 17/195,021, filed on Mar. 8, 2021, now Pat. No. 12,037,185.
(60) Provisional application No. 62/987,311, filed on Mar. 9, 2020.
(60) Provisional application No. 63/277,232, filed on Nov. 9, 2021.
(60) Provisional application No. 63/277,232, filed on Nov. 9, 2021.
(60) Provisional application No. 63/320,791, filed on Mar. 17, 2022.
(60) Provisional application No. 63/343,141, filed on May 18, 2022.
(60) Provisional application No. 63/343,141, filed on May 18, 2022.
(60) Provisional application No. 63/343,141, filed on May 18, 2022.
(60) Provisional application No. 63/343,141, filed on May 18, 2022.
(60) Provisional application No. 63/532,371, filed on Aug. 12, 2023.
(60) Provisional application No. 63/545,793, filed on Oct. 26, 2023.
(60) Provisional application No. 63/761,731, filed on Feb. 21, 2025.
(60) Provisional application No. 63/761,731, filed on Feb. 21, 2025.
(60) Provisional application No. 63/812,175, filed on May 26, 2025.
(60) Provisional application No. 63/812,180, filed on May 26, 2025.

(51) Int. Cl. G05D 1/648; B62D 57/04; B65D 88/54; B65G 69/04; G05D 1/689; G05D 107/50; G05D 109/10

(52) U.S. Cl. CPC G05D 1/6486; B62D 57/04; B65G 69/0433; G05D 1/6895; B65D 88/54; B65G 2201/042; B65G 2814/0264; G05D 2107/50; G05D 2109/135

(57) ABSTRACT

A method of moving granular material involves positioning the robotic device proximate to the pile of granular material, wherein the robotic device comprises a body, an auger-based drive system with a plurality of augers configured to propel and maneuver the device, and an auger payload coupled to the body. The auger payload includes a rotatable auger component and a motorized system configured to control the rotation of the rotatable auger component. The method further includes orienting the rotatable auger component substantially parallel to the slope of the pile, rotating the rotatable auger component in a first direction to engage the granular material, and agitating the granular material via the rotation of the rotatable auger component to incite sediment gravity flow. The engaged granular material is discharged downslope from the rotatable auger component, triggering additional sediment gravity flow or avalanche of the granular material on the pile.

### REFERENCE TO RELATED APPLICATIONS

This application claims priority to and benefit of co-pending U.S. Provisional Patent Application No. 63/812,175 filed on May 26, 2025 entitled “MANAGEMENT OF PILED GRANULAR MATERIAL” by Vanderheyden et al., having Attorney Docket No. GWC-017-PR, and assigned to the assignee of the present application, the disclosure of which is hereby incorporated herein by reference in its entirety.

This application claims priority to and benefit of co-pending U.S. Provisional Patent Application No. 63/812,180 filed on May 26, 2025 entitled “MANAGEMENT OF PILED GRANULAR MATERIAL” by Vanderheyden et al., having Attorney Docket No. GWC-017-PR2, and assigned to the assignee of the present application, the disclosure of which is hereby incorporated herein by reference in its entirety.

This application is a continuation-in-part application of and claims priority to and benefit of co-pending U.S. patent application Ser. No. 19/077,443 filed on Mar. 12, 2025 entitled “MANAGEMENT OF PILED GRANULAR MATERIAL WITH VERTICAL SURFACE PROJECTIONS” by Vanderheyden et al., having Attorney Docket No. GWC-016-01, and assigned to the assignee of the present application, the disclosure of which is hereby incorporated herein by reference in its entirety.

U.S. patent application Ser. No. 19/077,443 claims priority to and benefit of then co-pending U.S. Provisional Patent Application No. 63/761,731 filed on Feb. 21, 2025 entitled “MANAGEMENT OF PILED GRANULAR MATERIAL WITH VERTICAL SURFACE PROJECTIONS” by Vanderheyden et al., having Attorney Docket No. GWC-016-PR, and assigned to the assignee of the present application, the disclosure of which is hereby incorporated herein by reference in its entirety.

This application is a continuation-in-part application of and claims priority to and Entitled “MANAGEMENT OF PILED GRANULAR MATERIAL WITH VERTICAL SURFACE PROJECTIONS” by Vanderheyden et al., having Attorney Docket No. GWC-016-02, and assigned to the assignee of the present application, the disclosure of which is hereby incorporated herein by reference in its entirety.

U.S. patent application Ser. No. 19/078,006 claims priority to and benefit of then co-pending U.S. Provisional Patent Application No. 63/761,731 filed on Feb. 21, 2025 entitled “MANAGEMENT OF PILED GRANULAR MATERIAL WITH VERTICAL SURFACE PROJECTIONS” by Vanderheyden et al., having Attorney Docket No. GWC-016-PR, and assigned to the assignee of the present application, the disclosure of which is hereby incorporated herein by reference in its entirety.

U.S. patent application Ser. No. 19/078,006 is a continuation-in-part application of and claims priority to and benefit of co-pending U.S. patent application Ser. No. 18/923,554 filed on Oct. 22, 2024, entitled “ROBOT WITH ARTICULABLE FLAP FOR MOVING GRANULAR MATERIAL” by Travis Vanderheyden, et al., having Attorney Docket No. GWC-015, and assigned to the assignee of the present application, the disclosure of which is hereby incorporated herein by reference in its entirety.

U.S. patent application Ser. No. 18/923,554 claims priority to and benefit of co-pending U.S. Provisional Patent Application No. 63/545,793 filed on Oct. 26, 2023 entitled “ROBOT WITH ARTICULABLE FLAP FOR MOVING GRANULAR MATERIAL” by Travis Vanderheyden, et al., having Attorney Docket No. GWC-015-PR, and assigned to the assignee of the present application, the disclosure of which is hereby incorporated herein by reference in its entirety.

U.S. patent application Ser. No. 18/923,554 is a continuation-in-part application of and claims priority to and benefit of co-pending U.S. patent application Ser. No. 18/800,047 filed on Aug. 10, 2024, entitled “ROBOT WITH INTERCHANGEABLE DRIVE SYSTEM” by Travis Vanderheyden, et al., having Attorney Docket No. GWC-014, and assigned to the assignee of the present application, the disclosure of which is hereby incorporated herein by reference in its entirety.

U.S. patent application Ser. No. 18/800,047 claims priority to and benefit of then co-pending U.S. Provisional Patent Application 63/532,371 filed on Aug. 12, 2023 entitled “ROBOT WITH INTERCHANGEABLE DRIVE SYSTEM” by Juan Manuel Bogado Torres, et al., having Attorney Docket No. GWC-014-PR, and assigned to the assignee of the present application, the disclosure of which is hereby incorporated herein by reference in its entirety.

U.S. patent application Ser. No. 18/800,047 is a continuation-in-part application of and claims priority to and benefit of co-pending U.S. patent application Ser. No. 18/316,393 (now U.S. Pat. No. 12,576,374) filed on May 12, 2023, entitled “GRAIN BIN MANAGEMENT DURING LOAD-IN” by Benjamin H. Johnson et al., having Attorney Docket No. GWC-009, and assigned to the assignee of the present application, the disclosure of which is hereby incorporated herein by reference in its entirety.

U.S. patent application Ser. No. 18/316,393 claims priority to and benefit of then co-pending U.S. Provisional Patent Application No. 63/343,141 filed on May 18, 2022 entitled “Grain Bin Management” by Benjamin H. Johnson et al., having Attorney Docket No. GWC-009-PR, and assigned to the assignee of the present application, the disclosure of which is hereby incorporated herein by reference in its entirety.

U.S. patent application Ser. No. 18/316,393 is a continuation-in-part application of and claims priority to and benefit of then co-pending U.S. patent application Ser. No. 17/195,021 (now U.S. Pat. No. 12,037,185) filed on Mar. 8, 2021, entitled “Bulk Store Slope Adjustment” by Benjamin H. Johnson et al., having Attorney Docket No. GWC-001, and assigned to the assignee of the present application, the disclosure of which is hereby incorporated herein by reference in its entirety.

U.S. patent application Ser. No. 18/316,393 is a continuation-in-part application of and claims priority to and benefit of then co-pending U.S. patent application Ser. No. 17/982,590 (now U.S. Pat. No. 11,858,145) filed on Nov. 8, 2022, entitled “SURFACE MANAGEMENT OF PILED GRAIN” by Benjamin H. Johnson et al., having Attorney Docket No. GWC-003, and assigned to the assignee of the present application, the disclosure of which is hereby incorporated herein by reference in its entirety.

U.S. patent application Ser. No. 19/078,006 is a continuation-in-part application of and claims priority to and benefit of co-pending U.S. patent application Ser. No. 18/317,072 (now U.S. Pat. No. 12,564,138) filed on May 13, 2023, entitled “GRAIN BIN MANAGEMENT DURING GRAIN STORAGE” by Benjamin H. Johnson et al., having Attorney Docket No. GWC-010, and assigned to the assignee of the present application, the disclosure of which is hereby incorporated herein by reference in its entirety.

U.S. patent application Ser. No. 18/317,072 claims priority to and benefit of then co-pending U.S. Provisional Patent Application No. 63/343,141 filed on May 18, 2022 entitled “Grain Bin Management” by Benjamin H. Johnson et al., having Attorney Docket No. GWC-009-PR, and assigned to the assignee of the present application, the disclosure of which is hereby incorporated herein by reference in its entirety.

U.S. patent application Ser. No. 18/317,072 is a continuation-in-part application of and claims priority to and benefit of then co-pending U.S. patent application Ser. No. 17/195,021 (now U.S. Pat. No. 12,037,185) filed on Mar. 8, 2021, entitled “Bulk Store Slope Adjustment” by Benjamin H. Johnson et al., having Attorney Docket No. GWC-001, and assigned to the assignee of the present application, the disclosure of which is hereby incorporated herein by reference in its entirety.

U.S. patent application Ser. No. 18/317,072 is a continuation-in-part application of and claims priority to and benefit of then co-pending U.S. patent application Ser. No. 17/982,590 (now U.S. Pat. No. 11,858,145) filed on Nov. 8, 2022, entitled “SURFACE MANAGEMENT OF PILED GRAIN” by Benjamin H. Johnson et al., having Attorney Docket No. GWC-003, and assigned to the assignee of the present application, the disclosure of which is hereby incorporated herein by reference in its entirety.

U.S. patent application Ser. No. 19/078,006 is a continuation-in-part application of and claims priority to and benefit of co-pending U.S. patent application Ser. No. 18/317,074 (now U.S. Pat. No. 12,576,526) filed on May 13, 2023, entitled “ROBOTIC GRAIN WALK DOWN IN A FLAT STORAGE BULK STORE” by Benjamin H. Johnson et al., having Attorney Docket No. GWC-011, and assigned to the assignee of the present application, the disclosure of which is hereby incorporated herein by reference in its entirety.

U.S. patent application Ser. No. 18/317,074 claims priority to and benefit of then co-pending U.S. Provisional Patent Application No. 63/343,141 filed on May 18, 2022 entitled “Grain Bin Management” by Benjamin H. Johnson et al., having Attorney Docket No. GWC-009-PR, and assigned to the assignee of the present application, the disclosure of which is hereby incorporated herein by reference in its entirety.

U.S. patent application Ser. No. 18/317,074 is a continuation-in-part application of and claims priority to and benefit of then co-pending U.S. patent application Ser. No. 17/195,021 (now U.S. Pat. No. 12,037,185) filed on Mar. 8, 2021, entitled “Bulk Store Slope Adjustment” by Benjamin H. Johnson et al., having Attorney Docket No. GWC-001, and assigned to the assignee of the present application, the disclosure of which is hereby incorporated herein by reference in its entirety.

U.S. patent application Ser. No. 18/317,074 is a continuation-in-part application of and claims priority to and benefit of then co-pending U.S. patent application Ser. No. 17/982,590 (now U.S. Pat. No. 11,858,145) filed on Nov. 8, 2022, entitled “SURFACE MANAGEMENT OF PILED GRAIN” by Benjamin H. Johnson et al., having Attorney Docket No. GWC-003, and assigned to the assignee of the present application, the disclosure of which is hereby incorporated herein by reference in its entirety.

U.S. patent application Ser. No. 19/078,006 is a continuation-in-part application of and claims priority to and benefit of co-pending U.S. patent application Ser. No. 18/317,998 filed on May 16, 2023, entitled “GRAIN MANAGEMENT IN A BULK STORE” by Benjamin H. Johnson et al., having Attorney Docket No. GWC-012, and assigned to the assignee of the present application, the disclosure of which is hereby incorporated herein by reference in its entirety.

U.S. patent application Ser. No. 18/317,998 claims priority to and benefit of then co-pending U.S. Provisional Patent Application No. 63/343,141 filed on May 18, 2022 entitled “Grain Bin Management” by Benjamin H. Johnson et al., having Attorney Docket No. GWC-009-PR, and assigned to the assignee of the present application, the disclosure of which is hereby incorporated herein by reference in its entirety.

U.S. patent application Ser. No. 18/317,998 is a continuation-in-part application of and claims priority to and benefit of then co-pending U.S. patent application Ser. No. 17/195,021 (now U.S. Pat. No. 12,037,185) filed on Mar. 8, 2021, entitled “Bulk Store Slope Adjustment” by Benjamin H. Johnson et al., having Attorney Docket No. GWC-001, and assigned to the assignee of the present application, the disclosure of which is hereby incorporated herein by reference in its entirety.

U.S. patent application Ser. No. 18/317,998 is a continuation-in-part application of and claims priority to and benefit of then co-pending U.S. patent application Ser. No. 17/982,590 (now U.S. Pat. No. 11,858,145) filed on Nov. 8, 2022, entitled “SURFACE MANAGEMENT OF PILED GRAIN” by Benjamin H. Johnson et al., having Attorney Docket No. GWC-003, and assigned to the assignee of the present application, the disclosure of which is hereby incorporated herein by reference in its entirety.

This application is a continuation-in-part application of and claims priority to and benefit of co-pending U.S. patent application Ser. No. 17/983,505 filed on Nov. 9, 2022, entitled “MAPPING PILED GRANULAR MATERIAL IN A BULK STORE” by Benjamin H. Johnson et al., having Attorney Docket No. GWC-002, and assigned to the assignee of the present application, the disclosure of which is hereby incorporated herein by reference in its entirety.

U.S. patent application Ser. No. 17/983,505 is a continuation-in-part application of and claims priority to and benefit of then co-pending U.S. patent application Ser. No. 17/195,021 (now U.S. Pat. No. 12,037,185) filed on Mar. 8, 2021, entitled “Bulk Store Slope Adjustment” by Benjamin H. Johnson et al., having Attorney Docket No. GWC-001, and assigned to the assignee of the present application, the disclosure of which is hereby incorporated herein by reference in its entirety.

U.S. patent application Ser. No. 17/983,505 claims priority to and benefit of then co-pending U.S. Provisional Patent Application No. 63/277,232 filed on Nov. 9, 2021, entitled “PRECISE PAYLOAD DELIVERY RELATIVE TO PILED GRANULAR MATERIAL” by Benjamin H. Johnson et al., having Attorney Docket No. GWC-003-PR, and assigned to the assignee of the present application, the disclosure of which is hereby incorporated herein by reference in its entirety.

U.S. patent application Ser. No. 17/983,505 claims priority to and benefit of then co-pending U.S. Provisional Patent Application No. 63/320,791 filed on Mar. 17, 2022, entitled “MAPPING PILED GRANULAR MATERIAL IN A BULK STORE” by Benjamin H. Johnson et al., having Attorney Docket No. GWC-002-PR, and assigned to the assignee of the present application, the disclosure of which is hereby incorporated herein by reference in its entirety.

U.S. patent application Ser. No. 19/078,006 is a continuation-in-part application of and claims priority to and benefit of co-pending U.S. patent application Ser. No. 18/377,471 filed on Oct. 6, 2023, entitled “INCITING SEDIMENT GRAVITY FLOW IN PILED GRAIN” by Zane Zents et al., having Attorney Docket No. GWC-003-CON2, and assigned to the assignee of the present application, the disclosure of which is hereby incorporated herein by reference in its entirety.

U.S. patent application Ser. No. 18/377,471 is a continuation application of and claims priority to and benefit of then co-pending U.S. patent application Ser. No. 17/982,590 (now U.S. Pat. No. 11,858,145) filed on Nov. 8, 2022, entitled “SURFACE MANAGEMENT OF PILED GRAIN” by Benjamin H. Johnson et al., having Attorney Docket No. GWC-003, and assigned to the assignee of the present application, the disclosure of which is hereby incorporated herein by reference in its entirety.

U.S. patent application Ser. No. 19/078,006 is a continuation-in-part application of and claims priority to and benefit of co-pending U.S. patent application Ser. No. 18/377,414 filed on Oct. 6, 2023, entitled “SURFACE MANAGEMENT OF PILED GRANULAR MATERIAL” by Benjamin H. Johnson et al., having Attorney Docket No. GWC-003-CON1, and assigned to the assignee of the present application, the disclosure of which is hereby incorporated herein by reference in its entirety.

U.S. patent application Ser. No. 18/377,414 is a continuation application of and claims priority to and benefit of then co-pending U.S. patent application Ser. No. 17/982,590 (now U.S. Pat. No. 11,858,145) filed on Nov. 8, 2022, entitled “SURFACE MANAGEMENT OF PILED GRAIN” by Benjamin H. Johnson et al., having Attorney Docket No. GWC-003, and assigned to the assignee of the present application, the disclosure of which is hereby incorporated herein by reference in its entirety.

U.S. patent application Ser. No. 17/982,590 claims priority to and benefit of then co-pending U.S. Provisional Patent Application No. 63/277,232 filed on Nov. 9, 2021, entitled “PRECISE PAYLOAD DELIVERY RELATIVE TO PILED GRANULAR MATERIAL” by Benjamin H. Johnson et al., having Attorney Docket No. GWC-003-PR, and assigned to the assignee of the present application, the disclosure of which is hereby incorporated herein by reference in its entirety.

U.S. patent application Ser. No. 17/982,590 is a continuation-in-part application of and claims priority to and benefit of then co-pending U.S. patent application Ser. No. 17/195,021 (now U.S. Pat. No. 12,037,185) filed on Mar. 8, 2021, entitled “Bulk Store Slope Adjustment” by Benjamin H. Johnson et al., having Attorney Docket No. GWC-001, and assigned to the assignee of the present application, the disclosure of which is hereby incorporated herein by reference in its entirety.

U.S. patent application Ser. No. 19/078,006 is a continuation-in-part application of and claims priority to and benefit of co-pending U.S. patent application Ser. No. 18/650,523 filed on Apr. 30, 2024, entitled “BULK STORE SLOPE ADJUSTMENT VIA TRAVERSAL INCITED SEDIMENT GRAVITY FLOW” by Benjamin H. Johnson et al., having Attorney Docket No. GWC-001-CON1, and assigned to the assignee of the present application, the disclosure of which is hereby incorporated herein by reference in its entirety.

U.S. patent application Ser. No. 18/650,523 is a continuation application of and claims priority to and benefit of then co-pending U.S. patent application Ser. No. 17/195,021 (now U.S. Pat. No. 12,037,185) filed on Mar. 8, 2021 entitled “BULK STORE SLOPE ADJUSTMENT” by Benjamin H. Johnson et al., having Attorney Docket No. GWC-001, and assigned to the assignee of the present application, the disclosure of which is hereby incorporated herein by reference in its entirety.

U.S. patent application Ser. No. 19/078,006 is a continuation-in-part application of and claims priority to and benefit of co-pending U.S. patent application Ser. No. 18/652,204 filed on May 1, 2024, entitled “TRAVERSAL BASED MIXTURE OF MOIST GRANULAR MATERIAL IN A BULK STORE” by Benjamin H. Johnson et al., having Attorney Docket No. GWC-001-CON2, and assigned to the assignee of the present application, the disclosure of which is hereby incorporated herein by reference in its entirety.

U.S. patent application Ser. No. 18/652,204 is a continuation application of and claims priority to and benefit of then co-pending U.S. patent application Ser. No. 17/195,021 (now U.S. Pat. No. 12,037,185) filed on Mar. 8, 2021 entitled “BULK STORE SLOPE ADJUSTMENT” by Benjamin H. Johnson et al., having Attorney Docket No. GWC-001, and assigned to the assignee of the present application, the disclosure of which is hereby incorporated herein by reference in its entirety.

U.S. patent application Ser. No. 17/195,021 claims priority to and benefit of then co-pending U.S. Provisional Patent Application No. 62/987,311 filed on Mar. 9, 2020, entitled “METHOD AND APPARATUS FOR SAFE GRAIN BIN/SILO GRAIN EXTRACTION ASSISTANCE” by Benjamin H. Johnson et al., having Attorney Docket No. JLI-001-PRO, and assigned to the assignee of the present application, the disclosure of which is hereby incorporated herein by reference in its entirety.

### BACKGROUND

Some examples of granular material include, without limitation: grain (e.g., small hard and typically edible seeds or beans such as soybean seeds, peas, garbanzo beans, pinto beans, corn kernels, wheat, rice, etc.), non-grain plant seeds (e.g., flower seeds and grass seeds), nuts (e.g., shelled or unshelled tree nuts or ground nuts), nut shells, sand, animal litter, concrete mix, cement, dry fertilizer, pelletized products (e.g., wood pellets, plastic pellets, hemp pellets, fish food pellets, etc.) and granular milled/ground products (e.g., flour, soy meal, sugar, coffee, cocoa, guar gum, sodium bicarbonate, alumina, and granular mineral/rock aggregates/products, etc.). Granular material is often piled in a bulk store, either in the open or in a container such as a bin. Bulk stores, such as grain bins, are often hot, dirty, dusty, and dangerous workplaces. To adequately manage bulk stored granular materials, farmers and/or other workers are required to enter bulk stores and/or climb about on the surface of a pile of the bulk stored granular material. Such interactions expose the farmer/worker to falls, entrapments, explosions, auger entanglements, heat stroke, and long-term conditions such as Farmer's Lung.

### BRIEF DESCRIPTION OF THE DRAWINGS

The accompanying drawings, which are incorporated in and form a part of the Description of Embodiments, illustrate various embodiments of the subject matter and, together with the Description of Embodiments, serve to explain principles of the subject matter discussed below. Unless specifically noted, the drawings referred to in this Brief Description of Drawings should be understood as not being drawn to scale. Herein, like items are labeled with like item numbers.

FIG. 1 shows an example block diagram of some aspects of a device that moves about and/or operates in relation to a pile of granular material, in accordance with various embodiments.

FIG. 2 shows a block diagram of a collection of sensors, any or all of which may be incorporated into the device of FIG. 1, in accordance with various embodiments.

FIG. 3 shows a block diagram of a collection of payloads, any or all of which may be incorporated into the device of FIG. 1, in accordance with various embodiments.

FIGS. 4A-1, 4A-2, and 4A-3 illustrate front elevational views of the exterior of a device that moves about and/or operates in relation to a pile of granular material, in accordance with various embodiments.

FIGS. 4B-1 and 4B-2 illustrate rear elevational views of the exterior of a device that moves about and/or operates in relation to a pile of granular material, in accordance with various embodiments.

FIGS. 4C-1 and 4C-2 illustrate right elevational views of the exterior of a device that moves about and/or operates in relation to a pile of granular material, in accordance with various embodiments.

FIGS. 4D-1 and 4D-2 illustrate left elevational views of the exterior of a device that moves about and/or operates in relation to a pile of granular material, in accordance with various embodiments.

FIGS. 4E-1 and 4E-2 illustrate bottom plan views of the exterior of a device that moves about and/or operates in relation to a pile of granular material, in accordance with various embodiments.

FIG. 4F illustrates a top plan view of the exterior of a device that moves about and/or operates in relation to a pile of granular material, along with a chart illustrating directional movements, in accordance with various embodiments.

FIG. 4G illustrates an upper front right perspective view of the exterior of a device that moves about and/or operates in relation to a pile of granular material, in accordance with various embodiments.

FIG. 4H illustrates an upper front right perspective view of the exterior of a device that moves about and/or operates in relation to a pile of granular material and that includes a separate auger payload/implement, in accordance with various embodiments.

FIG. 4I illustrates an upper front right perspective view of the exterior of a device that moves about and/or operates in relation to a pile of granular material and that includes a separate broom payload/implement, in accordance with various embodiments.

FIG. 4J illustrates a side elevational view of the exterior of a device which moves about and/or operates in relation to a pile of granular material and which includes a separate shovel payload/implement, in accordance with various embodiments.

FIG. 5 illustrates some example embodiments of a bulk store slope adjustment system, in accordance with various embodiments.

FIG. 6 illustrates some example embodiments of a bulk store slope adjustment system, in accordance with various embodiments.

FIG. 7A illustrates an example bulk store for granular material, in accordance with various embodiments.

FIG. 7B illustrates a side sectional view A-A of an example bulk store for granular material which shows a device moving about and/or operating in relation to a portion of piled granular material in the bulk store, in accordance with various embodiments.

FIG. 7C illustrates a top sectional view B-B of an example bulk store for granular material which shows a device moving about and/or operating in relation to a portion of piled granular material in the bulk store, in accordance with various embodiments.

FIG. 7D illustrates a top sectional view B-B of an example bulk store for granular material which shows a pattern for moving a device about and/or operating in relation to a portion of piled granular material in the bulk store, in accordance with various embodiments.

FIG. 7E illustrates a top sectional view B-B of an example bulk store for granular material which shows a pattern for moving a device about and/or operating in relation to a portion of piled granular material in the bulk store, in accordance with various embodiments.

FIG. 7F illustrates a top sectional view B-B of an example bulk store for granular material which shows a pattern for moving a device about and/or operating in relation to a portion of piled granular material in the bulk store, in accordance with various embodiments.

FIG. 7G illustrates a side sectional view A-A of an example bulk store for granular material which shows a device moving about and/or operating in relation to a portion of piled granular material in the bulk store, in accordance with various embodiments.

FIG. 7H illustrates a side sectional view A-A of an example bulk store for granular material which shows a device moving about and/or operating in relation to a portion of piled granular material in the bulk store, in accordance with various embodiments.

FIG. 7I illustrates a side sectional view A-A of an example bulk store for granular material which shows a device moving about and/or operating in relation to a portion of piled granular material in the bulk store, in accordance with various embodiments.

FIG. 7J illustrates a side sectional view A-A of an example bulk store for granular material which shows a device moving about and/or operating in relation to a portion of piled granular material in the bulk store, in accordance with various embodiments.

FIG. 7K illustrates a side sectional view A-A of an example bulk store for granular material which shows a device moving about and/or operating in relation to a portion of piled granular material in the bulk store, in accordance with various embodiments.

FIG. 7L illustrates a side sectional view A-A of an example bulk store for granular material which shows a device moving about and/or operating in relation to a portion of piled granular material in the bulk store, in accordance with various embodiments.

FIGS. 8A-8E illustrate a flow diagram of an example method of bulk store slope adjustment, in accordance with various embodiments.

FIGS. 9A-9H illustrate diagrams of a granular material management robot with an interchangeable drive system, in accordance with various embodiments.

FIGS. 9I-9K illustrate diagrams of a granular material management robot with an interchangeable drive system and a variety of payload implements, in accordance with various embodiments.

FIG. 10A illustrates a side elevational view of a bulk store for granular material, according to various embodiments.

FIG. 10B shows the side section view C-C of the bulk store of FIG. 10A in an empty state, according to various embodiments.

FIG. 10C illustrates a diagram of a granular material management robot using an auger attachment to manage a pile of granular material, in accordance with various embodiments.

FIG. 10D illustrates the pile of granular material of FIG. 10A after management by a granular material management robot using an auger attachment, in accordance with various embodiments.

FIGS. 11A-11D illustrate diagrams of a granular material management robot with an interchangeable drive system and a variety of interchangeable payload implements being used for cleanout tasks in a bulk store for granular material, in accordance with various embodiments.

FIGS. 12A-12D illustrate a flow diagram of an example method of moving granular material.

FIG. 13 illustrates a flow diagram of an example method of cleanout operations in a bulk store.

FIG. 14 illustrates a flow diagram of an example method of cleanout operations in a bulk store.

### DETAILED DESCRIPTION

Reference will now be made in detail to various embodiments of the subject matter, examples of which are illustrated in the accompanying drawings. While various embodiments are discussed herein, it will be understood that they are not intended to limit them to these embodiments. On the contrary, the presented embodiments are intended to cover alternatives, modifications, and equivalents, which may be included within the spirit and scope of the various embodiments as defined by the appended claims. Furthermore, in this Description of Embodiments, numerous specific details are set forth in order to provide a thorough understanding of embodiments of the present subject matter. However, embodiments may be practiced without these specific details. In other instances, well-known methods, procedures, components, and circuits have not been described in detail so as not to unnecessarily obscure aspects of the described embodiments.

### Overview of Discussion

A device which can operate via remote controlled instruction, autonomously, or some combination thereof is described. The device is robotic and may be referred to herein as a “robot” or as a “robotic device,” or the “device,” and includes an auger-based drive system which facilitates the movement and/or operation of the device in relation to a portion of piled granular material in a bulk store, such as a grain bin. More particularly, because of the augers in the auger-based drive system, the device can operate and maneuver (i.e., drive about) upon or beneath piled granular material. Additionally, and advantageously, augers of the auger-based drive system move, disrupt, agitate, and/or disperse piled granular material as a consequence of the movement of the device.

Although tracked and wheeled devices would seem to be alternatives to the auger-driven devices described herein, both wheeled and tracked drive systems have been found ill-suited to operation on piled granular material. For example, wheeled and tracked devices are both easily bogged down when operating on piled granular material, such that they exhibit poor mobility in traversing atop/upon deeply piled granular material (e.g., over a foot deep, and sometimes not even that deep). In short, they frequently get stuck and require human retrieval or intervention, which typically necessitates a human undesirably entering upon the pile of granular material.

Herein, the term “granular material” refers to the physical collection of granules. Some examples of granular material include, without limitation: grain (e.g., small hard and typically edible seeds or beans such as soybean seeds, peas, garbanzo beans, pinto beans, corn kernels, wheat, rice, etc.), non-grain plant seeds (e.g., flower seeds and grass seeds), nuts (e.g., shelled or unshelled tree nuts or ground nuts), nut shells, sand, animal litter, concrete mix, cement, dry fertilizer, pelletized products (e.g., wood pellets, plastic pellets, hemp pellets, fish food pellets, etc.) and granular milled/ground products (e.g., flour, soy meal, sugar, coffee, cocoa, guar gum, sodium bicarbonate, alumina, and granular mineral/rock aggregates/products, etc.). “Bulk solid” is a term that may be used to generally describe non-grain granular materials. Granular material is often piled (i.e., heaped up) in a bulk store.

Herein, the term “granular medium” describes the bulk behavior and interaction of granular material as a system.

A bulk store is the place where granular material is piled for bulk storage. Although a grain bin is frequently used herein as an example of a bulk store, nearly any bulk store which is large enough for a human to access and work inside or upon the stored granular material is a candidate for operation of the device described herein. Accordingly, it should be appreciated that other large bulk stores are also suitable bulk stores for use of the described device in relation to piled granular material in many of the manners described herein. Some examples of other large bulk stores include, but are not limited to: containers (e.g., railcars, semi-trailers, barges, ships, which may be enclosed or have open tops, and the like) for transport/storage of granular material, upright metal storage, buildings (e.g., silos, bins, warehouses, flat storage, government grain storage, etc.) for storage of granular material, and open storage piles of granular material.

Bulk stored granular material can present many safety concerns for humans. For example, bulk stores are often hot, dusty, poorly lit, and generally inhospitable work environments for humans. Additionally, entrapments can take place when a farmer or worker is in a bin or other bulk store of granular material, such as grain, and the granular material slides onto or engulfs the person. Entrapments can happen because a slope angle of the piled granular material (e.g., grain) is at a critical angle which may slide when disturbed by the person or else when it may slide when extraction augers or machinery disturb the bulk stored granular material. As one example, steep walls of grain can avalanche onto a farmer/worker trying to mitigate problems in a grain bin, inspect the stored grain, or agitate the grain to improve the outflow. Additionally, sometimes a bridge/crust layer can form over a void in a pile of grain and when a farmer/worker walks across it or tries to break it with force, the grain bridge can collapse and entrap the person. As this bridge/crust layer and/or the size of the void below it may be invisible to the human eye, it can present an unknown danger to a farmer/worker. Furthermore, in some piled granular materials, localized compaction can cause vertical projections which, from the surface, appear as granular material is removed from a bulk store. Such vertical projections can often be very tall (e.g., 10 to 50 feet, or more). Thus, if they topple on a human, severe injury may occur. As will be discussed, many of these and other safety concerns can be reduced or eliminated through use of the device and techniques/methods described herein.

Among other things, the device described herein can be used to address managing the quality of bulk stored granular material (e.g., grain in a bin) through tasks like, but not limited to: inspections of the bulk stored granular material, leveling of the bulk stored granular material, agitating of the bulk stored granular material to prevent/reduce spoilage, traversing a surface of granular material to break up a crust and/or prevent crust formation, dispersing of the bulk stored granular material while it is being loaded into the bulk store, assisting with rehydration of grain to a higher test weight prior to extraction, assisting with extraction of grain, feeding a sweep auger or other collection device which removes the bulk stored granular material from the bulk store, lowering the slope angles of the granular material in a partially emptied bulk store, and/or reducing/eliminating vertical projections (e.g., cliffs and pillars) of the granular material which extend vertically upward from the surface. In short, the device can accomplish numerous tasks which, when done by the device, preclude the need for humans to enter a bulk store, work on a pile of granular material, or else make it safer when it is necessary for humans to enter a bulk store or work on a pile of granular material. In various embodiments, these tasks may be carried out: by the device under remote-control of the device by an operator located outside the bulk store; by the device in an ad-hoc fashion; by the device in a partially automated fashion; and/or by the device in a fully automated fashion. Employment of the device relative to a bulk stored granular material reduces or eliminates the requirement for a human to enter a bulk store or personally traverse the piled granular material. As a consequence, safety to humans is drastically improved with regard to tasks related to management of a bulk store. In an event where a human chooses to enter a bulk store, the device can manage/prepare the surface by removing crusts, eliminating grain bridges, eliminating vertical projections, and reducing slope so that the piled granular material is safer for human traversal.

Additionally, as an extension of the device traversing atop/upon the surface of piled granular material for leveling, material movement, cleanout, or other purposes, the robot/device can note and record its locations at a plurality of points on the surface such that a mapping of the three-dimensional contours of the upper surface of the piled granular material in the bulk store can be constructed from the points of location of the device. The mapping can further include environmental characteristics measured at respective locations upon the surface. Several surface maps can be sequentially captured during the filling of a bulk store such that when compiled, a three-dimensional map is assembled which illustrates environmental characteristics not only on the surface of the piled granular material, but also beneath the existing surface at the levels of previous surfaces where mapping was accomplished prior to the filling of additional granular material. Such mappings have many beneficial uses. For example, a surface contour map can be combined with information regarding test weights (i.e., moisture levels) of piled grain and the location of the floor of the bulk store to estimate an amount of granular material (e.g., grain) stored in the bulk store (i.e., a number of bushels or other weight or volume). In another example, a surface contour map can be utilized to determine whether and where surface leveling should be performed by the device. In another example, an environmental characteristics map can indicate one or more areas of concern which may need to be cooled, dispersed, or otherwise attended to by the robotic device described herein. Put more generally, data collected by the device while traversing the surface of a piled granular material in a bulk store (e.g., a grain bin) is used to assist a human (e.g., a farmer, worker, etc.) in managing the bulk store and the piled granular material during loading, storage, and unloading of the piled granular material.

Additionally, as an extension of the device traversing atop/upon the surface of piled granular material and in some instances as a function of mapping as well, the device operates as a grain bin assistant in the management of the grain that is stored within a bulk store such as a grain bin. That is, the device may operate to assist with management of a grain bin: prior to load-in of grain, during load-in of grain, after load-in, during storage, during extraction of grain, and/or during clean-out of grain from a bin. This may include one or more of: the device operating to level, map, aerate, and/or prepare the surface of any grain already in a grain bin to prepare the bin for load-in of additional grain; the device operating during load-in of a load of grain to disperse BGFM which typically accumulates in the landing zone of the loaded-in grain; the device operating during/after the load-in of a load of grain to level, map, remediate hot spots, and/or aerate the surface of grain; the device operating to prepare the upper surface of the loaded-in grain either for long term storage or load-in of an additional load; the device operating to maintain and/or inspect the surface of the grain during long term storage; the device operating to assist with rehydration of stored grain prior to extraction; the device operating to assist with extraction by leveling the surface, mapping the surface, and/or pushing grain to the center/extraction point through one or more of the action of the augers of the device and purposely inciting sediment gravity flow of grain; and/or the device operating with clean-out of the grain bin by running one or more patterns to move grain to a sweep auger or other extraction point/tool at the bottom of the bin through one or more of the action of the augers of the device and purposely inciting sediment gravity flow of grain.

Discussion begins with a description of notation and nomenclature. Additional discussion is divided into sections. In Section 1, discussion is directed to a description of some block diagrams of example components of some examples of a robotic auger-driven “device” which moves about atop/upon and/or operates in relation to a bulk stored pile of granular material. A variety of sensors and payloads which may be included with and/or coupled with the device are described. Numerous example views of the exterior of a device are presented and described, including a description of the auger-based drive system of the device. Several systems for remote-controlled, semi-autonomous, and autonomous operation of the device are described. Additionally, systems and techniques for storing information from the device and/or providing information and/or instructions to the device are described. In Section 2, an example bulk store for granular material is then depicted and described in conjunction with operation of the device in relation to piled granular material in the bulk store. Operation of the device and components thereof, to include some sensors of the device, are discussed in conjunction with a variety of methods/modes of operation. For example, operation of the device is discussed in conjunction with a description of an example method of bulk store leveling. In Section 3, some techniques for movement and management of piled granular material are described in conjunction with various robotic devices, including a robotic device which includes a convertible drive system and/or a variety of payloads/implements. An example bulk store for granular material is then depicted and described in conjunction with operation of the device in relation to piled granular material in the bulk store, to include utilizing an auger payload/implement attachment to move granular material and/or utilizing various drive systems and payloads/implements, such as augers, shovels, and/or brooms, to assist with the final clean-out of a granular material bulk store.

### Section 1

### Notation and Nomenclature

Some portions of the detailed descriptions which follow are presented in terms of procedures, logic blocks, processes, modules, and other symbolic representations of operations on data bits within a computer memory. These descriptions and representations are the means used by those skilled in the data processing arts to most effectively convey the substance of their work to others skilled in the art. In the present application, a procedure, logic block, process, module, or the like, is conceived to be one or more self-consistent procedures or instructions leading to a desired result. The procedures are those requiring physical manipulations of physical quantities. Usually, although not necessarily, these quantities take the form of electrical or magnetic signals capable of being stored, transferred, combined, compared, and otherwise manipulated in an electronic device/component.

It should be borne in mind, however, that all of these and similar terms are to be associated with the appropriate physical quantities and are merely convenient labels applied to these quantities. Unless specifically stated otherwise, as apparent from the following discussions, it is appreciated that throughout the description of embodiments, discussions utilizing terms such as “accessing,” “additionally traversing,” “agitating,” “articulating,” “assembling,” “capturing,” “ceasing,” “ceasing traversal,” “collecting,” “communicating,” “communicatively coupling,” “continuing,” “continuing traversal,” “controlling,” “coupling,” “deploying,” “discharging,” “delivering,” “depositing,” “determining,” “directing,” “directing traversal,” “failing to satisfy,” “inciting,” “initiating,” “instructing,” “lowering,” “mapping,” “measuring,” “obtaining,” “orienting,” “operating,” “performing,” “placing,” “providing,” “providing access,” “raising,” “receiving,” “receiving data,” “receiving instructions,” “recording,” “relaying,” “responding,” “rotatably articulating,” “rotating,” “satisfying,” “sending,” “sensing,” “traversing,” “undercutting,” “using,” and “utilizing,” or the like, refer to the actions and processes of an electronic device or component, such as (and not limited to): a host processor, a sensor processing unit, a sensor processor, a digital signal processor, or other processor, a memory, a sensor (e.g., a temperature sensor, motion sensor, etc.), a computer, a remote controller, a device which moves about and/or operates in relation to a portion of piled granular material, some combination thereof, or the like. The electronic device/component manipulates and transforms data represented as physical (electronic and/or magnetic) quantities within the registers and/or memories into other data similarly represented as physical quantities within memories and/or registers or other such information storage, transmission, processing, and/or display components.

Embodiments described herein may be discussed in the general context of processor-executable instructions residing on some form of non-transitory processor-readable medium, such as program modules or logic, executed by one or more computers, processors, or other devices. Generally, program modules include routines, programs, objects, components, data structures, etc., that perform particular tasks or implement particular abstract data types. The functionality of the program modules may be combined or distributed as desired in various embodiments.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, circuits, and steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example electronic device(s) described herein may include components other than those shown, including well-known components.

The techniques described herein may be implemented in hardware, or a combination of hardware with firmware and/or software, unless specifically described as being implemented in a specific manner. Any features described as modules or components may also be implemented together in an integrated logic device or separately as discrete but interoperable logic devices. If implemented in software, the techniques may be realized at least in part by a non-transitory computer/processor-readable storage medium comprising computer/processor-readable instructions that, when executed, cause a processor and/or other components of a computer, computer system, or electronic device to perform one or more of the methods and/or actions of a method described herein. The non-transitory computer/processor-readable storage medium may form part of a computer program product, which may include packaging materials.

The non-transitory processor-readable storage medium (also referred to as a non-transitory computer-readable storage medium) may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

The various illustrative logical blocks, modules, circuits and instructions described in connection with the embodiments disclosed herein may be executed by one or more processors, such as host processor(s) or core(s) thereof, digital signal processors (DSPs), general purpose microprocessors, application specific integrated circuits (ASICs), application specific instruction set processors (ASIPs), field programmable gate arrays (FPGAs), or other equivalent integrated or discrete logic circuitry. The term “processor,” as used herein may refer to any of the foregoing structures or any other structure suitable for implementation of the techniques described herein. In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any conventional processor, controller, microcontroller, or state machine. A processor may also be implemented as a combination of computing devices, e.g., a plurality of microprocessors, one or more microprocessors in conjunction with an ASIC or DSP, or any other such configuration or suitable combination of processors.

Example Block Diagrams of a Device which Moves About and/or Operates in Relation to a Pile of Granular Material

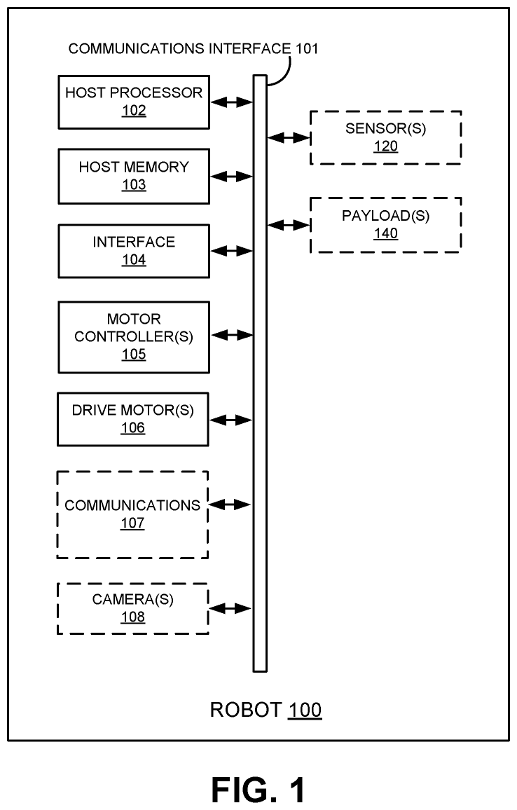

FIG. 1 shows an example block diagram of some aspects of a device 100 which moves about and/or operates in relation to a pile of granular material, in accordance with various embodiments. As previously discussed, device 100 may be referred to as a robot and/or robotic device, and device 100 may carry out some or all of its functions and operations based on stored instructions.

As shown, example device 100 comprises a communications interface 101, a host processor 102, host memory 103, an interface 104, motor controllers 105, and drive motors 106. In some embodiments, device 100 may additionally include one or more of communications 107, a camera(s) 108, one or more sensors 120, and/or one or more payloads 140.

Communications interface 101 may be any suitable bus or interface which facilitates communications among/between components of device 100. Examples of communications interface 101 include a peripheral component interconnect express (PCIe) bus, a universal serial bus (USB), a universal asynchronous receiver/transmitter (UART) serial bus, a suitable advanced microcontroller bus architecture (AMBA) interface, an Inter-Integrated Circuit (I2C) bus, a serial digital input/output (SDIO) bus, or other equivalent and may include a plurality of communications interfaces.

The host processor 102 may, for example, be configured to perform the various computations and operations involved with the general function of device 100 (e.g., sending commands to move, steer, avoid obstacles, and operate/control the operation of sensors and/or payloads). Host processor 102 can be one or more microprocessors, central processing units (CPUs), DSPs, general purpose microprocessors, ASICs, ASIPs, FPGAs, or other processors which run software programs or applications, which may be stored in host memory 103, associated with the general functions and capabilities of device 100.

Host memory 103 may comprise programs, modules, applications, or other data for use by host processor 102. In some embodiments, host memory 103 may also hold information that is received from or provided to interface 104, motor controller(s) 105, communications 107, camera(s) 108, sensors 120, and/or payloads 140. Host memory 103 can be any suitable type of memory, including but not limited to electronic memory (e.g., read only memory (ROM), random access memory (RAM), or other electronic memory).

Interface 104 is an external interface by which device 100 may receive input from an operator or instructions. Interface 104 is one or more of a wired or wireless transceiver which may provide a connection to an external transmission source/recipient for receipt of instructions, data, or direction to device 100 or offload of data from device 100. One example of an external transmission source/external recipient may be a base station to which device 100 communicates collected data or from which device 100 receives instructions or direction. Another example of an external transmission source/recipient is a handholdable remote-controller to which device 100 communicates collected data or from which device 100 receives instructions or direction. By way of example, and not of limitation, in various embodiments, interface 104 may comprise one or more of: a cellular transceiver, a wireless local area network transceiver (e.g., a transceiver compliant with one or more Institute of Electrical and Electronics Engineers (IEEE) 802.11 specifications for wireless local area network communication (e.g., Wi-Fi)), a wireless personal area network transceiver (e.g., a transceiver compliant with one or more IEEE 802.15 specifications (or the like) for wireless personal area network communication), and a wired serial transceiver (e.g., a universal serial bus for wired communication).

Motor controller(s) 105 are mechanism(s), typically circuitry and/or logic, which operate under instruction from processor 102 to drive one or more drive motors 106 with electricity to govern/control the direction and/or speed of rotation of the drive motor(s) 106 and/or other mechanism of movement to which the drive motor(s) 106 are coupled (such as augers). Motor controller(s) 105 may be integrated with or separate from drive motor(s) 106.

Drive motor(s) 106 are electric motors which receive electrical input from motor controller(s) 105 and turn a shaft in a direction and/or speed responsive to the electrical input. In some embodiments, drive motors 106 may be coupled directly to a mechanical means of drive motivation and steering—such as one or more augers. In some embodiments, drive motors 106 may be coupled indirectly, such as via a gearing or a transmission, to a mechanical means of drive motivation and steering—such as one or more augers.

Communications 107, when included, may comprise external interfaces in addition to those provided by interface 104. Communications 107 may facilitate wired and/or wireless communication with devices external to and in some instances remote (e.g., many feet or even many miles away) from device 100. Communications protocols may include those used by interface 104 as well as others. Some examples include, but are not limited to: Wi-Fi, LoRaWAN (e.g., long range wireless area network communications on the license-free sub-gigahertz radio frequency bands), IEEE 802.15.4-2003 standard derived communications (e.g., xBee), IEEE 802.15.4 based or variant personal area network (e.g., Bluetooth, Bluetooth Low Energy, etc.), cellular, and connectionless wireless peer-to-peer communications (e.g., ESP-NOW). In various aspects, communications 107 may be used for data collection/transmission, reporting of autonomous interactions of device 100, and/or user interface and/or operator interface with device 100.

Camera(s) 108 may comprise, without limitation: any type of optical sensor or infrared image sensor for capturing still or moving images. Some examples of suitable cameras include charge-coupled device (CCD) sensor cameras, metal-oxide semiconductor (MOS) sensor cameras, and other digital electronic cameras. Captured images may be utilized by device 100 for purposes such as navigation and decision making, may be stored, and/or may be transmitted to devices external to device 100. In some embodiments, camera(s) 108 facilitate wayfinding for device 100 when operating autonomously or semi-autonomously. In some embodiments, camera(s) 108 facilitates a remote view for an operator when device 100 is manually driven by a human user via a remote controller or computer system communicatively coupled with device 100. In some embodiments, an infrared camera 108 is used to find hotspots of grain to mix or agitate with device 100 (to reduce the heat of the hotspot). In some embodiments, computer vision is used by device 100 to make autonomous decisions based on inputs to processor 102 from camera(s) 108.

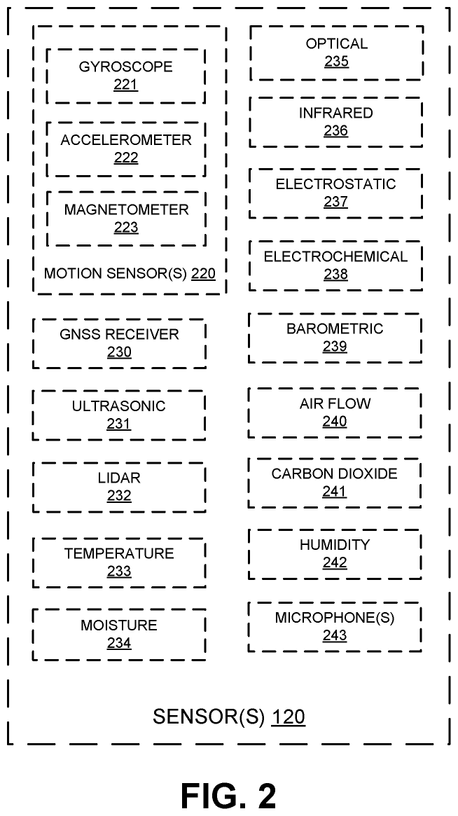

FIG. 2 shows a block diagram of a collection of sensors 120, any or all of which may be incorporated into device 100 of FIG. 1, in accordance with various embodiments. Sensors 120 illustrate a non-limiting selection of sensors, which include: motion sensor(s) 220, GNSS (Global Navigation Satellite System) receiver 230, ultrasonic transducer 231, LIDAR (light detection and ranging/laser imaging, detection, and ranging) 232, temperature sensor 233, moisture sensor 234, optical sensor 235, (e.g., an optical camera), infrared sensor 236 (which may be a receiver such as an infrared camera or an emitter/receiver), electrostatic sensor 237, electrochemical sensor 238, a barometric pressure sensor 239, an air flow sensor 240, a carbon dioxide sensor 241, and a humidity sensor 242.

It is appreciated that one or more sensors may be combined. For example, several sensors may be combined in a device such as the ICM-20789 microelectromechanical sensor (available from InvenSense, a TDK group company, of San Jose, CA) which provides 7-axis sensing (3-axis accelerometer, 3-axis gyroscope, and 1-axis barometric pressure (for measuring elevation changes to an accuracy of less than 8.5 cm)) along with an on-board digital motion processor. In other embodiments, separate sensors may be used; for example, a stand-alone pressure sensor 239 may measure elevation, via differential barometric pressure measurement, of as little as 5 cm (e.g., InvenSense sensor ICP-10101, as one example) while a motion sensor 220 includes an accelerometer 222 for measuring movement and a gyroscope 221 for measuring direction of movement). Other sensors may be additionally or alternatively included in some embodiments, for example, a carbon dioxide sensor 241 and a humidity sensor 242 may be included to measure off-gassed carbon dioxide from piled grain, and/or an air flow sensor 240 may be included to measure air flow through and around piled grain (air flow is used for drying the pile of grain but must be controlled to prevent over drying or undesired rehydration). In some embodiments, one or more microphones 243 may be included as sensors. For example, an array of microphones may be used with a beamforming technique to locate the directional source of a sound, such as falling granular material being poured, conveyed, streamed, or augured into a bulk store. Some embodiments may additionally, or alternatively, include other sensors not described.

In general, individual sensors 120 operate to detect motion, position, timing, and/or some aspect of environmental context (e.g., temperature, atmospheric humidity, moisture of a sample or probed portion of granular material, distance to an object, shape of an object, solidity of a material, light or acoustic reflectivity, ambient charge, atmospheric pressure, presence of certain chemical(s), noise/sound, etc.). For example, in an embodiment where the piled granular material is grain, many of sensors 120 are used to determine the state of the grain (e.g., temperature, moisture, electrostatic charge, etc.). In some embodiments, one or more sensors 120 are used for fall detection, orientation, and to aid in autonomous direction of movement of device 100. For example, by detecting the temperature of grain, device 100 may determine hot spots which need to be mixed by traversal with device 100 or by other means. Similarly, by detecting the moisture of grain, device 100 may determine moist spots which need to be mixed by traversal with device 100 or by other means. By detecting an electrostatic and/or electrochemical aspect of the atmosphere in a grain bin, a level of dust or other particulates and/or likelihood of an explosion may be detected in order to gauge safety for a human and/or safety for operating device 100.

Some embodiments may, for example, comprise one or more motion sensors 220. For example, an embodiment with a gyroscope 221, an accelerometer 222, and a magnetometer 223 or other compass technology, which each provide a measurement along three axes that are orthogonal relative to each other, may be referred to as a 9-axis device. In another embodiment, a three-axis accelerometer 222 and a three-axis gyroscope 221 may be used to form a 6-axis device. Other embodiments may, for example, comprise an accelerometer 222, gyroscope 221, compass, and pressure sensor, and may be referred to as a 10-axis device. Other embodiments may not include all these motion sensors or may provide measurements along one or more axes. In some embodiments, motion sensors 220 may be utilized to determine the orientation of device 100, the angle of slope or inclination of a surface upon which device 100 operates, the velocity of device 100, and/or the acceleration of device 100. In various embodiments, measurements from motion sensors 220 may be utilized by host processor 102 to measure direction and distance of travel and may operate as an inertial navigation system (INS) suitable for controlling and/or monitoring maneuvering of device 100 in a bulk store (e.g., within a grain bin). In some embodiments, motion sensors 220 may be used for fall detection. In some embodiments, motion sensor(s) 220 may be used to detect vibrations in the granular material proximate to device 100.

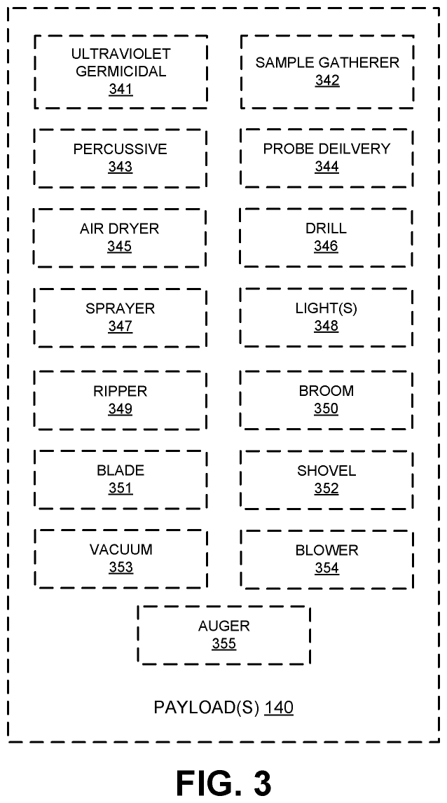

FIG. 3 shows a block diagram of a collection of payloads 140, any or all of which may be incorporated into device 100 of FIG. 1, in accordance with various embodiments. Payloads 140 illustrate a non-limiting selection of payloads, which include: ultraviolet germicidal 341, sample gatherer 342, percussive payload 343, probe/sensor delivery 344, air dryer 345, drill 346, sprayer 347, lights 348, ripper 349, broom 350, blade 351, shovel 352, vacuum 353, a blower 354, and/or an auger 355.

Ultraviolet germicidal payload 341, when included, emits ultraviolet light to kill germs by irradiating in the proximity of device 100. Sample gatherer payload 342, when included, provides one or more containers or bays for gathering one or more samples of granular material from a pile of granular material upon which device 100 operates. Percussive payload 343, when included, operates to vibrate, or percussively impact piled granular material touching or in the proximity of device 100. Probe/sensor delivery payload 344, when included, operates to insert one or more probes or sensors into piled granular material upon which device 100 operates and/or to position one or more probes onto piled granular material upon which device 100 operates. Air dryer payload 345, when included, provides a fan and/or heater for drying piled granular material proximate to device 100. Drill payload 346, when included, operates to bore into and/or sample piled granular material and/or break up crusts or aggregations of piled granular material proximate to device 100. Sprayer payload 347, when included, operates to spray fungicide, insecticide, or other liquid or powdered treatments onto piled granular material proximate to device 100. Lights payload 348, when included, emit optical and/or infrared illumination in proximity of device 100. Ripper payload 349, when included, comprises one or more blades, tines, or the like and is used to rip into, agitate, and/or break up crusts or chunks of aggregated granular material proximate to device 100. Broom payload 350, when included, may include fixed or rotating components for sweeping. Blade 351, when included, may be a fixed or movable blade (e.g., similar to a dozer blade) for pushing/sweeping granular material in the path of traversal of device 100. Shovel 352, when included, may be a fixed or movable shovel (e.g., similar in appearance/function to a snow shovel) relative to device 100 and is used for pushing/scooping/shoveling granular material in the path of traversal of device 100. In some embodiments, blade 351 and shovel 352 may have some similarity and perform some functions which overlap, though a blade 351 is generally suited more toward pushing than scooping granular material, while a shovel 352 may push granular material, it is generally better configured for scooping than blade 351. Vacuum 353, when included, may be a powered vacuum that is fixed or movable relative to device 100 and is used for sucking up and storing granular material in the path of traversal of device 100. Blower 354, when included, may be a powered air blower that is fixed or movable relative to device 100 and is used for blowing granular material in the path of traversal of device 100.

Auger payload 355, when included, may provide a powered auger as an implement that is independent of and in addition to the augers 403 of the auger-based drive system of device 100. The angle of auger payload 355 may be fixed or movable relative to device 100. Auger payload 355 is used for agitating, grinding, and/or moving granular material in the path of traversal of device 100. In some embodiments, auger payload 355 may also be used to provide propulsion, in addition to the propulsion of augers 403 of the auger-based drive system.

It should be appreciated that various payloads may be delivered, where delivery includes leaving or expelling the payload or a portion thereof at a designated location. For example, delivery can include leaving/installing a probe or sensor. Delivery may also include spraying or spreading a substance such as, but not limited to: a coolant, a flame retardant, an insecticide, a fungicide, or other liquid, gas, or powder.

In various embodiments, one or some combination of payloads 140 may be included in a payload bay of device 100. In some embodiments, the payload bay is fixed in place. In some embodiments, the payload bay may be removably coupled to device 100 to facilitate swapping it for another payload bay to quickly reconfigure device 100 with various different payloads.

Example External Views of a Device which Moves About and/or Operates in Relation to a Pile of Granular Material

FIGS. 4A-1, 4A-2, and 4A-3 illustrate front elevational views of the exterior of a device 100 which moves about and/or operates in relation to a pile of granular material, in accordance with various embodiments.

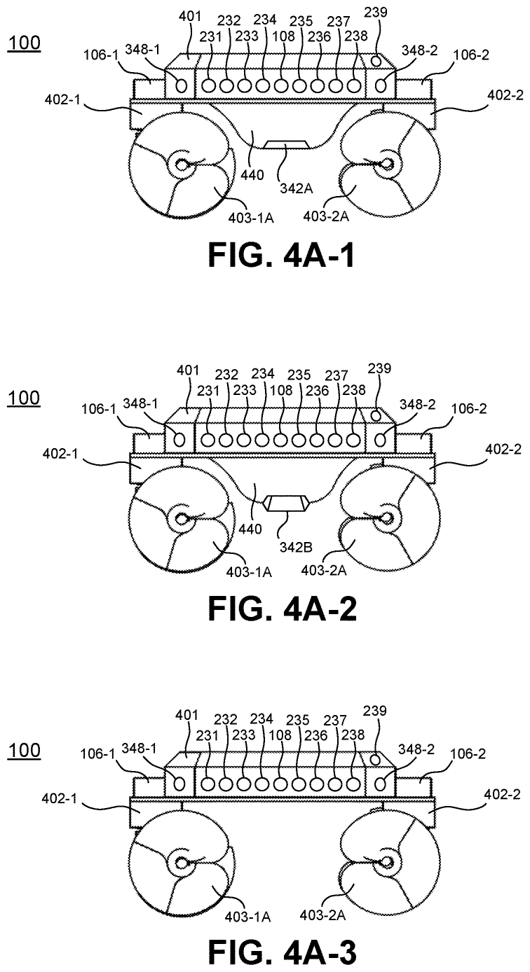

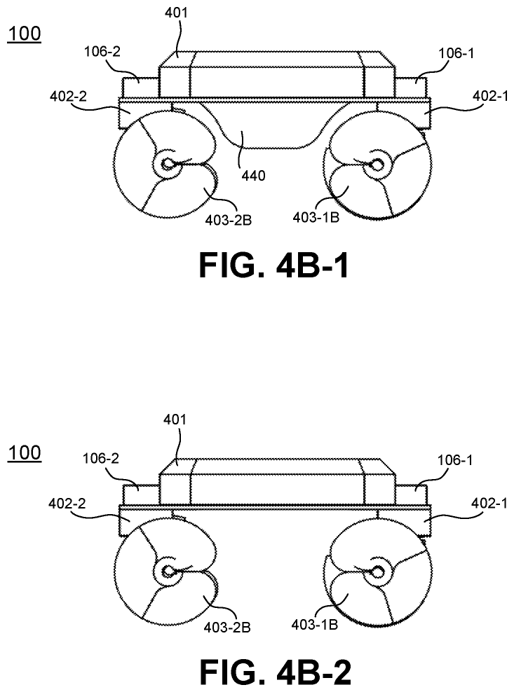

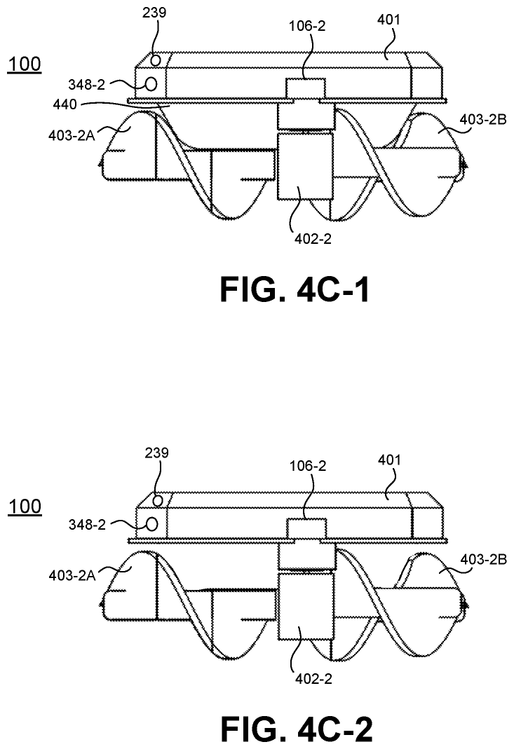

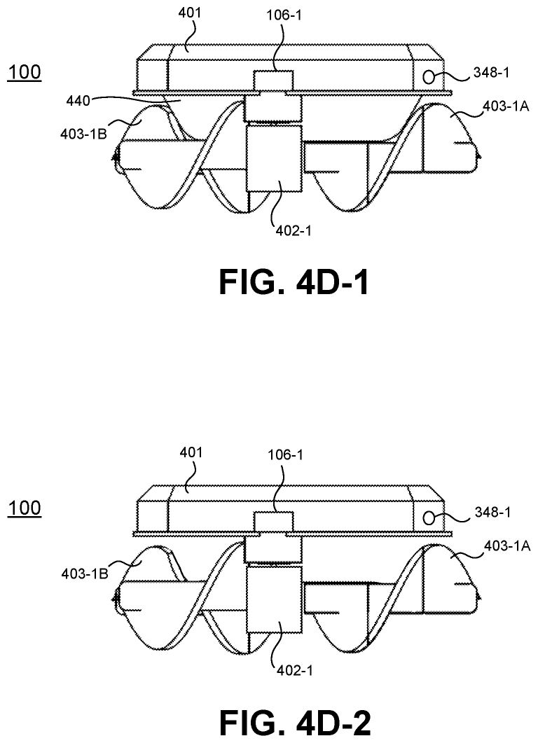

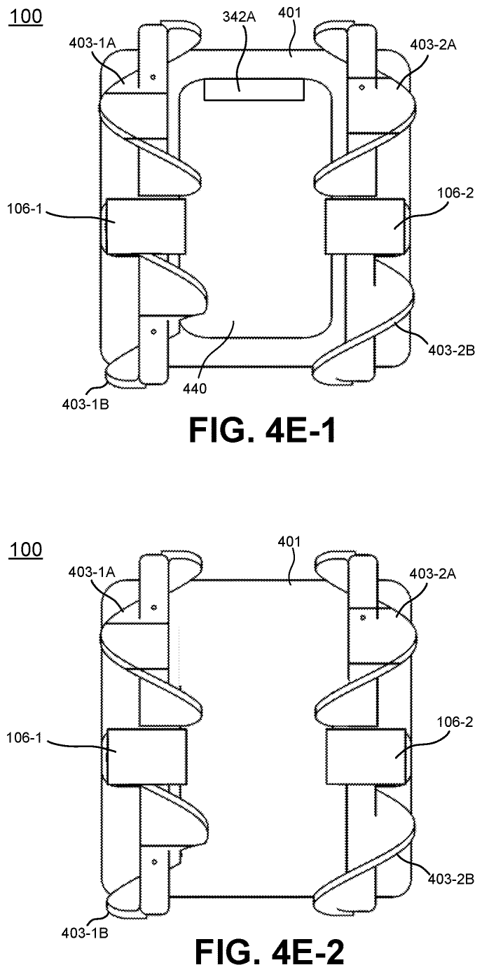

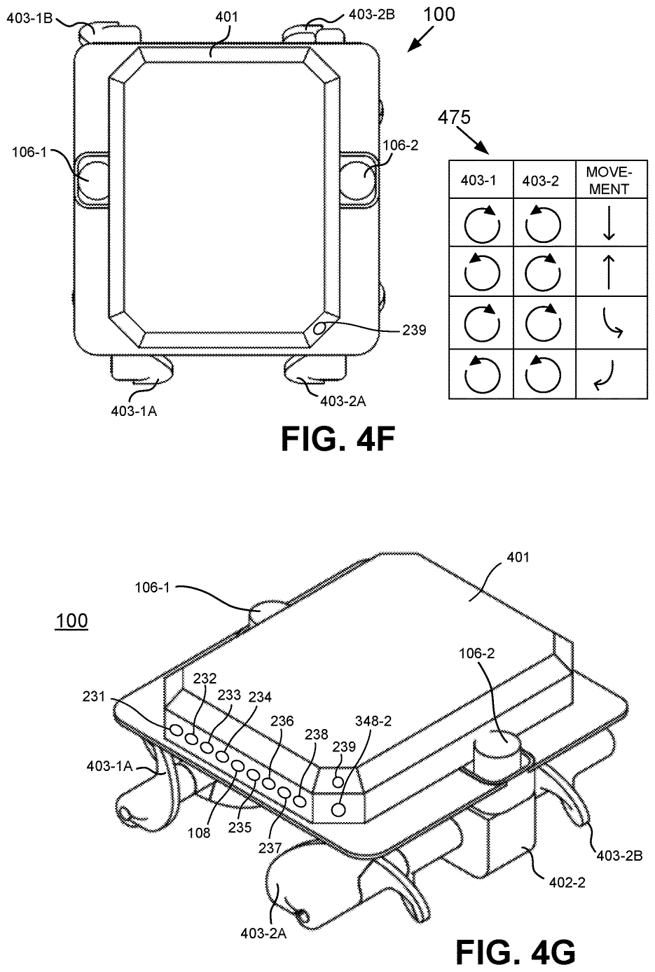

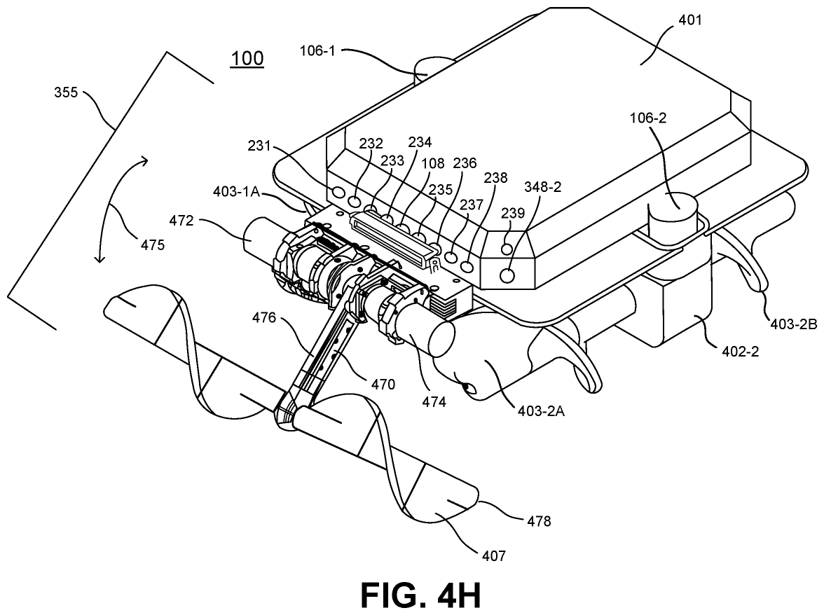

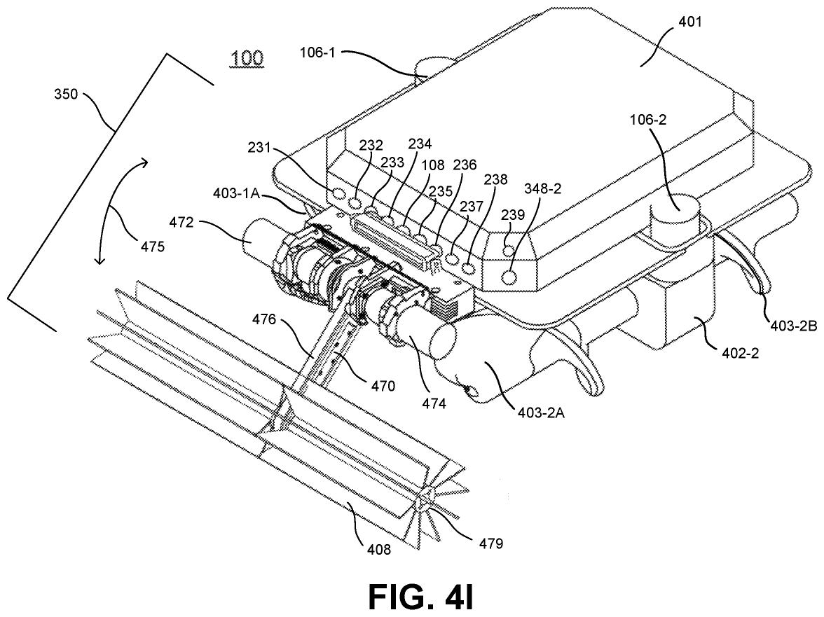

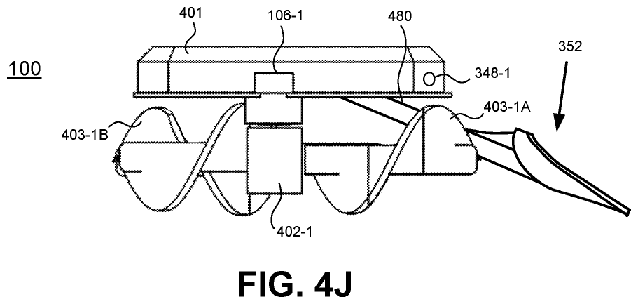

With reference to FIG. 4A-1, device 100 includes a body 401, motors 106 (106-1 and 106-2), transmissions 402 (402-1 and 402-2), and augers 403 (403-1 and 403-2). In the illustrated embodiment of device 100, a pair of augers 403 is utilized. As depicted, the augers 403 are bilateral; however, other arrangements of the augers 403 are possible and anticipated. In some embodiments, a drive motor 106 may be coupled to an auger 403 (such as to the end of an auger 403) in a manner that eliminates the need for a transmission 402 between the drive motor 106 and the auger 403. In the depicted embodiments, the transmission is located near the middle of each auger 403, thus bifurcating each auger into two portions. In FIG. 4A-1, the front portion 403-1A of auger 403-1 is visible, as is the front portion 403-2A of auger 403-2. In typical operation, augers 403 sink at least partially into the piled granular material and thrust against it as they rotate. The direction and speed of rotation of the augers 403 determine the movement fore, aft, left, right, turning left, and/or turning right of device 100. In this manner, in various embodiments, device 100 can move atop a pile of granular material, can move beneath a pile of granular material (i.e., submerged in it), and can move to the surface after being submerged in a pile of granular material. It should be appreciated that in some embodiments, a different arrangement of augers in an auger-based drive system may be utilized. For example, a different arrangement may not have bilateral augers or else may have one or more augers in addition to bilateral augers. There may be three parallel augers (like a trimaran hull arrangement in a boat), or augers arranged in parallel with each of the four sides of the robot. Additionally, in a similar arrangement to what is shown, there may be four independent augers, in an embodiment where augers 403-1A, 403-1B, 403-2A, and 403-2B are independently driven (i.e., each with its own motor, motor controller, transmission, etc.).

In some embodiments, device 100 includes one or more payloads 140. For example, lights payloads 348 (348-1 and 348-2) are included to provide illumination. In some embodiments, device 100 may additionally or alternatively include a payload bay 440 which may be fixed to device 100 or removably couplable with device 100. The payload bay 440 may provide a housing for one or more of the payloads 140 discussed herein and/or for other payloads. As one example, payload bay 440 may include sample gatherer payload 342 (shown in the closed, non-sample gathering position as 342A). In some embodiments, one or more cameras 108 are included and coupled with body 401. In some embodiments, one or more sensors 120 are included and coupled with body 401 in a manner which provides access to the external environment of device 100. For example, one or more of ultrasonic transducer 231, LIDAR 232, temperature sensor 233, moisture sensor 234, optical sensor 235, infrared sensor 236, electrostatic sensor 237, and electrochemical sensor 238 may be included in a manner which provides sensor access to the operating environment of device 100.

Referring now to FIG. 4A-2, device 100 is illustrated with sample gatherer payload 342 in an open, sample gathering position 342B, to scoop up a sample of granular material as device 100 moves forward with sample gatherer payload open and submerged into the piled granular material upon which device 100 operates.

Referring now to FIG. 4A-3, device 100 is illustrated without payload bay 440. This illustrates a configuration of device 100 in which payload bay 440 has been removed or else device 100 is not configured to support a payload bay 440.

FIGS. 4B-1 and 4B-2 illustrate rear elevational views of the exterior of a device 100 which moves about and/or operates in relation to a pile of granular material, in accordance with various embodiments.

With reference to FIG. 4B-1, the rear portion 403-1B of auger 403-1 is visible, as is the rear portion 403-2B of auger 403-2.

With reference to FIG. 4B-2, device 100 is illustrated without payload bay 440. This illustrates a configuration of device 100 in which payload bay 440 has been removed or else device 100 is not configured to support a payload bay 440.

FIGS. 4C-1 and 4C-2 illustrate right elevational views of the exterior of a device 100 which moves about and/or operates in relation to a pile of granular material, in accordance with various embodiments.

With reference to FIG. 4C-1, the full span of auger 403-2 is visible, including front portion 403-2A and rear portion 403-2B, as is the drive motor 106-2 and transmission 402-2, which, together, operate to drive auger 403-2. An auger-based drive system includes, for example, drive motors 106 and augers 403, and may include transmissions 402. In some embodiments, motor controllers 105 may also be considered a portion of an auger-based drive system. This lateral side of the auger-based drive system of device 100 comprises drive motor 106-2, transmission 402-2, and auger 403-2. As has been discussed, other embodiments may directly drive the auger with the drive motor, thus eliminating the transmission from the auger-based drive system.

With reference to FIG. 4C-2, device 100 is illustrated without payload bay 440. This illustrates a configuration of device 100 in which payload bay 440 has been removed or else device 100 is not configured to support a payload bay 440.

FIGS. 4D-1 and 4D-2 illustrate left elevational views of the exterior of a device 100 which moves about and/or operates in relation to a pile of granular material, in accordance with various embodiments.

With reference to FIG. 4D-1, the full span of auger 403-1 is visible, including front portion 403-1A and rear portion 403-1B, as is the drive motor 106-1 and transmission 402-1, which drives auger 403-1. This lateral side of the auger-based drive system of device 100 comprises drive motor 106-1, transmission 402-1, and auger 403-1. As has been discussed, other embodiments may directly drive the auger with the drive motor, thus eliminating the transmission from the auger-based drive system.

With reference to FIG. 4D-2, device 100 is illustrated without payload bay 440. This illustrates a configuration of device 100 in which payload bay 440 has been removed or else device 100 is not configured to support a payload bay 440.

FIGS. 4E-1 and 4E-2 illustrate bottom plan views of the exterior of a device 100 which moves about and/or operates in relation to a pile of granular material, in accordance with various embodiments.

With reference to FIG. 4E-1, a bottom plan view of device 100 is shown with a payload bay 440 coupled with device 100. As can be seen in FIG. 4E-1, drive auger 403-1 and drive auger 403-2 are arranged in a bilateral fashion and have flighting wound in opposite directions from each other. Thus, the bilateral drive augers 403-1 and 403-2 may be referred to as “opposing screw” drive augers. Propulsion is through direct interaction with the granular material in which device 100 operates and can be forward, reverse, sideways, and turning.

With reference to FIG. 4E-2, device 100 is illustrated in bottom plan view without payload bay 440. This illustrates a configuration of device 100 in which payload bay 440 has been removed or else device 100 is not configured to support a payload bay 440.

FIG. 4F illustrates a top plan view of the exterior of a device 100 which moves about and/or operates in relation to a pile of granular material, along with a chart 475 illustrating directional movements, in accordance with various embodiments. Chart 475 shows some examples of rotations of augers 403-1 and 403-2 utilized to implement movement of device 100 in the directions indicated by the arrows in the chart. The rotations and movement directions in chart 475 are in relation to the view of device 100 shown in FIG. 4F. Although not depicted, in some embodiments, device 100 may be operated to move laterally to one side or the other.

FIG. 4G illustrates an upper front right perspective view of the exterior of a device 100 which moves about and/or operates in relation to a pile of granular material, in accordance with various embodiments.

FIG. 4H illustrates an upper front right perspective view of the exterior of a device 100 which moves about and/or operates in relation to a pile of granular material, and which includes a separate auger payload 355, in accordance with various embodiments. In the illustrated embodiment, auger payload 355 is an articulable (up/down 475) rotary auger implement that is mounted to an exterior portion of the body 401 of robot 100. In some embodiments, auger payload 355 may be configured to be fixed in place rather than be articulable up and down. In some embodiments, an electrical and/or communicative coupling may conduct electrical power and/or control signals from within body 401 to power and/or control operation/movement of an attached payload implement 140, such as auger payload 355. For example, such control signals may raise or lower auger payload 355 along an arc 475, start/stop the rotation of rotatable auger component 407, control the direction of rotation of rotatable auger component 407, and/or control the speed of rotation of rotatable auger component 407.

Auger payload 355, as depicted, is configured with a rotatable auger component 407 which may be raised or lowered with lift arm 470. Lift arm 470 is actuated along an arced up/down path 475 by electric motor 472. Electric motor 474 spins a pulley (not visible) attached to a belt 476 disposed along the outside edge of lift arm 470. Belt 476 then spins the shaft 478 of rotatable auger component 407, which is coupled with lift arm 470. As the shaft 478 spins, so does rotatable auger component 407.

Auger payload 355 may also interchangeably be referred to as auger implement 355, as it serves as a tool for performing work in conjunction with device 100. For example, auger payload 355 may be employed, as an implement, by robot 100 for tasks such as moving material in the path of traversal of robot 100. Auger payload 355 may also be employed, as an implement, by robot 100 to erode a segment near the base of a vertical projection (e.g., a cliff or pillar). Auger payload 355 may also be used, as an implement, by robot 100 to break up chunks and/or crusts of granular material that exist on a surface which is traversed by robot 100. Robot 100 may use an auger payload 355 for moving material in a path of traversal of the robot, and in such a manner may be utilized to assist with the final cleanout of granular material in a bulk store, by sweeping the granular material piled on the floor of a bulk store and depositing it at an extraction point such as a door, or a sump auger entry, or a sweep auger. For example, device 100 may move across a slope (e.g., generally perpendicular to the slope of a pile of granular material) while rotating the rotatable auger component 407 of auger payload 355 in a selected direction to eject engaged granular material downslope. In some embodiments, robot 100 may remain stationary (and may use a spud or anchor to maintain a stationary position) while using auger payload 355 to move granular material. For example, robot 100 may use a spud or anchor to maintain a stationary cross-slope position while rotating the rotatable auger component 407 of auger payload 355 in a selected direction to eject engaged granular material downslope.

Though auger payload 355 is separate from the auger-based drive system of robot 100, in some embodiments, auger payload 355 may be employed as an auxiliary portion of the auger-based drive system of robot 100 which also includes augers 403. For example, rotatable auger component 407 of auger implement/payload 355 may be utilized to provide additional thrust or propulsion in a particular direction of travel of robot/device 100.

FIG. 4I illustrates an upper front right perspective view of the exterior of a device 100 which moves about and/or operates in relation to a pile of granular material, and which includes a separate broom payload 350, in accordance with various embodiments. In the illustrated embodiment, broom payload 350 is an articulable (up/down 475) rotary broom implement mounted to an exterior portion of the body 401 of robot 100. In some embodiments, broom payload 350 may be configured to be fixed in place rather than be articulable up and down. In some embodiments, an electrical and/or communicative coupling may conduct electrical power and/or control signals from within body 401 to power and/or control operation/movement of an attached payload implement 140, such as broom payload 350. For example, such control signals may raise or lower broom payload 350 along arc 475, start/stop the rotation of broom 408, control the direction of rotation of broom 408, and/or control the speed of rotation of broom 408.

Broom payload 350, as depicted, is configured with a rotatable broom 408 which may be raised or lowered with lift arm 470. Broom 408 may use blades, bristles, or other sweeping components. Lift arm 470 is actuated along an arced up/down path 475 by electric motor 472. Electric motor 474 spins a pulley (not visible) attached to a belt 476 disposed along the outside edge of lift arm 470. Belt 476 then spins the shaft 479 of broom 408, which is coupled with lift arm 470. As shaft 479 spins, so does broom 408.

Broom payload 350 may also interchangeably be referred to as broom implement 350 or broom 350, as it serves as a tool for performing work in conjunction with device 100. For example, broom payload 350 may be employed for tasks such as moving granular material in the path of traversal of robot 100. Broom payload 350 may also be employed to erode a segment near the base of a vertical projection (e.g., a cliff or pillar). Robot 100 may use a broom payload 350 for sweeping and/or moving material in a path of traversal of the robot, and in such a manner may be utilized to assist with the final cleanout of granular material in a bulk store, by sweeping the granular material piled on the floor of a bulk store and depositing it at an extraction point, such as a door, or a sump auger entry, or a sweep auger.

FIG. 4J illustrates a side plan view of the exterior of a device 100 which moves about and/or operates in relation to a pile of granular material and which includes a separate shovel payload/implement 352, in accordance with various embodiments. In the illustrated embodiment, scoop shovel payload 352 is mounted to the underside of body 401 by an arm 480 which is in a fixed angle/position with respect to body 401. Other mechanisms of attachment may be employed. Robot 100 may use a shovel payload 352 for pushing and/or scooping and moving material in a path of traversal of the robot, and in such a manner may be utilized to assist with the final cleanout of granular material in a bulk store, by scooping the granular material piled on the floor of a bulk store and depositing it at an extraction point, such as a door, or a sump auger entry, or a sweep auger.

### Example Systems

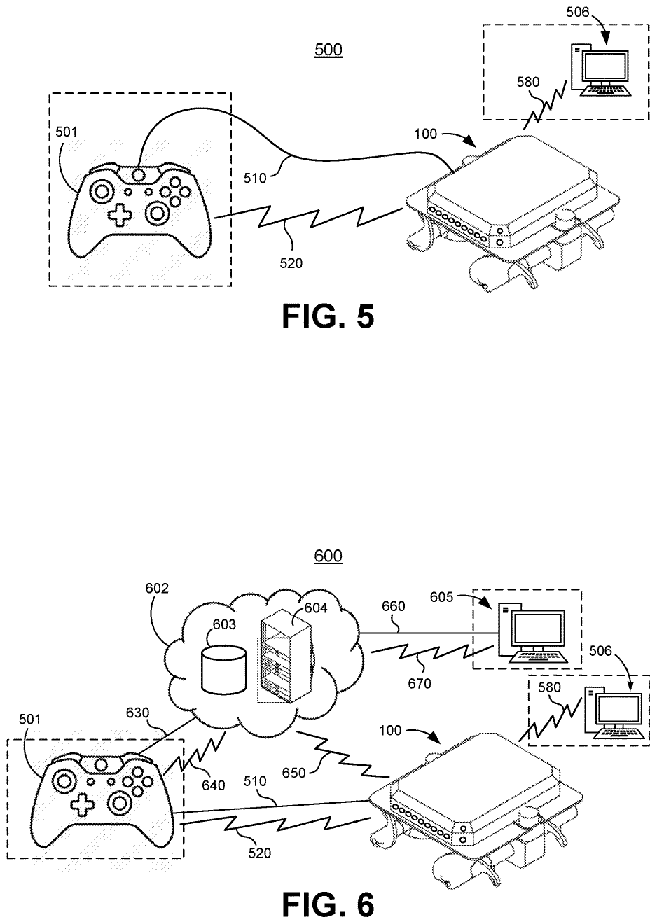

FIG. 5 illustrates some example embodiments of a bulk store slope adjustment system 500, in accordance with various embodiments. System 500 includes at least device 100 when operating autonomously. In some embodiments, system 500 may include device 100 and a remotely located remote controller 501, which is communicatively coupled by wireline 510 or wirelessly 520 with device 100 (e.g., to interface 104) to send instructions or data and/or to receive information or data collected by device 100 (e.g., from operation of device 100 and/or from sensor(s) 120 and/or payload(s) 140). Remote controller 501 may be like a handholdable remote controller for a video game, or a remotely controlled model car or model airplane. In some embodiments, remote controller 501 may have a display screen for visual display of textual information or still/video images received from device 100. In some embodiments, remote controller 501 is utilized by an operator to maneuver device 100 and/or to operate sensor(s) 120 and/or payload(s) 140. In some embodiments, system 500 may include device 100 and a remotely located computer system 506 which is communicatively coupled wirelessly 580 with device 100 to send instructions or data and/or to receive/access information or data collected by device 100 (e.g., from operation of device 100 and/or from sensor(s) 120 and/or payload(s) 140). In some embodiments, system 500 may include device 100 along with a communicatively coupled remote controller 501 and a communicatively coupled remotely located computer system 506. It should be appreciated that wireless communications 520 and 580 may be peer-to-peer, over a wide area network, or by other protocols.

FIG. 6 illustrates some example embodiments of a bulk store slope adjustment system 600, in accordance with various embodiments. In some embodiments, system 600 includes device 100 in wireless communicative coupling 650 (e.g., via the Internet) with one or more of cloud-based 602 storage 603 and processing 604. In some embodiments, cloud-based 602 storage 603 is used to store data collected by device 100. In some embodiments, cloud-based processing 604 is used to process data collected by device 100 and/or to assist in autonomous decision making based on collected data. In some embodiments, system 600 additionally includes a remotely located computer 605, communicatively coupled to cloud 602 (e.g., via the internet) either wirelessly 670 or by wireline 660. In this fashion, remotely located computer 605 may access data from device 100 which has been uploaded to storage 603 and/or may communicate with or access device 100 by relay through processing/computer system 605 or cloud 602. In some embodiments, system 600 may additionally include one or more components (remote controller 501 and/or remotely located computer system 506) which were described in FIG. 5. In some embodiments, one or more of remote controller 501 and remote computer system 506 may be communicatively coupled (e.g., 630/640) with cloud 602 for transmission and/or receipt of information related to device 100.

### Section 2

### Example Bulk Store and Example Operations to Adjust Slope of a Portion of Piled Granular Material

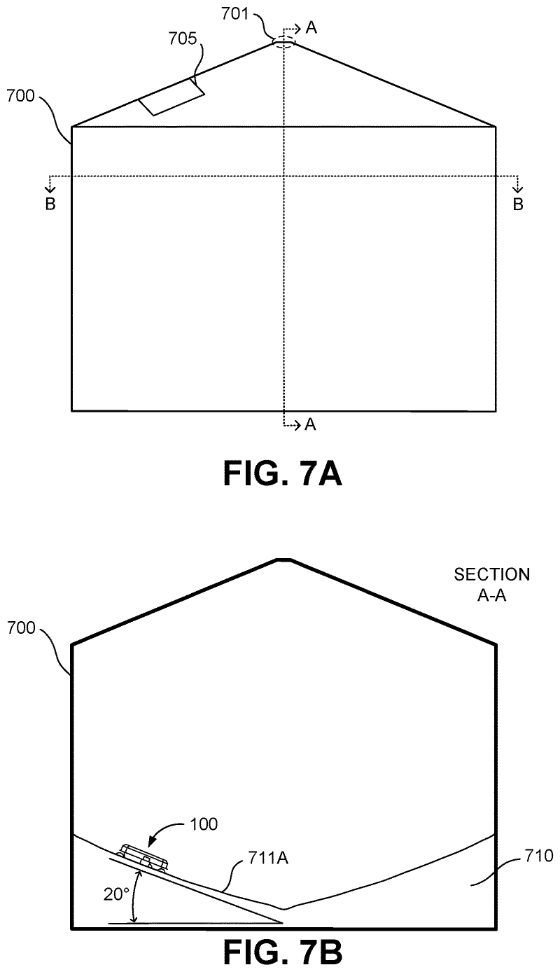

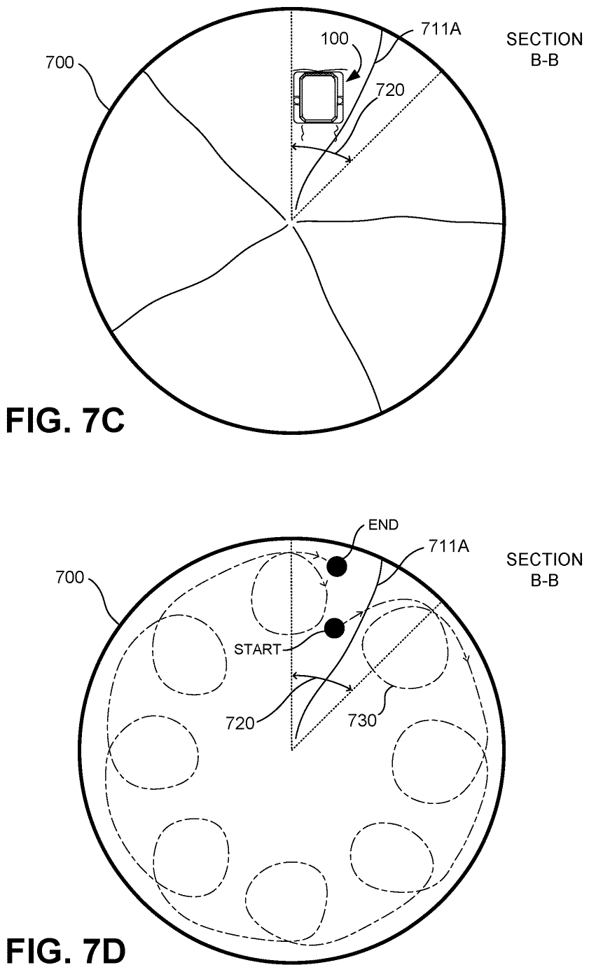

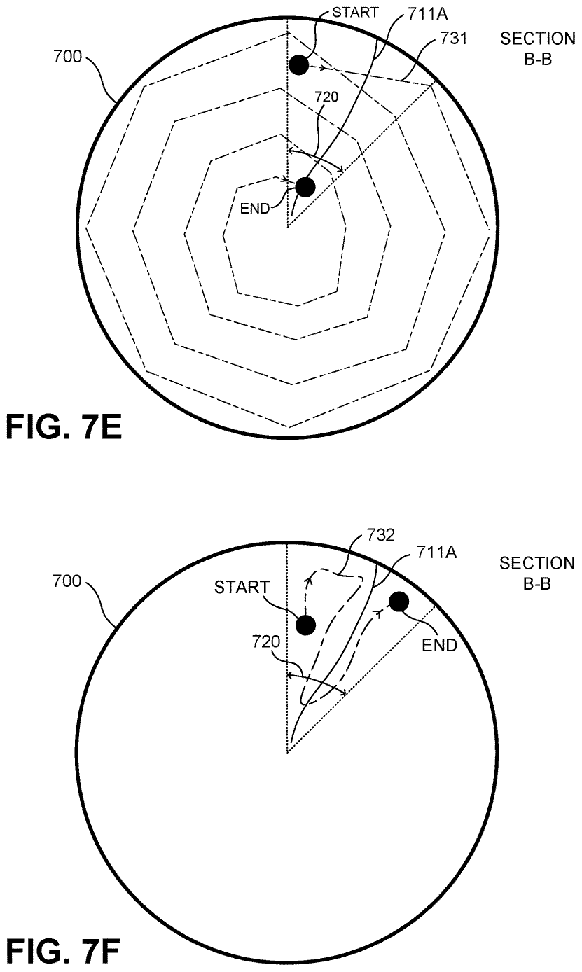

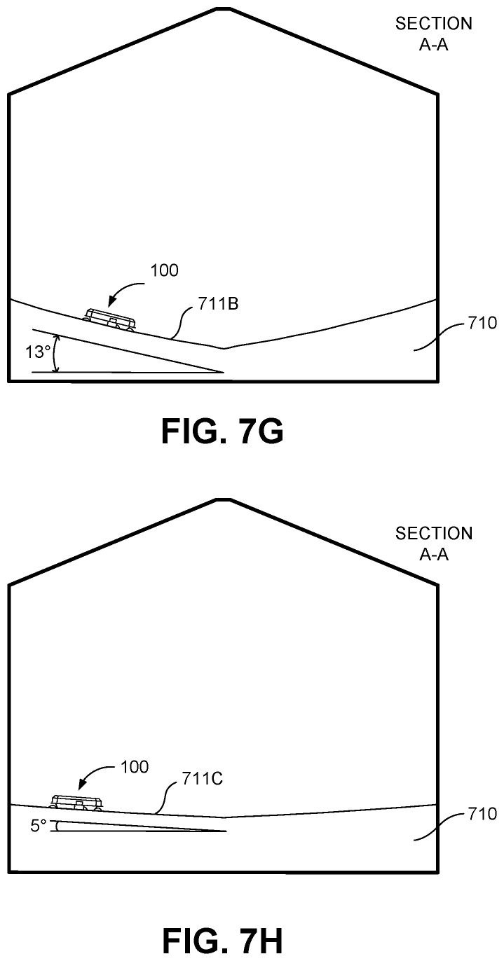

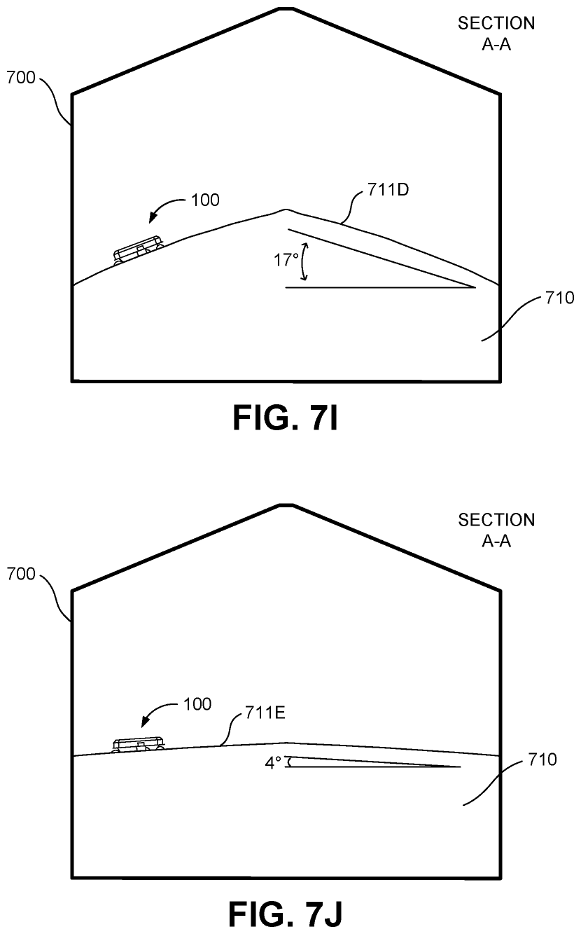

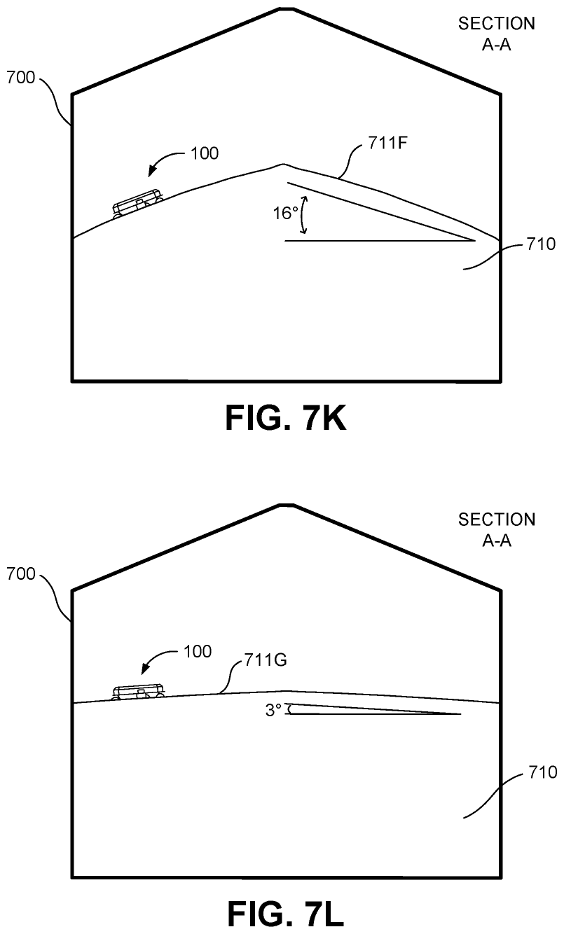

FIG. 7A illustrates an example bulk store 700 for granular material, in accordance with various embodiments. For purposes of example, and not limitation, bulk store 700 is depicted as a grain bin which is used to bulk store grain (e.g., edible seeds/beans such as corn, wheat, soybeans, peas, rice, beans, etc.). However, in other embodiments, bulk store 700 may store other granular materials. Bulk store 700 includes an access door 705 through which device 100 may be inserted into and/or removed from bulk store 700. Bulk store 700 also includes a top loading portal 701 through which bulk grain or other granular material may be filled into bulk store 700, by an auger or other filling system (not depicted in FIG. 7A), and then fall into bulk store 700 to form a pile of granular material (e.g., grain 710 shown in FIG. 7B). Section lines depict a location and a direction of Section A-A and Section B-B which will be illustrated in other figures.

FIG. 7B illustrates a side sectional view A-A of an example bulk store 700 for granular material which shows a device 100 moving about and/or operating in relation to a portion (portion 720 as shown in FIG. 7C) of piled granular material (e.g., grain 710) in the bulk store 700, in accordance with various embodiments. Because some of grain 710 has been removed from the bottom of bulk store 700, a cone-shaped concavity on surface 711A has been created with a slope of approximately 20 degrees down from the walls to the center of bulk store 700 in the portion of piled granular material where device 100 is operating. The slope of 20 degrees is used for example purposes only. The maximum angle of the downward slope from the sides to the middle (or from the middle to the sides) is dictated by the angle of repose, which differs for different granular materials and may differ for a particular granular material based on environmental physical characteristics (such as moisture) of the granular material. When a granular material is steeply sloped and near the angle of repose, it can be easily triggered to slide and cause entrapment of a person. When the slope of a granular material exceeds its angle of repose, it slides (like an avalanche). Additionally, when a surface 711A of grain 710 becomes steeply sloped toward the center (as illustrated) during removal of grain 710 from bulk store 700, it means that much of the removed grain is coming out from the center of the bin, rather than a mixture of grain from all areas of the bin. Leveling, or reduction of slope, of an inwardly sloped pile, reduces the risk of a slide from a steeply sloped surface 711A and distributes grain from the high sloped edges to prevent/reduce spoilage of those portions of the grain.

Due to the friction of augers 403 against grain 710 and the agitation of augers 403 caused to grain 710 when device 100 traverses a portion of piled granular material (e.g., portion 720 of grain 710), the viscosity of the piled granular material at or near surface 711A is disrupted. The disruption of viscosity lowers the angle of repose and, because of the slope being caused to exceed the angle of repose, incites sediment gravity flow in the portion of piled granular material down the slope. Additionally, rotational movement of the augers also displaces grain 710 and can be used to auger the grain in a desired direction or expel it such that gravity carries it down slope. Either or both of these actions can be used to disperse grain 710 and/or to adjust (reduce) the slope of the surface 711A of portion 720 and other similar portions.

FIG. 7C illustrates a top sectional view B-B of an example bulk store 700 for granular material which shows a device 100 moving about and/or operating on surface 711A in relation to a portion 720 of piled granular material 710 in the bulk store 700, in accordance with various embodiments.

FIG. 7D illustrates a top sectional view B-B of an example bulk store 700 for granular material which shows pattern 730 for moving a device 100 about and/or operating on surface 711A in relation to a portion 720 of piled granular material 710 in the bulk store 700, in accordance with various embodiments. In some embodiments, pattern 730 may be manually driven by a remotely located operator via remote controller 501 (for example). In some embodiments, pattern 730 may be autonomously driven by device 100. In some embodiments, pattern 730 may be initiated due to a first measurement of the angle of slope of the surface 711A of grain 710 in portion 720 satisfying a first condition such as being beyond an acceptable threshold angle (e.g., 10 degrees of slope). Pattern 730 or other patterns of traversal of portion 720 may be repeatedly driven until a follow-on measurement of the angle of slope of grain 710 in portion 720 meets a second condition (e.g., falls below the threshold angle or falls below some other angle such as 7 degrees). In this manner, a portion (e.g., portion 720) or all of the grain in bulk store 700 can have its slope adjusted downward, closer to level.

FIG. 7E illustrates a top sectional view B-B of an example bulk store 700 for granular material which shows pattern 731 for moving a device 100 about and/or operating on surface 711A in relation to a portion 720 of piled granular material 710 in the bulk store 700, in accordance with various embodiments. In some embodiments, pattern 731 may be manually driven by a remotely located operator via remote controller 501 (for example). In some embodiments, pattern 731 may be autonomously driven by device 100. In some embodiments, pattern 731 may be initiated due to a first measurement of the angle of slope of surface 711A of grain 710 in portion 720 satisfying a first condition such as being beyond an acceptable threshold angle (e.g., 10 degrees of slope). Pattern 731 or other pattern(s) of traversal of portion 720 may be repeatedly driven until a follow-on measurement of the angle of slope of surface 711A of grain 710 in portion 720 meets a second condition (e.g., falls below the threshold angle or falls below some other angle such as 7 degrees). In this manner, a portion (e.g., portion 720) or all of the grain in bulk store 700 can have its surface slope adjusted downward, closer to level.

FIG. 7F illustrates a top sectional view B-B of an example bulk store 700 for granular material which shows pattern 732 for moving a device 100 about and/or operating on surface 711A in relation to a portion 720 of piled granular material 710 in the bulk store 700, in accordance with various embodiments. In some embodiments, pattern 732 may be manually driven by a remotely located operator via remote controller 501 (for example). In some embodiments, pattern 732 may be autonomously driven by device 100. In some embodiments, pattern 732 may be initiated due to a first measurement of the angle of slope of surface 711A of grain 710 in portion 720 satisfying a first condition, such as being beyond an acceptable threshold angle (e.g., 10 degrees of slope). Pattern 732 or other pattern(s) of traversal of portion 720 may be repeatedly driven until a follow-on measurement of the angle of slope of surface 711A of grain 710 in portion 720 meets a second condition (e.g., falls below the threshold angle or falls below some other angle, such as 7 degrees). In this manner, a portion (e.g., portion 720) or all of the grain in bulk store 700 can have its surface slope adjusted downward, closer to level. In FIG. 7F, pattern 732 is confined to portion 720. In such an embodiment, only this portion may be leveled by device 100, or else device 100 may work its way around bulk store 700, portion by portion, leveling surface 711A in each portion completely or incrementally before moving to the next portion.

FIGS. 7D-7F illustrate only three example patterns; many other patterns are possible and anticipated, including, but not limited to: grid patterns, circular patterns, symmetric patterns, unsymmetrical patterns, spiral patterns, random/chaos motion (e.g., patternless), patterns/paths that are dynamically determined based on the slope and changes of the slope, and patterns which are cooperatively executed by two or more devices 100 working in communication with one another. Any of the patterns executed by device 100 may be stored in host memory 103 for automated execution by processor 102 controlling the movements of device 100 to traverse the pattern. Similarly, patternless or dynamic movement may be executed by processor 102 in an automated fashion by controlling the movements of device 100, such as to seek out portions with a slope which satisfies a first condition and traverse them until the slope satisfies the second condition.

In some embodiments, patterns or traversal operations may similarly be utilized to break up and distribute grain 710 to assist it in drying out, to prevent a crust from forming, to inspect grain, to push grain towards a sweep auger or other uptake, and/or to diminish spoilage.

In some embodiments, patterns or traversal operations may similarly be utilized to level peaks which form in grain or other piled granular material due to the method and/or location in which it is loaded into a bulk store. Such leveling better utilizes available storage space, reduces crusts or pipe formation, reduces hotspots, and/or more evenly distributes granular material of differing moisture contents.

FIG. 7G illustrates a side sectional view A-A of an example bulk store 700 for granular material 710, which shows a device 100 moving about and/or operating in relation to one or more portions (e.g., portion 720 and the like) on the surface 711B of piled granular material 710 in the bulk store 700, in accordance with various embodiments. FIG. 7G is similar to FIG. 7B, except that the slope of the upper surface 711B has been downwardly adjusted from 20 degrees of surface 711A to approximately 13 degrees (as measured by device 100 or other means) by traversal of the surface by device 100 in the manner previously described to effect surface leveling and slope adjustment (i.e., traversed in a “leveling traversal”). In an embodiment where this 13-degree slope is below a predetermined threshold, leveling and slope adjustment operations may cease. In an embodiment where this 13-degree slope is above a predetermined threshold, leveling and slope adjustment operations may continue toward achieving a slope threshold which is closer to 0 degrees.

FIG. 7H illustrates a side sectional view A-A of an example bulk store 700 for granular material 710, which shows a device 100 moving about and/or operating in relation to one or more portions (e.g., portion 720 and the like) on the surface 711C of piled granular material 710 in the bulk store 700, in accordance with various embodiments. FIG. 7H is similar to FIG. 7G except that the slope of the upper surface 711C has been further downwardly adjusted from 13 degrees of surface 711B to approximately 5 degrees (as measured by device 100 or other means) by traversal of the surface by device 100 in the manner previously described to effect surface leveling and slope adjustment (i.e., traversed in a “leveling traversal”). In an embodiment where this 5-degree slope is below a predetermined threshold, leveling and slope adjustment operations may cease. In an embodiment where this 5-degree slope is above a predetermined threshold, leveling operations may continue toward achieving a slope threshold which is closer to 0 degrees.

FIG. 7I illustrates a side sectional view A-A of an example bulk store 700 for granular material 710, which shows a device 100 moving about and/or operating in relation to one or more portions (e.g., portion 720 and the like) on the surface 711D of piled granular material 710 in the bulk store 700, in accordance with various embodiments. FIG. 7I differs from FIGS. 7B, 7G, and 7H, in that the slope of surface 711D of grain 710 is now peaked in the middle and low on the edges, sloping downward at about 17 degrees from the center due to filling of additional grain 710 atop surface 711C of FIG. 7H via a centrally located top loading portal 701 (see e.g., FIG. 7A). In some embodiments, device 100 can operate in the same manner to level grain 710 during and/or after completion of the fill operation.

FIG. 7J illustrates a side sectional view A-A of an example bulk store 700 for granular material 710, which shows a device 100 moving about and/or operating in relation to one or more portions (e.g., portion 720 and the like) on the surface 711E of piled granular material 710 in the bulk store 700, in accordance with various embodiments. FIG. 7J is similar to FIG. 7I except that the slope of the upper surface 711E has been downwardly adjusted from 17 degrees of surface 711D to approximately 4 degrees (as measured by device 100 or other means) by traversal of the surface by device 100 in the manner previously described for surface leveling and slope adjustment (i.e., traversed in a “leveling traversal”). In an embodiment where this 4-degree slope is below a predetermined threshold, leveling and slope adjustment operations may cease. In an embodiment where this 4-degree slope is above a predetermined threshold, leveling operations may continue toward achieving a slope threshold which is closer to 0 degrees.

FIG. 7K illustrates a side sectional view A-A of an example bulk store 700 for granular material 710, which shows a device 100 moving about and/or operating in relation to one or more portions (e.g., portion 720 and the like) on the surface 711F of piled granular material 710 in the bulk store 700, in accordance with various embodiments. FIG. 7K illustrates an embodiment where additional grain 710 has been loaded atop the substantially leveled surface 711E of FIG. 7J and is now peaked in the middle and low on the edges, sloping downward at about 16 degrees from the center due to filling of additional grain 710 atop surface 711E of FIG. 7J via a centrally located top loading portal 701 (see e.g., FIG. 7A). In some embodiments, device 100 can operate in the same manner to level grain 710 during and/or after completion of the fill operation.

FIG. 7L illustrates a side sectional view A-A of an example bulk store 700 for granular material 710, which shows a device 100 moving about and/or operating in relation to one or more portions (e.g., portion 720 and the like) on the surface 711G of piled granular material 710 in the bulk store 700, in accordance with various embodiments. FIG. 7L is similar to FIG. 7K except that the slope of the upper surface 711G has been downwardly adjusted from about 16 degrees of surface 711F to approximately 3 degrees (as measured by device 100 or other means) by traversal of the surface by device 100 in the previous manner for surface leveling and slope adjustment (i.e., traversed in a “leveling traversal”). In an embodiment where this 3-degree slope is below a predetermined threshold, leveling and slope adjustment operations may cease. In an embodiment where this 3-degree slope is above a predetermined threshold, leveling operations may continue toward achieving a slope threshold which is closer to 0 degrees.

### Example Method(s) of Bulk Store Slope Adjustment

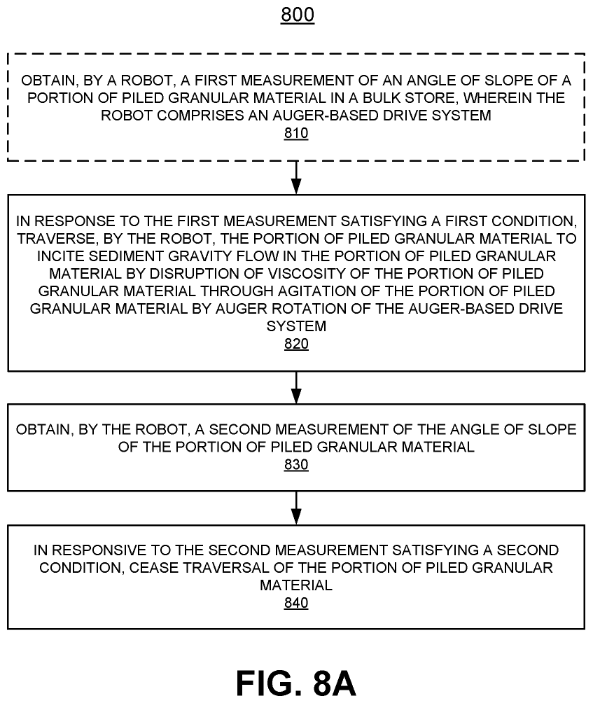

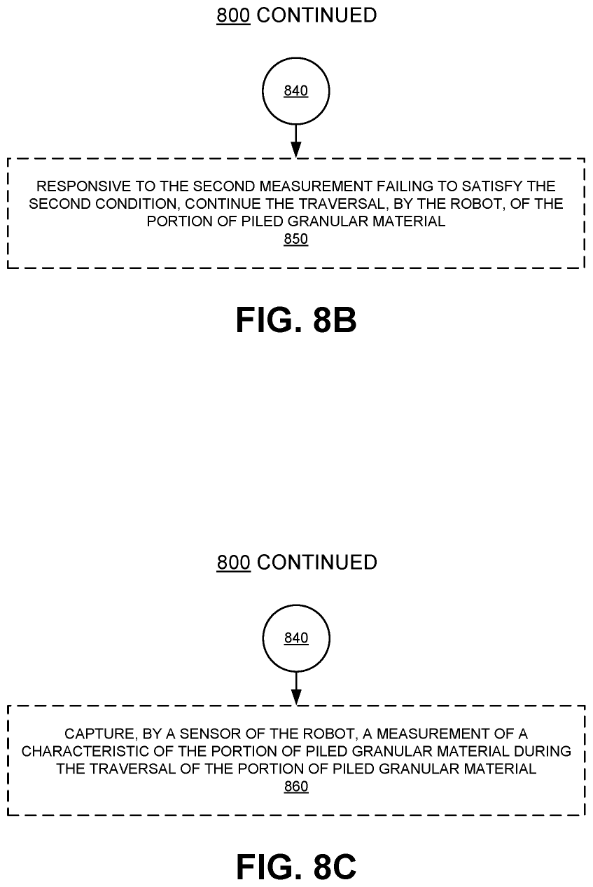

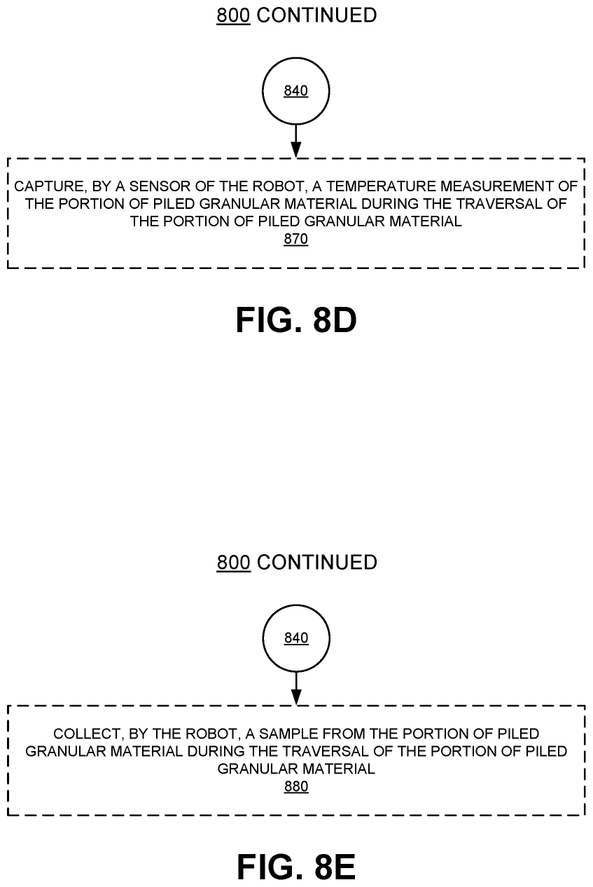

Procedures of the methods illustrated by flow diagram 800 of FIGS. 8A-8E will be described with reference to elements and/or components of one or more of FIGS. 1-7L. It is appreciated that in some embodiments, the procedures may be performed in a different order than described in a flow diagram, that some of the described procedures may not be performed, and/or that one or more additional procedures to those described may be performed. Flow diagram 800 includes some procedures that, in various embodiments, are carried out by one or more processors (e.g., host processor 102 or any processor of device 100 or a computer or system to which device 100 is communicatively coupled) under the control of computer-readable and computer-executable instructions that are stored on non-transitory computer-readable storage media (e.g., host memory 103, other internal memory of device 100, or memory of a computer or system to which device 100 is communicatively coupled). It is further appreciated that one or more procedures described in flow diagram 800 may be implemented in hardware, or a combination of hardware with firmware and/or software.

For purposes of example only, device 100 of FIGS. 1-7L is a robotic device that utilizes augers (403) to move and maneuver with respect to piled granular material, such as, but not limited to, grain. Robot 100 will be described as operating on or in relation to piled granular material in a bulk store, such as, but not limited to, grain in a grain bin. In some embodiments, the robot 100 is free of mechanical coupling with a structure (e.g., the bulk store) in which the piled granular material is contained. For example, in some embodiments, there is no tether or safety harness coupling the robot 100 to the grain storage bin, and it operates autonomously or under wireless remote control. In some embodiments, robot 100 performs the method of flow diagram 800 completely autonomously. In some embodiments, robot 100 performs the method of flow diagram 800 semi-autonomously, such as by measuring a slope of grain, sending the slope to an external computer system, which then determines a pattern for robot 100 to autonomously execute when traversing the piled grain. In some embodiments, robot 100 performs the method of flow diagram 800 semi-autonomously, such as by receiving a remotely measured slope of grain, then autonomously determining a pattern for robot 100 to autonomously execute when traversing the piled grain.

FIGS. 8A-8E illustrate a flow diagram 800 of an example method of bulk store slope adjustment, in accordance with various embodiments.

With reference to FIG. 8A, at procedure 810 of flow diagram 800, in various embodiments, a robot 100 that includes a processor 102, a memory 103, and an auger-based drive system (e.g., augers 403), obtains a first measurement of an angle of slope of a portion of piled granular material in a bulk store, wherein the robot 100 comprises an auger-based drive system. With reference to FIGS. 7A-7L, this can comprise a measure of the angle of slope of the surface 711 of portion 720 of grain 710 in bin 700. The angle can be measured and obtained autonomously by robot 100 or can be measured by a device external to robot 100 and then obtained by being communicated to or accessed by robot 100. In an embodiment, where the angle of slope of surface 711 is measured by robot 100, motion sensor(s) 220 may be used to measure the angle of robot 100 on a slope of portion 720 to approximate the angle of the slope. In some embodiments, procedure 810 may be skipped and an operator may simply direct robot 100 to begin traversal of a portion (e.g., portion 720) of piled granular material.

With continued reference to FIG. 8A, at procedure 820 of flow diagram 800, in various embodiments, in response to the first measurement satisfying a first condition, the robot 100 traverses the portion of piled granular material to incite sediment gravity flow in the portion of piled granular material by disruption of the viscosity of the portion of piled granular material through agitation of the portion of piled granular material by auger rotation of the auger-based drive system. The traversal may be controlled by host processor 102 via control of the direction of rotation and/or the speed of rotation of augers 403 of robot 100. Robot 100 may traverse the portion (e.g., portion 720) of the surface 711 of piled granular material (e.g., piled grain 710) in a predetermined pattern, which may be a predetermined pattern of movement stored in host memory 103 of robot 100. Robot 100 may traverse the portion (e.g., portion 720) of piled granular material (e.g., piled grain 710) in a patternless or random/chaotic manner or by following dictates other than a pattern, such as by dynamically seeking out areas of slope above a certain measure. In some embodiments, a pattern may be changed or altered based on information sensed by robot 100.

With continued reference to FIG. 8A, at procedure 830 of flow diagram 800, in various embodiments, robot 100 obtains a second measurement of the angle of slope of the portion of piled granular material. This second measurement is obtained after the robot has traversed the portion (e.g., portion 720) of surface 711 following a pattern, for a predetermined period of time, or based on other criteria for re-measurement of the slope. The second angle measurement can be measured and obtained autonomously by robot 100 or can be measured by a device external to robot 100 and then obtained by being communicated to or accessed by robot 100.

With continued reference to FIG. 8A, at procedure 840 of flow diagram 800, in various embodiments, in response to the second measurement satisfying a second condition, robot 100 ceases traversal of the portion of piled granular material. In some embodiments, the first condition is related to a first angle and the second condition is related to a second angle.

In some embodiments, where the first angle is the same as the second angle, the first condition may be met when the first measurement exceeds the angle, and the second condition may be met when the second measurement falls below the angle. For example, the angle may be 10 degrees, and when the first measurement is 20 degrees, traversal will continue until the angle is adjusted to below 10 degrees.

In some embodiments, where the first angle and the second angle are different, the first angle is larger than the second angle. For example, the first angle may be 10 degrees, while the second angle is 5 degrees. In such an embodiment, when the first measurement is 20 degrees, traversal will continue until the angle meets the second condition (e.g., drops below 5 degrees).

With reference to FIG. 8B, at procedure 850 of flow diagram 800, in various embodiments, in response to the second measurement failing to satisfy the second condition, robot 100 continues traversal of the portion of piled granular material. For example, if the second condition specifies that the measurement of slope needs to be reduced to below 5 degrees, the robot would continue traversal of the portion of piled granular material in response to the second measurement being 13 degrees.

With reference to FIG. 8C, at procedure 860 of flow diagram 800, in various embodiments, during traversal of the portion (e.g., 720) of piled granular material by robot 100, a sensor 120 of robot 100 acts under the instruction of host processor 102 to capture a measurement of a characteristic of the portion of piled grain. Some example characteristics include, but are not limited to, capturing a measurement of: temperature, humidity, moisture, gas composition, electrostatic nature, and/or electrochemical nature. A measured characteristic may also comprise an optical and/or infrared image. The captured measurement of a characteristic can be stored within memory 103 or transmitted from robot 100. In some embodiments, the captured measurement of a characteristic is paired with a location of robot 100 at the time of capture of the measurement. Such paired data can be used to create a characteristic map of the piled granular material that is traversed by robot 100.

In some embodiments, the captured measurement(s) of characteristic(s) may be transmitted to a base station (506, 605) communicatively coupled with robot 100. The base station (506, 605) is located remotely from the robot and may be configured to communicate with robot 100 over the Internet, via a wide-area network, via a peer-to-peer communication, or by other means. Via such communications, the base station (506, 605) may receive data collected by robot 100 (including motion sensor data) collected by the robot during the traversal of the portion of piled granular material. Additionally, or alternatively, via such communications, the base station (506, 605) may relay instructions to robot 100.

In some embodiments, the captured measurement(s) of characteristic(s) may be transmitted to a cloud-based 602 storage 603 and/or processing 604 which is/are communicatively coupled with robot 100. The cloud-based infrastructure 602 may be utilized to process data, store data, make data available to other devices (e.g., computer 605), and/or relay information or instructions from other devices (e.g., computer 605) to robot 100.

With reference to FIG. 8D, at procedure 870 of flow diagram 800, in various embodiments, a temperature sensor 233, infrared sensor 236, or infrared camera 108 of robot 100 is used to capture a temperature measurement of the portion of piled granular material during the traversal of the portion of piled granular material. In some embodiments, the captured measurement of a characteristic is paired with a location of robot 100 at the time of capture of the temperature measurement. Such paired data can be used to create a heat map of the piled granular material which is traversed by robot 100.

The heat map, when implemented, provides a data visualization that shows changes in temperature as changes in surface color or shading relative to the traversed surface or a depiction thereof. It should be appreciated that the heat map type visualization can similarly be used to show changes in other measured data relative to a traversed surface or depiction thereof. In other embodiments, the paired data may be graphed or mapped spatially such as on a depiction of the traversed surface; and, in some embodiments, the spatially mapped/graphed data is interactive such that a user may click on a point of paired data to show a visualization of the underlying data associated with the paired data (e.g., the measured 3-D location and temperature). It should be noted that such heat maps and spatially mapped/graphed data are formatted, in some embodiments, for display on a computer or monitor display (e.g., the display associated with a controller 501, a computer 506, a computer 605, or the like) to support management of the piled granular material and the bulk store during loading, storage, and/or unloading of the piled granular material. Among other management activities, the collected and visually displayed data may assist a human (e.g., a farmer, worker, bin manager) in controlling hot spots, controlling mold conditions, manipulating grain to reduce spoilage, manipulating grain to reduce formation of grain bridges, manipulating grain to reduce formation of BGFM (e.g., small particles, broken grain, chaff, and the like), manipulating grain to unload grain with desired characteristics (e.g., desired moisture level and/or desired visual exterior surface characteristics such as low cracking), managing or having knowledge of a slope of the piled grain, etc.

With reference to FIG. 8E, at procedure 880 of flow diagram 800, in various embodiments, robot 100 collects a sample from the portion of piled granular material during the traversal of the portion of piled granular material. For example, with reference to FIG. 4A-2, processor 102 or a remotely located operator may direct a sample collection device, such as gatherer payload 342, to open to collect a sample of grain at a particular location and to close after a sample is collected or a predetermined time period has elapsed.

### Mapping Piled Granular Material in a Bulk Store

In various embodiments, for example, device 100 can operate via remote controlled instruction, autonomously, or some combination thereof. Although various embodiments of a device 100 are described herein (e.g., device 100, device 100B), it is referred to generically as device 100. Also, as discussed above, device 100 is robotic and may be referred to as a “robot” (e.g., “robot 100”) or as a “robotic device,” (e.g., “robotic device 100”) or the like. Device 100 includes an auger-based drive system which facilitates the movement and/or operation of device 100 in relation to a portion of piled granular material (e.g., grain) in a bulk store 700, such as a grain bin.

A device 100 may record its location in three dimensions as it traverses a surface 711 of a piled granular material 710 in a bulk store 700. For example, three-dimensional positions may be recorded during any traversal, such as a random traversal, a traversal in a pattern such as the example patterns illustrated in FIGS. 7D-7F, or during a pattern executed purposefully for mapping or surface management, during slope adjustment, during maintenance traversals, during traversals to break up a crust, and during traversals to remove vertical projections. The positions may be stored and later or on-the-fly assembled into a three-dimensional map of the surface 711 of the piled granular material 710 (e.g., grain). The assembly of the map may be performed by device 100, or the positions may be communicatively coupled, such as by wireless communication, to an external computer system 506 located remotely from the device. The external computer system 506 may then assemble the recorded locations into a three-dimensional map of the surface 711 of the piled granular material 710 (e.g., grain).

Positions of device 100 may be acquired by any suitable means, including but not limited to: differential Global Navigation Satellite System (GNSS) positioning, real-time kinematic GNSS positioning, triangulation from at least two known points marked inside and/or outside the bulk store 700 (e.g., by optically, sonically, ultrasonically, or via radio signals measuring angle and distance to the known points); using motion sensors 220 and additionally a barometric sensor 239 (in some embodiments) as an internal inertial measurement unit (IMU) to navigate from a known starting location; and receiving a position communicated (wirelessly) from an external source, such as a camera or laser measuring device mounted to the internal roof or upper wall of a bulk store (e.g., bulk store 700). In various embodiments, more than one positioning means may be used.

The three-dimensional map may be assembled by plotting the recorded locations, such as on a three-dimensional graph with X, Y, and Z axes. This three-dimensional map may be viewed in any desired orientation or view and may be overlaid on a depiction of the bulk store 700 in which the assembled positions were recorded. In some embodiments, the three-dimensional map may be used to determine how much, if any, leveling needs to be performed on a surface 711 of a piled granular material 710. In some embodiments, when coupled with a known location of a bottom surface of a bulk store 700 (such as a grain bin), the volume between the mapped three-dimensional surface 711 (e.g., a surface contour map) and the bottom of the bulk store 700 may be calculated by device 100 or the external computer system 506.

Additionally, during any traversal of piled granular material 710, device 100 may capture one or more environmental characteristics with its sensors (e.g., temperature (with temperature sensor 233), humidity (e.g., with humidity sensor 242), moisture (e.g., directly with moisture sensor 234 or indirectly via calculation from measured temperature and humidity), amount of carbon dioxide (e.g., with carbon dioxide sensor 241), a measurement of atmospheric pressure (e.g., with barometric sensor 239), an optical image (e.g., with optical sensor/camera 235) to record visible environmental conditions, and an infrared image (e.g., with infrared sensor/camera 236), among others. For example, one or more sensors 120 of device 100 may capture measurements of environmental characteristics relative to the piled granular material being traversed by device 100. In some embodiments, such measurements may be taken at locations that are specified by coordinates with respect to the bulk store 700. In some embodiments, such measurements may be taken at intervals of time passed and/or distance traveled. In an example of time separated measurement intervals, an environmental measurement may be taken by one or more of the sensors 120 every 5 seconds, every 10 seconds, or more than once per second (e.g., 2, 3, or 10 times per second) as device 100 traverses. In an example of distance separated measurement intervals, an environmental measurement may be taken by one or more of the sensors 120 each time device 100 has moved a specified distance from a previous location (e.g., every centimeter of travel, every 5 centimeters of travel, every 10 centimeters of travel, every meter of travel, etc.). In some embodiments, the time and/or three-dimensional location of an environmental measurement captured by a sensor 120 is/are noted and stored in conjunction with captured environmental characteristics.

In some embodiments, device 100 may assemble the captured environmental characteristic(s) onto the three-dimensional surface map of the surface 711 of a piled granular material 710. In other embodiments, device 100 may communicatively couple (e.g., by wireless communication) the environmental characteristics and their respective three-dimensional locations and/or times of capture to external computer system 506, which then assembles them onto the three-dimensional surface map of the surface 711 of a piled granular material 710.

In some embodiments, multiple three-dimensional maps may be made over time, such as during filling or withdrawal of piled granular material 710 from the bulk store 700. These maps may be combined to form a three-dimensional map of the captured environmental characteristics of the piled granular material 710. The assembly of multiple surface maps in this manner may be accomplished by device 100 or computer system 506, or other computing system that is supplied with the captured environmental characteristics and respective three-dimensional locations of capture.

A device 100 may operate as an assistant in the management of grain that is stored in a bulk store. By way of example, and not of limitation, the grain may be stored within a grain bin, and the device 100 may operate to assist with management of a grain bin: prior to load-in of grain, during load-in of grain, after load-in of grain, during long term storage of grain, during extraction of grain, and/or during final clean-out of grain from a bin. The management may be a primary role of device 100 or as an extension of a device 100 traversing the surface of piled granular material for leveling, mapping, or other reasons. The device 100 may similarly assist with management of grain stored in other bulk stores, many types of which have been described herein.

During load-in traversals of piled granular material, during a maintenance traversal of a surface of piled granular material, or during a load-out traversal of piled granular material, a robot 100 may utilize a sensor 120 of robot 100, acting under the instruction/direction of host processor 102, to capture a measurement of a characteristic of the surface of piled granular material. Some example characteristics include, but are not limited to, capturing a measurement of: temperature, humidity, moisture, gas composition, electrostatic nature, and/or electrochemical nature. A measured characteristic may also comprise an optical and/or infrared image. The captured measurement of a characteristic can be stored within memory 103 or transmitted from robot 100. In some embodiments, the captured measurement of a characteristic is paired with a location of robot 100 at the time of capture of the measurement. Such paired data can be used to create a characteristic map of the piled grain which is traversed by robot 100. In a like fashion, the recorded positions of a robot 100 during one or more traversals may be utilized to create a three-dimensional map of the surface. This surface mapping may be referred to as a contour map and may include elevations of the contours.

In some embodiments, the captured measurement(s) of characteristic(s) may be transmitted to a base station (506, 605) that is/are communicatively coupled with robot 100. The base station (506, 605) is located remotely from the robot and may be configured to communicate with robot 100 over the Internet, via a wide-area network, via a peer-to-peer communication, or by other means. Via such communications, the base station (506, 605) may receive data collected by robot 100 (including motion sensor data) collected by the robot during the traversal of the portion of piled grain. Additionally, or alternatively, via such communications, the base station (506, 605) may relay instructions to robot 100.

In some embodiments, the captured measurement(s) of characteristic(s) may be transmitted to a cloud-based 602 storage 603 and/or processing 604 which is/are communicatively coupled with robot 100. The cloud-based infrastructure 602 may be utilized to process data, store data, make data available to other devices (e.g., computer 605), and/or relay information or instructions from other devices (e.g., computer 605) to robot 100.

### Section 3

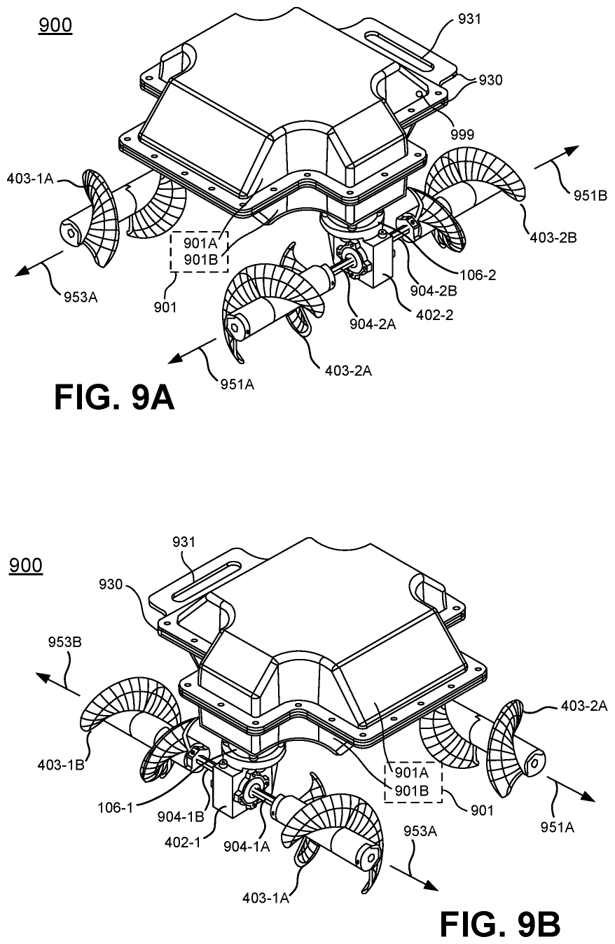

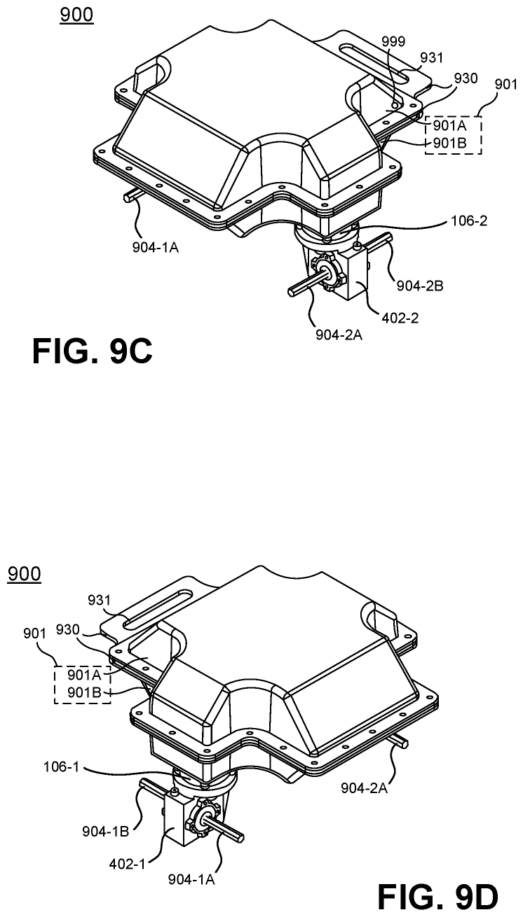

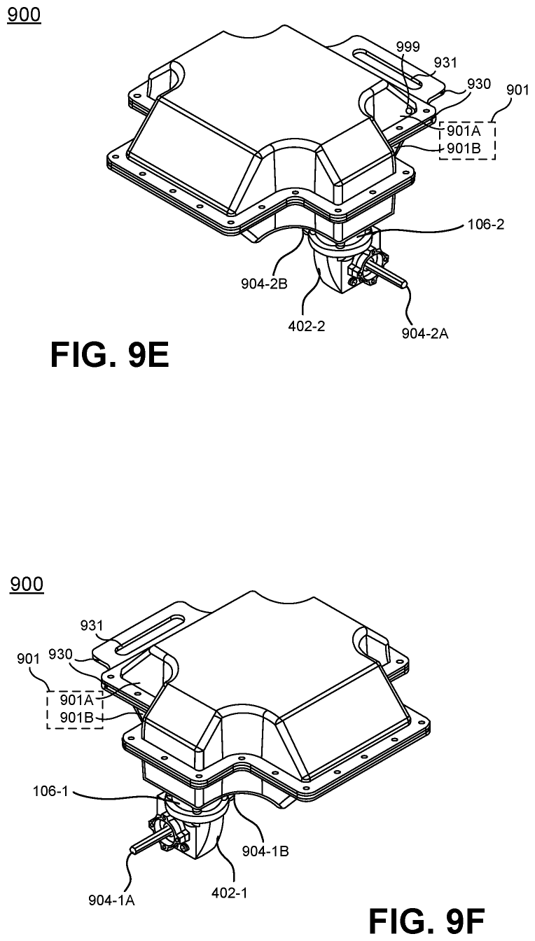

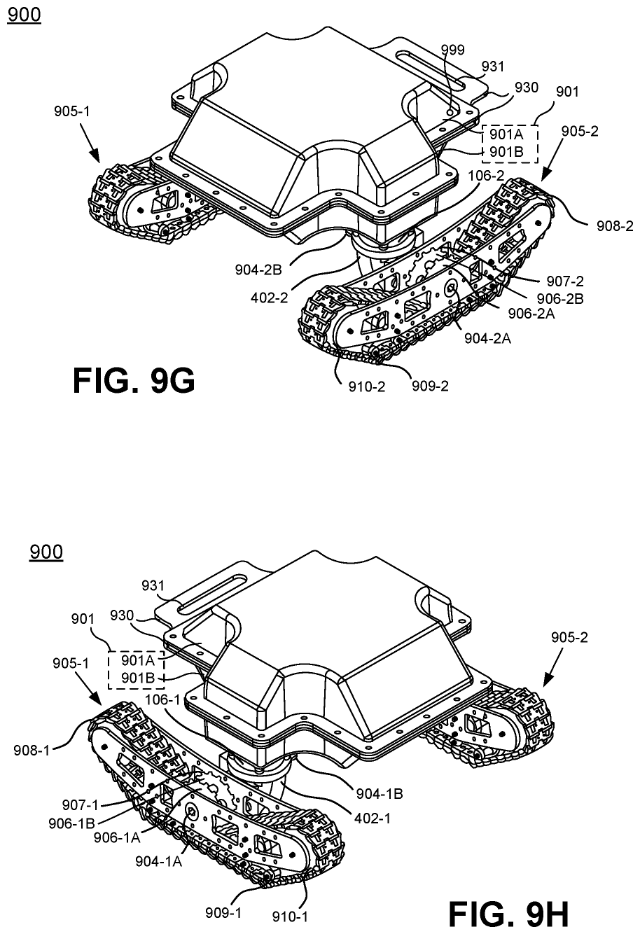

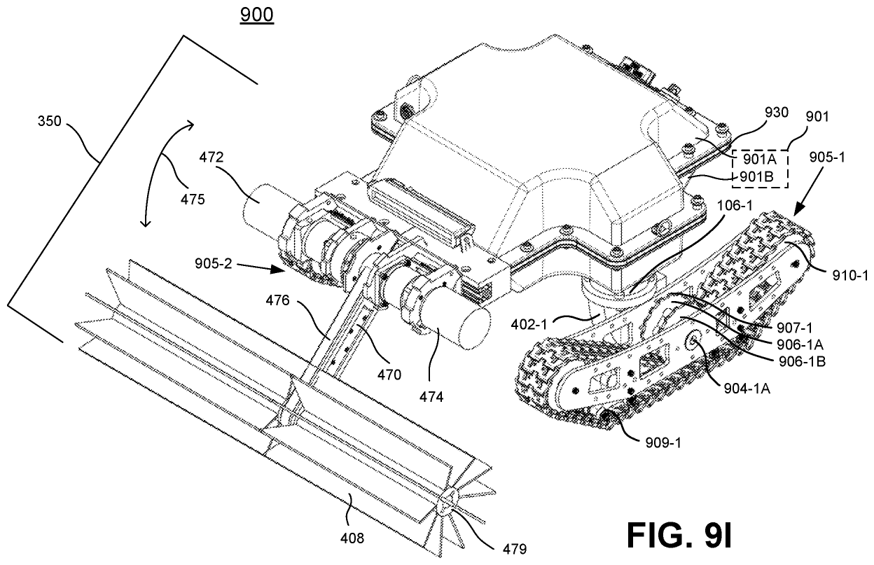

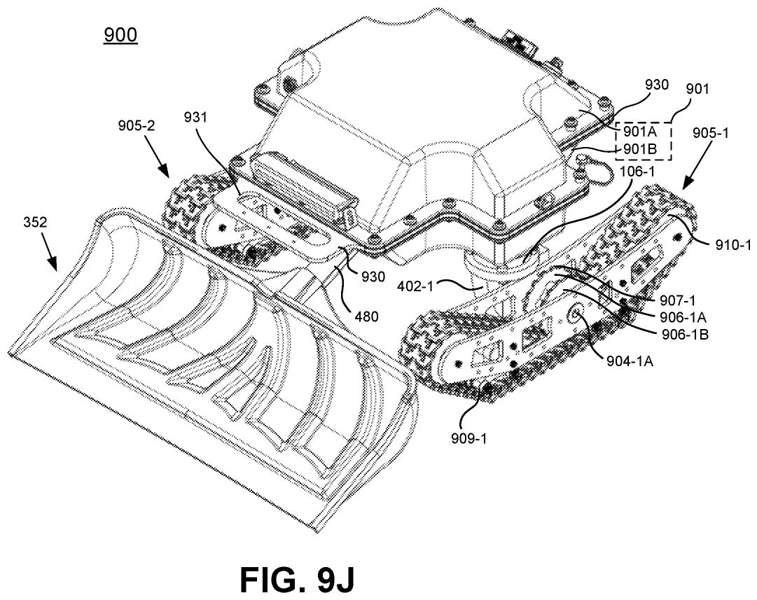

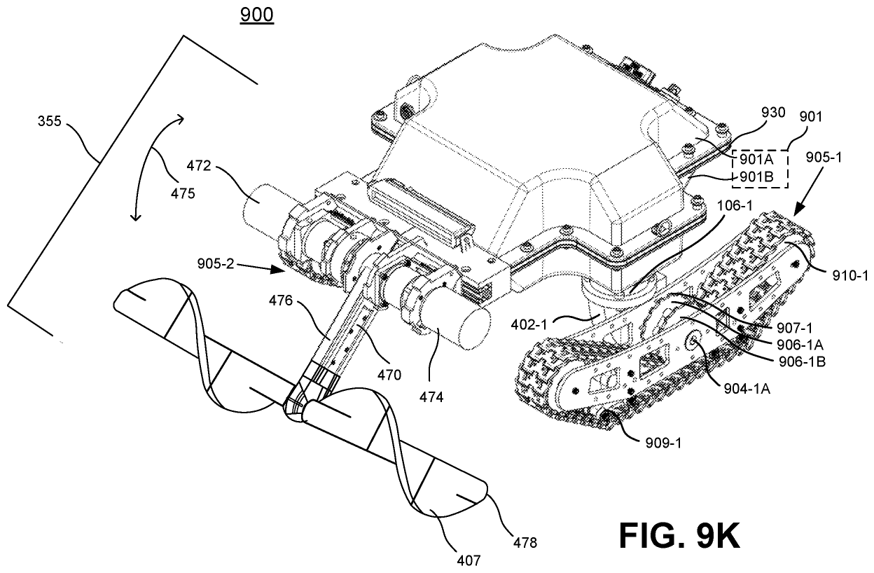

FIGS. 9A-9H illustrate diagrams of a granular material management robot 900 with an interchangeable drive system, in accordance with various embodiments. That is, one or more portions of the drive system/drive train may be swapped out to change the type of drive system used by robot 900. For example, the portion that interfaces with the surface upon which the robot operates may be referred to as the “surface interacting portion,” and one or more aspects of this surface interacting portion may be swapped out to, for example, change the robot from an auger-drive to a continuous tread drive (which may also be referred to as a continuous track drive), or to a wheel drive.

With respect to robot 900, it operates in the same manner as previously described in conjunction with device 100. Although a slightly different external form factor exists between body 401 (of robot 100) and body 901 (of robot 900), such as the inclusion of handle 902, the two robots 100 and 900 (when utilizing an auger-based drive system) operate in the same manner. Additionally, robot 900 may utilize any of the sensors 120 and/or payloads 140 that have been previously described with respect to robot 100; that is, robots 100 and 900 can both be configured with and utilize payloads 140 such as: broom payload 350, shovel payload 352, and auger payload 355, among others. Aside from the external differences of the body and handle, the main difference between robot 900 and robot 100 is that robot 900 has a reconfigurable/interchangeable drive system and robot 100 is only configured with an auger-based drive system.

FIGS. 9A-9H show the process of interchanging the components to change the type of the drive system from auger-based to continuous tread-based drive. The procedures shown in these figures may be similarly followed to change from auger-based to wheel-based drive. Similarly, the procedures may be reversed to change back from continuous tread to auger-based drive system. This interchangeability allows the robot or a user of the robot to adapt the robot to different terrain, different operating environments, and/or to different tasks. This allows the core of the robot 900, which includes the body 901 and any sensors, power supplies, and processing enclosed therein, to be reused in a variety of situations by adapting one or more components of the drive system. A variety of drive systems may be adapted to the robot 900 in this manner, including: continuous treads/tracks, wheels, magnetic assisted traction (e.g., wheels or tracks/treads with magnets for improved purchase on ferrous metal surfaces), augers, flotation screws, walking legs, and/or snow machine treads/tracks.

FIG. 9A illustrates an upper front right perspective view of the exterior of a device 900 with an interchangeable drive system depicted with auger-based surface interface portions 403 (403-1A, 403-2A, 403-1B, 403-2B) installed on its drive system, in accordance with various embodiments. In the depicted embodiments, the drive train of robot 900 comprises: an electric drive motor 106 (106-1, 106-2) which is coupled with a respective transmission 402 (402-1, 402-2), which spins one or more shafts 904 that are then coupled with a selected and interchangeable surface interface portion. Interchanging the surface interface portions of the drive system, along with, in some embodiments, reconfiguring the transmission 402, facilitates having a core robot with an interchangeable drive system. Some examples of surface interface portions include: auger-based surface interface portions 403 (403-1A, 403-2A, 403-1B, 403-2B), continuous tread surface interface portions 905 (905-1, 905-2), and wheels (not depicted). In some embodiments, there may be a variety of auger sizes with different pitches and floats that may be selectively interchanged. Likewise, in a continuous tread version, there may be different tread patterns (smooth, cleated, incorporating paddles, etc.), or tread materials (e.g., rubber, metal, magnetic), or treads adapted for certain surfaces (e.g., metal, dirt, intermittently scattered granular material, mud, snow, etc.). Similarly, in a wheeled version, different wheels may be selected for size, tread, material of construction, or the like.

FIG. 9B illustrates an upper left perspective view of the exterior of a device 900 with an interchangeable drive system depicted with auger-based surface interface portions 403 (403-1A, 403-2A, 403-1B, 403-2B) installed on its drive system, in accordance with various embodiments.

With reference to FIGS. 9A and 9B, device 900, except for the shape of body 901 as compared to body 401, is similar to device 100 and may incorporate any of the features and/or components previously described and attributed to device 100. Like device 100, device 900 may also be referred to as a “robot” or a “device” or a “robotic device” or a “granular material management robot” or a “grain management robot” and, when equipped with auger-based surface interface portions 403 (403-1A, 403-2A, 403-1B, 403-2B), is configured to traverse across, move about/upon, and/or operate in relation to a pile of granular material, in accordance with various embodiments.

As depicted, the drive system of device 900 includes, for example, drive motors 106 (106-1, 106-2), transmissions 402 (402-1, 402-2), and auger-based surface interface portions 403 (403-1A, 403-2A, 403-1B, 403-2B). The drive motors 106 are electric. In some embodiments, the electric drive motors may be directly coupled, such as via their output shaft, to turn surface interface portions; while in other embodiments (as depicted) a transmission 402 is interposed between a drive motor 106 and a surface interface portion. In an identical manner to the previously illustrated embodiments of device 100, a pair of bilateral augers 403 may be utilized as surface interface portions of the drive system. However, as will be discussed, the type of surface interface portion (e.g., augers) may be interchanged/swapped for a different type of surface interface portion (e.g., continuous tracks, wheels, etc.).

In the depicted embodiments, the transmission 402 is located near the middle of each auger 403, thus bifurcating each auger into two portions. Transmissions 402, in the depicted embodiment, comprise a worm drive which couples with an output shaft of a vertically oriented electric motor 106. Because a worm drive is used, the orientation of the output shafts 904 of a transmission 402 can thus be changed by rotating the transmission. Accordingly, as depicted herein, in some embodiments a transmission 402 may be turned 90 degrees such that shafts 904 are changed in orientation from fore/aft relative to the body 901 to being laterally oriented with respect to body 901. In this manner, both the transmission 402 and the shafts 904 may be rotated laterally by 90 degrees with respect to body 901. When transmissions 402 are bolted to their respective electric motors 106, this involves unbolting them, turning them, and re-bolting them in the new orientation. It is appreciated that, in various embodiments, securing mechanisms, other than bolts, may be employed to couple a transmission 402 with an electric motor 106. Some non-limiting examples of other securing mechanisms include: cotter pins, clevis pins, magnets, and quick-release pins.

In some embodiments, a drive motor 106 may be coupled to an auger 403 (such as to the end of an auger 403) in a manner that eliminates the need for a transmission 402 between the drive motor 106 and the auger 403. In some embodiments, a drive motor 106 may drive a belt which rotates a shaft that is coupled with an auger 403, also eliminating the need for a transmission 402. In either of these alternative embodiments, the surface interface portions of the overall drive system may be similarly switched out (e.g., from augers to wheels or continuous treads).

In FIG. 9A, the front portion 403-1A of auger 403-1 is visible, as are the front portion 403-2A and rear portion 403-2B of auger 403-2. In typical operation, augers 403 sink at least partially into the piled granular material and thrust against it as they rotate. The direction and speed of rotation of the augers 403 determine the movement fore, aft, left, right, turning left, and/or turning right of robot 900 when augers 403 are installed, in the manner as previously described with device 100. In this manner, in various embodiments with an auger-based drive system installed, robot 900 (in an identical manner to device 100) can move atop a pile of granular material, can move beneath a pile of granular material (i.e., submerged in it), can move to the surface after being submerged in a pile of granular material, and can level, disperse, and/or manage piled granular material in the manner previously described in conjunction with device 100 and FIGS. 1-23E.

With continued reference to FIG. 9A and FIG. 9B, in some embodiments, auger-based surface interface portions 403 (403-1A, 403-2A, 403-1B, 403-2B) may be removably coupled with the shafts 904 (904-1A, 904-2A, 904-1B, 904-2B) which extend from transmissions 402 (402-1, 402-2). As depicted, the auger-based surface interface portions 403 have been decoupled from their respective shafts 904 and are removed from their respective shafts, such as by removing set screws or other securing mechanisms, and by sliding in the directions shown by the arrows (951A, 951B, 953A, and 953B). In some embodiments, at this point, different types of augers (e.g., different pitch, different diameter, different float, etc.) may be installed by reversing the process if it is not desired to change the drive system to a completely different manner of interfacing with the surfaces upon which the robot 900 operates.

FIG. 9C illustrates an upper front right perspective view of the exterior of a device 900 with an interchangeable drive system depicted after auger-based surface interface portions 403 (403-1A, 403-2A, 403-1B, 403-2B) have been removed from its drive system, in accordance with various embodiments.

FIG. 9D illustrates an upper front left perspective view of the exterior of a device 900 with an interchangeable drive system depicted after auger-based surface interface portions 403 (403-1A, 403-2A, 403-1B, 403-2B) have been removed from its drive system, in accordance with various embodiments.

FIG. 9E illustrates an upper front right perspective view of the exterior of a device 900 with an interchangeable drive system depicted after auger-based surface interface portions 403 (403-1A, 403-2A, 403-1B, 403-2B) have been removed from its drive system and transmission 402-2 has been rotated 90 degrees such that shafts 904-2A and 904-2B are perpendicular to the front/rear axis of body 901, in accordance with various embodiments.

FIG. 9F illustrates an upper front left perspective view of the exterior of a device 900 with an interchangeable drive system depicted after auger-based surface interface portions 403 (403-1A, 403-2A, 403-1B, 403-2B) have been removed from its drive system and transmission 402-1 has been rotated 90 degrees such that shafts 904-1A and 904-1B are perpendicular to the front/rear axis of body 901, in accordance with various embodiments.

FIG. 9G illustrates an upper front right perspective view of the exterior of a device 900 with an interchangeable drive system depicted after continuous tread surface interface portions 905 (905-1, 905-2), such as tank or Caterpillar continuous treads, have been secured to their respective shafts 904 (904-2A, 904-2B) to become a portion of the drive system, which also includes drive motors 106-2 and transmissions 402-2, in accordance with various embodiments.

FIG. 9H illustrates an upper front left perspective view of the exterior of a device 900 with an interchangeable drive system depicted after continuous tread surface interface portions 905 (905-1, 905-2) have been secured to their respective shafts 904 (904-1A, 904-1B) to become a portion of the drive system, which also includes drive motors 106-1 and 106-2 and transmissions 402-1 and 402-2, in accordance with various embodiments.

As depicted, each continuous tread surface interface portion 905 may include one or more drive sprockets 906 (e.g., 906-1A, 906-1B, 906-2A, and 906-2B) coupled with a shaft 904, individual treads 908 that are coupled into a continuous loop, road wheels 909, and/or guide wheels 910. When the shafts 904 rotate the sprockets 906, cog teeth 907 (e.g., 907-1, 907-2, etc.) of the sprockets 906 engage with gaps/sockets in the coupled respective individual treads 908 (e.g., 908-1 or 908-2) of each respective continuous tread surface interface portion 905 (905-1, 905-2), to rotate the individual treads 908 in a loop around respective road wheels 909 (e.g., 909-1, 909-2) and/or respective guide wheels 910 (910-1, 910-2) that define the shape of the continuous tread surface interface portions 905. The direction and speed of rotation of the bilateral continuous tread surface interface portions 905-1 and 905-2 determine the movement fore, aft, left, right, turning left, and/or turning right of device 900 of FIGS. 9G, 9H, 9I, 9J, and 9K. In this manner device 900, in various embodiments that are configured with continuous tread surface interface portions 905, can move atop and traverse across and about a surface that is solid, packed, or semi-solid (e.g., not deeply piled granular material that can shift, slide, or move much beneath the continuous tread surface interfaces 905). In some embodiments, a semi-solid surface may be a floor of a bulk store covered by a layer of granular material less than one foot deep. In some embodiments, a semi-solid surface may be a floor of a bulk store covered by a layer of granular material less than three inches deep. In some embodiments, a semi-solid surface may be a wet mud surface. A solid surface is hard or hard-packed, such as metal, dirt, plastic, a gravel road, or poured concrete. Some examples of the types of surface that may be traversed by the continuous tread surface interface portions 905 include, without limitation: the bottom/floor of a grain bin or other bulk store, a metal surface, a dirt surface, a gravel surface, a concrete surface, a muddy surface, a gravel road, a dirt road, a sand road, a beach, a plowed field, grass, a cover crop planted field, water, a bog, a rice field, a snow-covered surface, a manure pit, and a solid surface such as a floor of a granular material bulk store which has some scattered granular material on it to include areas where the granular material being traversed may be a thin layer of a few inches or less deep in some embodiments or up to about a foot deep in some embodiments. In some embodiments, auger-based surface interface portions 403 may be used when managing a pile of granular material that is more than a foot deep and may be swapped for continuous tread surface interface portions 905 to provide better mobility and purchase on the floor of a granular material bulk store during final clean out of the granular material from the bulk store.

In some embodiments, wheel-based surface interface portions may be installed similarly to the installation of the sprockets 906 which are attached to shafts 904. By exchanging treaded wheels for the sprockets 906, the robot is equipped with drive wheels. Additional wheels may be added for stability and the additional wheels may or may not be coupled with the drive wheels.

In particular, the tread surface interface portions 905 are well-suited to operating in the “final foot” of grain/granular material where the auger-based drive is no longer needed or where bare bin/bulk store floor is visible in some areas. Besides sweeping, the robot 900 may be configured with other payload implements and used to scoop granular material from the floor of a bulk store, move granular material with an attached auger payload, scrape the floor of a bulk store, spray the floor, and/or perform bin maintenance tasks.

Other uses of a continuous tread surface interface equipped robot 900 may be outside of a grain bulk store. Some example uses may include, but are not limited to: cleaning or operating in a non-grain bulk store for granular material; transporting loads; precise robotic in-row irrigation including robot-assisted furrow irrigation; robotic in-row weed removal by individually digging, cutting, spraying herbicide upon, or burning of weeds; robotic management of waste pits and ponds, management of manure and/or manure piles; precise payload delivery in multiple operating environments; rice paddy management; animal management (e.g., cows, pigs, chickens) in harsh conditions (winter, mud) and/or in confinement facilities. Such tasks may be performed in an automated fashion (either by the robot acting alone or via remote computer control), via human remote control, or some combination.

It should be appreciated that the interchange of surface interface portions, such as the change from auger-based surface interface portions 403 to continuous tread surface interface portions 905, may be performed manually by a human or in an automated or semi-automated fashion when robot 900 is in a docking station, such as for charging.

FIG. 9I illustrates an upper right rear perspective view of the exterior of a device 900 with an interchangeable drive system depicted after continuous tread surface interface portions 905 (905-1, 905-2) have been installed and after a payload implement 140, such as broom payload 350, has been attached, in accordance with various embodiments. In the illustrated embodiment, implement 350 is a rotary broom that is mounted to the handle 902 of robot 900 (other mechanisms for mounting may be employed). In other embodiments, broom payload 350 may be configured to be fixed in place rather than to rotate and/or articulate. In some embodiments, an electrical and/or communicative coupling may conduct electrical power and/or control signals from within body 901 to power and/or control operation/movement of an attached payload implement 140, such as a broom payload 350, a blade payload 351, a shovel payload 352, a vacuum payload 353, a blower payload 354, and/or an auger payload 355.

Broom payload 350, as depicted in FIG. 9I, is a rotating broom which may also be raised or lowered with lift arm 470. Lift arm 470 is actuated in a rotating/arced up/down path 475 by electric motor 472, while electric motor 474 spins a pulley attached to a belt 476 disposed along the outside edge of lift arm 940. Belt 476 spins the shaft 478 of rotating broom 350, which is coupled with lift arm 940. The lift arm 470 is actuated along an arced path 475 by an electric motor 472, enabling precise vertical positioning of the broom payload 350 relative to the granular material slope.

Broom payload 350, as depicted, is secured to the handle 902 of robot 900 (causing the handle to no longer be visible). Broom payload 350 is coupled to and powered by batteries that are internal to body 901 and likewise may be controlled by signals provided by host processor 102.

Broom payload 350 may be employed for tasks such as sweeping material in the path of traversal of robot 900. For example, robot 900 may utilize a fixed or rotating broom 350 to sweep a floor of a shop, a sidewalk, or the floor of a granular material bulk store. For example, robot 900 may use a broom payload 350 to sweep or push granular material in a traversal path of the robot, and in such a manner may be utilized in the final clean out of granular material in a bulk store by sweeping/pushing granular material toward an extraction point, such as a door, or a sump auger entry, or a sweep auger.

FIG. 9J illustrates an upper right rear perspective view of the exterior of a device 900 with an interchangeable drive system depicted after continuous tread surface interface portions 905 (905-1, 905-2) have been installed and after a payload implement 140, such as shovel payload 352, has been attached, in accordance with various embodiments. In the illustrated embodiment, scoop shovel payload 352 is mounted to the underside of body 901 by an arm 480, which is in a fixed angle/position with respect to body 901. Other mechanisms of attachment may be employed. Robot 900 may use a shovel 352 for pushing and/or scooping and moving material in a path of traversal of the robot, and in such a manner may be utilized to assist with the final cleanout of granular material in a bulk store, by scooping the granular material piled on the floor of a bulk store and depositing it at an extraction point, such as a door, or a sump auger entry, or a sweep auger.

FIG. 9K illustrates an upper right rear perspective view of the exterior of a device 900 with an interchangeable drive system depicted after continuous tread surface interface portions 905 (905-1, 905-2) have been installed and after a payload implement 140, such as auger payload 355, has been attached, in accordance with various embodiments. In the illustrated embodiment, payload implement 355 is a rotatable auger component 407 that is mounted to the handle 902 of robot 900 (other mechanisms for mounting may be employed). In other embodiments, auger payload 355 may be configured to be fixed in place rather than to articulate. In some embodiments, an electrical and/or communicative coupling may conduct electrical power and/or control signals from within body 901 to power and/or control the operation/movement of an attached payload implement 140, such as auger 355.

As depicted, auger payload 355 is secured to the handle 902 of robot 900 (causing the handle to no longer be visible). Auger payload 355 is coupled to and powered by batteries that are internal to body 901 and likewise may be controlled by signals provided by host processor 102.

Auger payload 355, as depicted in FIG. 9K, is a rotating auger 478, which may also be raised or lowered with lift arm 470. Lift arm 470 is actuated in a rotating/arced up/down path 475 by electric motor 472, while electric motor 474 spins a pulley attached to a belt 476 disposed along the outside edge of lift arm 470. Belt 476 spins the shaft 478 of rotating auger 355, which is coupled with lift arm 470. The lift arm 470 is actuated along an arced path 475 by an electric motor 472, enabling precise vertical positioning of the auger payload 355 relative to the granular material slope.

Auger payload 355 may be employed for tasks such as moving granular material during the traversal of robot 900. For example, robot 900 may utilize auger payload 355 to move a pile of granular material in a bulk store. For example, robot 900 may use an auger 355 to level a peaked pile (e.g., to create a less steeply peaked pile or to turn a peak into a plateau, or to move granular material down a slope). This includes managing piled granular material while it is piled and stored and further includes moving granular material during the final cleanout of granular material in a bulk store by using auger payload 355 to move granular material toward an extraction point, such as a door, or a sump auger entry, or a sweep auger. In some embodiments, auger payload 355 may also be used for grinding clumps of granular material, breaking crusts of granular material, and/or mixing granular material.

Robot 900 may use an auger payload 355 for moving material in a path of traversal of the robot. For example, device 900 may move across a slope (e.g., generally perpendicular to the slope of a pile of granular material) while rotating the rotatable auger component 407 of auger payload 355 in a selected direction to eject engaged granular material downslope. In some embodiments, robot 900 may remain substantially stationary (it may shift up to a few inches) while using auger payload 355 to move granular material. In some embodiments, a stationary position may be maintained by the auger-based drive system, which performs small station-keeping movements. In other embodiments, robot 900 may use an anchor, such as a spud 950, to maintain a stationary cross-slope position while rotating the rotatable auger component 407 of auger payload 355 in a selected direction to eject/discharge engaged granular material downslope. For example, a host processor may receive or generate an instruction that causes a robot 100/900 to deploy one or more spuds 950. In some instances, additional granular material may be moved downslope by the rotation/agitation of the rotatable auger component 407, causing sediment gravity flow of the engaged granular material and/or by the downslope landing of granular material ejected from the rotatable auger component 407, causing sediment gravity flow of other granular material that it lands upon. In this manner, device 900, when equipped with auger payload 355, provides a mobile auger that can be moved about atop the surface 1011 of a pile 1010 of granular material to any selected location for the purpose of mixing, agitating, breaking up, and/or moving granular material at the selected location.

In other embodiments, other payloads 140 may be employed. For example, a drill for making holes and probing, a basket/bed for carrying a payload, a ripper, a sprayer/spray tank, a water tank, a cultivator, a blade, a flame torch, among others, may be coupled to robot 900 in a similar manner. In another example, a robot 900 may use a blade 351 for pushing/sweeping/clearing material in a path of traversal of the robot, and in such a manner may be utilized to assist with the final cleanout of granular material in a bulk store, by pushing the granular material along the floor of a bulk store toward an extraction point, such as a door, or a sump auger entry, or a sweep auger. In another example, robot 900 may use a vacuum 353 for sucking up granular material in a path of traversal of the robot, and in such a manner may be utilized to assist with the final cleanout of granular material in a bulk store, by vacuuming up the granular material along the floor of a bulk store. In another example, robot 900 may use a blower 354 for blowing air to push/clear material in a path of traversal of the robot, and in such a manner may be utilized to assist with the final cleanout of granular material in a bulk store, by blowing the granular material along the floor of a bulk store toward an extraction point, such as a door, or a sump auger entry, or a sweep auger.

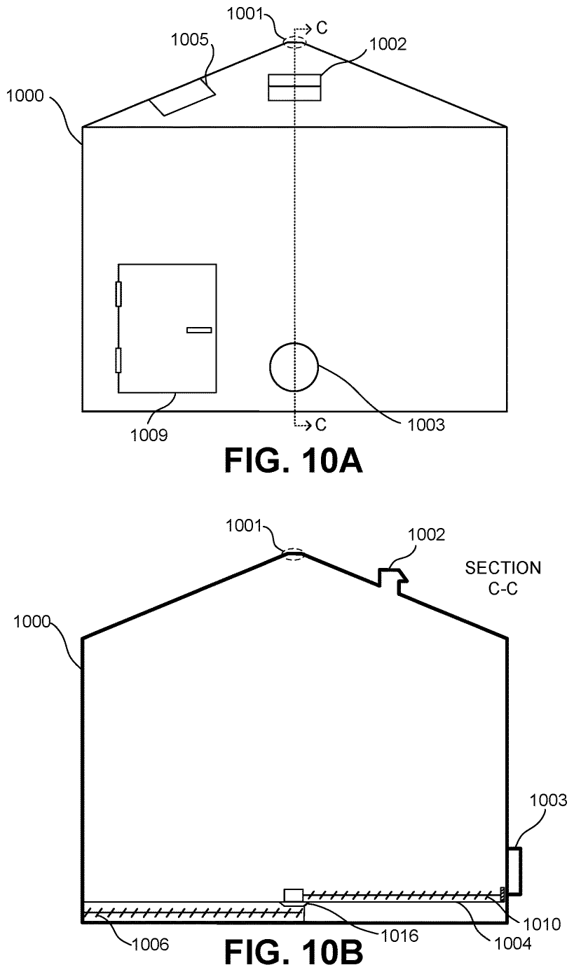

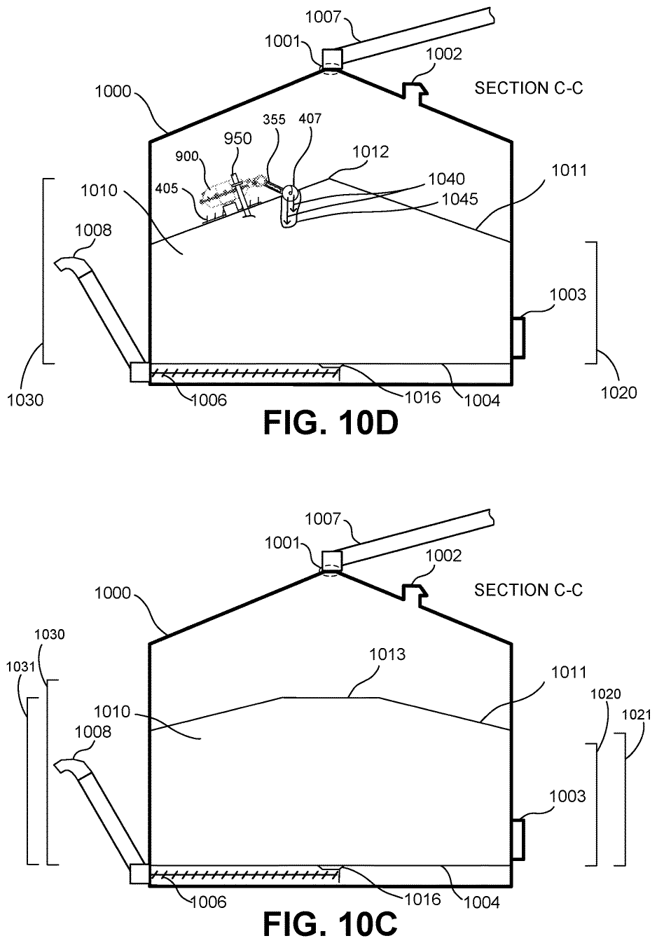

FIG. 10A illustrates a side elevational view of a bulk store 1000 for granular material, according to various embodiments. Bulk store 1000 is very similar to grain bin 700 of FIG. 7A, except for the inclusion of a roof vent 1002 and a fan 1003. Bulk store 1000 includes a top-loading portal 1001 through which granular material may be loaded via an auger or other granular material transport means. Bulk store 1000 also includes a side door 1009, which may be opened for access and/or manual cleanout/manipulation of granular material within bulk store 1000. Dotted section lines indicate the direction of a side sectional view C-C. Any of a variety of granular materials may be piled into and bulk-stored within bulk store 1000.

FIG. 10B shows the side section view C-C of bulk store 1000 in an empty state, according to various embodiments. Floor 1004 is visible and includes a drain type hole 1016 (sometimes referred to as a “sump”) which facilitates funneling of granular material stored above floor 1004 to an unloading auger 1006 (sometimes referred to as a “sump auger”) during load out of granular material. A center mounted sweep auger 1015 is illustrated as being mounted above floor 1004. Such a sweep auger 1015 is typically buried under piled granular material and is only engaged and used during a clean out operation when granular material ceases to flow with gravity into sump 1016. When employed, sweep auger pivots around its center to travel in a circular fashion around the floor 1004 of bulk store to engage with granular material and direct the engaged granular material toward the sump 1016 where it can fall into sump auger 1006. In some embodiments, a device 100 and/or a device 900 may determine an elevation of floor 1004 prior to the loading of any granular material; in other embodiments, this elevation of floor 1004 may be supplied as an input to device 100/900 or any computer system (e.g., 604, 605, 506, etc.) which operates with data collected by a device 100/900.

FIG. 10C illustrates a diagram of a granular material management robot 900 using an auger attachment to manage a pile of granular material, in accordance with various embodiments. Auger payload 355, and specifically the rotatable auger component 407, is utilized to move granular material without relying on sediment gravity flow to move the granular material. In such embodiments, the auger payload 355 is engaged with granular material that is to be relocated, and the rotatable auger component 407 is oriented such that, when rotated in a selected direction, the engaged granular material is discharged/ejected laterally in a desired direction. This operation provides versatility in granular material management, enabling the robotic device to perform tasks beyond moving granular material strictly by inciting sediment gravity flow.

Prior to interaction with auger payload 355, distance 1020 represents the initial height of the side edges of piled granular material 1010 above floor 1004 of bulk store 1000, while distance 1030 represents the height of peak 1012 above floor 1004.

For example, as depicted, the auger payload 355 may be employed to reduce the size of a peak of granular material by shaving the peak 1012 down to a plateau 1013 (see FIG. 10D). In this operation, the rotatable auger component 407 engages the surface 1011 of the piled granular material 1010 at or near the peak 1012 and discharges it laterally, gradually reducing the height of the peak until a flat or leveled surface is achieved. Arrows 1040 represent the discharged granular material. This functionality is particularly useful in storage environments where granular material piles need to be reshaped or redistributed to optimize space utilization. Although sediment gravity flow is not relied upon to move granular material, in some embodiments, it is triggered by the movement of the rotatable auger component 407 and by the discharged material 1040 as it lands downslope on the pile. Granular material 1045 represents a downhill slide or sluffing of granular material which resulted from sediment gravity flow incited by one or more of the rotation and agitation of rotatable auger component 407 and the force of impact of discharged granular material 1040.

In some embodiments, robot 900 may deploy an anchoring device, such as one or more spuds 950, to assist it in maintaining a stationary position with auger payload 355 disposed cross-slope or substantially perpendicular to the slope of the pile of granular material 1010.

Similarly, the rotatable auger component 407 may be used to dig a hole in a pile of granular material. In this operation, the auger payload 355 is positioned at the desired location, and the rotatable auger component 407 is rotated to engage and discharge granular material from the location. As the granular material is discharged, a depression or hole is created in the pile. This capability is beneficial for applications requiring the creation of voids or cavities within granular material piles, such as for inspection, sampling, or material extraction purposes.

In the same fashion, the rotatable auger component 407 may be utilized to fill a hole or depression in a pile of granular material. The auger payload 355 is positioned near the depression, and the rotatable auger component 407 is rotated to engage granular material and discharge it into the depressed location. As the granular material is discharged, the depression is gradually filled or leveled out. This operation is advantageous for restoring the integrity of granular material piles or redistributing material to achieve a desired surface profile.

In the same fashion, the rotatable auger component 407 may mix or distribute granular material about a pile of granular material. By enabling precise control over the movement and discharge of granular material, the auger payload 355 provides a robust solution for reshaping, redistributing, and managing granular material piles in various storage and operational environments.

It should be appreciated that robot 100, as illustrated in FIG. 4H, may be similarly employed in the manner illustrated and described in connection with FIG. 10C.

FIG. 10D illustrates the pile of granular material of FIG. 10A after management by granular material management robot 900 using an auger attachment, in accordance with various embodiments. After the interaction with auger payload 355, the initial height of the side edges of piled granular material 1010 above floor 1004 of bulk store 1000 has been increased from distance 1020 to distance 1021, while the height of peak 1012 above floor 1004 has been reduced from 1030 to distance 1031 (which is associated with the distance from floor 1004 to the top of plateau 1013).

### Example Method of Managing Piled Granular Material

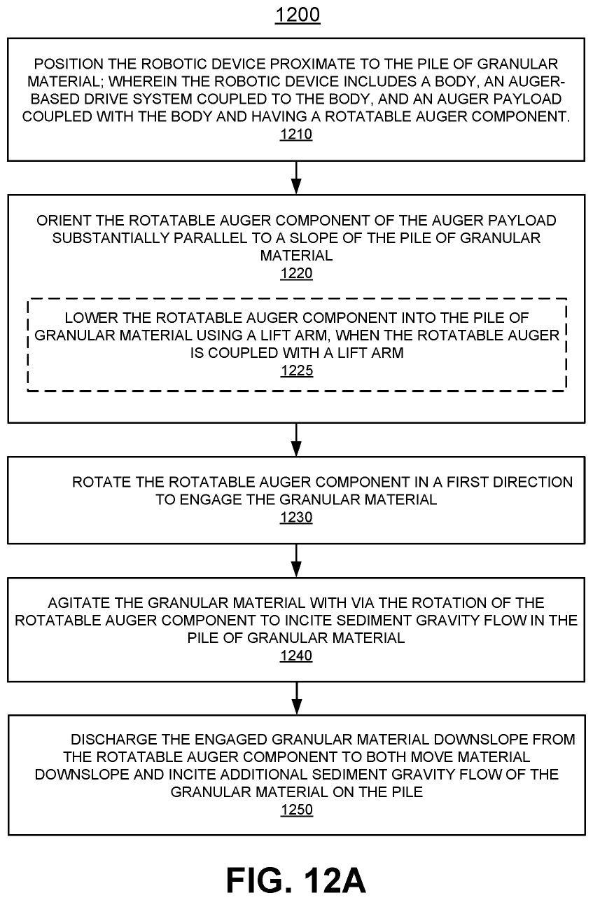

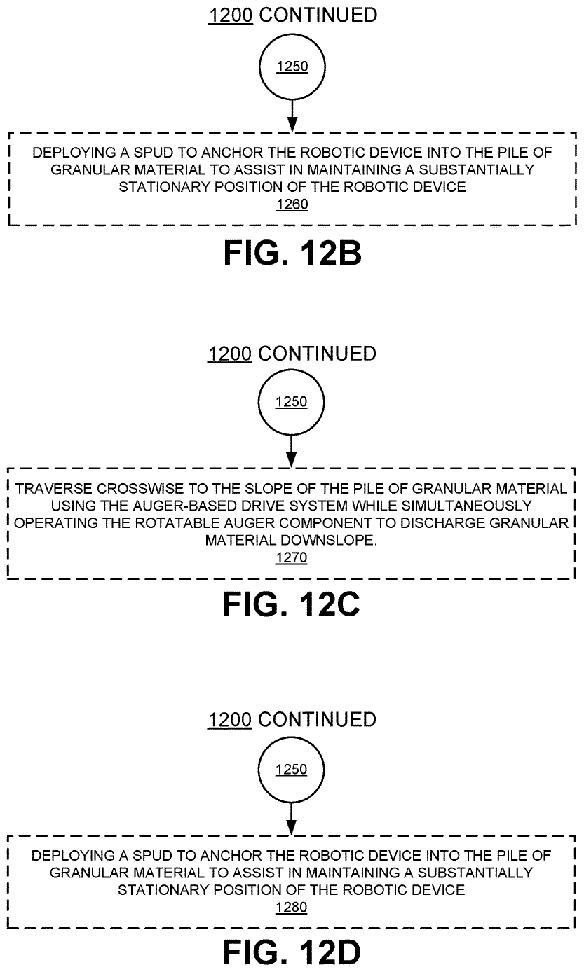

In FIGS. 12A-12D, a low diagram 1200 illustrates procedures in an example method of managing piled granular material. It should be appreciated that the method may include fewer procedures than those illustrated or additional procedures to those illustrated.

With reference to FIG. 12A, in one embodiment, at 1210 of flow diagram 1200, the method begins with positioning a robotic device 100/900 proximate to the pile of granular material. This may include positioning the robotic device 100/900 near a peak of the pile of granular material or else part way up the slope of a pile of granular material. The robotic device includes a body that houses and supports all operational subsystems, including an auger-based drive system and an auger payload 355, which is coupled externally to the body. The auger-based drive system comprises a plurality of augers configured to propel and maneuver the robotic device atop or within the granular material. The auger payload 355, which may be articulable, is coupled to the body and includes a rotatable auger component 407 and a motorized system configured to control the rotation of the rotatable auger component 407. The robotic device is positioned such that the auger payload is capable of interacting with the granular material to move it directly through the interaction and/or to incite sediment gravity flow when the material is interacted with on a slope.

At 1220, once positioned, the rotatable auger component 407 of the auger payload 355 is oriented to be parallel or substantially parallel to the slope of the pile of granular material. By “substantially parallel”, what is meant is that one end of the rotatable auger component 407 of the auger payload 355 is upslope on the piled granular material, while the opposing end of the rotatable auger component 407 is downslope. This orientation ensures that the rotatable auger component 407 can effectively engage the granular material and discharge it downslope. The orientation may be achieved by adjusting the lift arm of the auger payload, which is configured to raise and lower the rotatable auger component 407. The lift arm is actuated by a motorized system that allows precise positioning of the rotatable auger component 407 relative to the slope.

At 1225, in embodiments where the auger payload includes a lift arm which facilitates articulation, the method illustrated by flow diagram 1200 further comprises lowering the rotatable auger component 407 into the pile of granular material using the lift arm. The lift arm is actuated along an arced path by an electric motor, enabling the rotatable auger component 407 to penetrate the granular material at the desired depth. This procedure ensures that the rotatable auger component 407 is optimally positioned to engage the granular material and initiate sediment gravity flow.

At 1230, the rotatable auger component 407 is then rotated in a first direction to engage the granular material. The motorized system of the auger payload 355 controls the rotation, including the direction and speed, to ensure efficient interaction with the granular material.

At 1240, the rotation of the rotatable auger component 407 agitates the granular material, breaking up compacted (e.g., crusted) regions and reducing localized interlocking, thereby directly moving the material it engages with and also inciting and triggering sediment gravity flow within the pile of granular material.

At 1250, the engaged granular material is discharged downslope from the rotatable auger component 407. As the rotatable auger component 407 rotates, it also agitates the granular material, causing it to flow downslope due to inciting sediment gravity flow. The downslope discharge may trigger additional sediment gravity flow or avalanche of the granular material on the pile through the impact force on the pile where it lands after discharge. The discharge may occur to a first lateral side (e.g., downslope) when the rotatable auger component 407 rotates in the first direction and to a second lateral side (e.g., upslope) when rotated in the opposite direction. The second lateral side is opposite to the first lateral side. Generally, for this method, it is more advantageous to discharge downslope when moving material, though upslope discharge may be utilized to assist in breaking up compacted and/or crusted regions of granular material. The speed of rotation may be controlled to adjust the rate of granular material discharge, providing operational flexibility.

In FIG. 12B, at 1260 of flow diagram 1200, in some embodiments where the robotic device maintains a substantially stationary position during the operations, this may comprise deploying an anchor, such as a spud 950, into the pile of granular material to assist in maintaining the stationary position. The anchor provides stability, preventing the robotic device from shifting due to forces generated by the operation of the auger payload. This stationary operation is particularly useful for discharging granular material downslope in a controlled manner. Station keeping using the drive system of the robotic device may additionally or alternatively be utilized to assist the robotic device in remaining substantially stationary.

In FIG. 12C, at 1270 of flow diagram 1200, in some embodiments the robotic device traverses the granular material while utilizing the auger payload 355 to discharge material downslope on a pile of granular material. This comprises using the auger-based drive system to move/traverse the robotic device crosswise or perpendicular to the slope of the pile of granular material. During such traversal, the rotatable auger component 407 of the auger payload 355 operates simultaneously to discharge granular material downslope. This traversal allows the robotic device to cover larger areas of the pile and effectively move and manage the granular material.

Attention is directed to FIG. 12D. During traversal (and even while substantially stationary), the robotic device may encounter crusts or chunks of granular material. In FIG. 12B, at 1280 of flow diagram 1200, the method further comprises breaking up these crusts or chunks using the rotatable auger component 407 of the auger payload. The rotation of the rotatable auger component 407 agitates and pulverizes the crusts or chunks, ensuring smooth operation and reducing obstructions within the pile.

In some embodiments, prior to orienting the rotatable auger component 407 substantially parallel to the slope of a pile of granular material, the robotic device may map the slope of the pile of granular material. This mapping is performed using sensors integrated into the robotic device, which measure the contours and angles of the pile. The mapping data assists in positioning the rotatable auger component 407 and optimizing the operation of the robotic device.

In some embodiments, the method described by flow diagram 1200 may comprise measuring environmental characteristics of the granular material during operation of the robotic device. Sensors integrated into the robotic device measure properties such as temperature, moisture, and humidity. These measurements provide valuable data for managing the granular material and adjusting the operation of the robotic device to account for variations in material properties.

The method illustrated by flow diagram 1200 is applicable to movement and management of various types of granular materials, including grain (e.g., small hard and typically edible seeds or beans, such as soybean seeds, peas, garbanzo beans, pinto beans, corn kernels, wheat, rice, etc.), non-grain plant seeds (e.g., flower seeds and grass seeds), nuts (e.g., shelled or unshelled tree nuts or ground nuts), nut shells, sand, animal litter, concrete mix, cement, dry fertilizer, pelletized products (e.g., wood pellets, plastic pellets, hemp pellets, fish food pellets, etc.) and granular milled/ground products (e.g., flour, soy meal, sugar, coffee, cocoa, guar gum, sodium bicarbonate, alumina, and granular mineral/rock aggregates/products, etc.), among others.

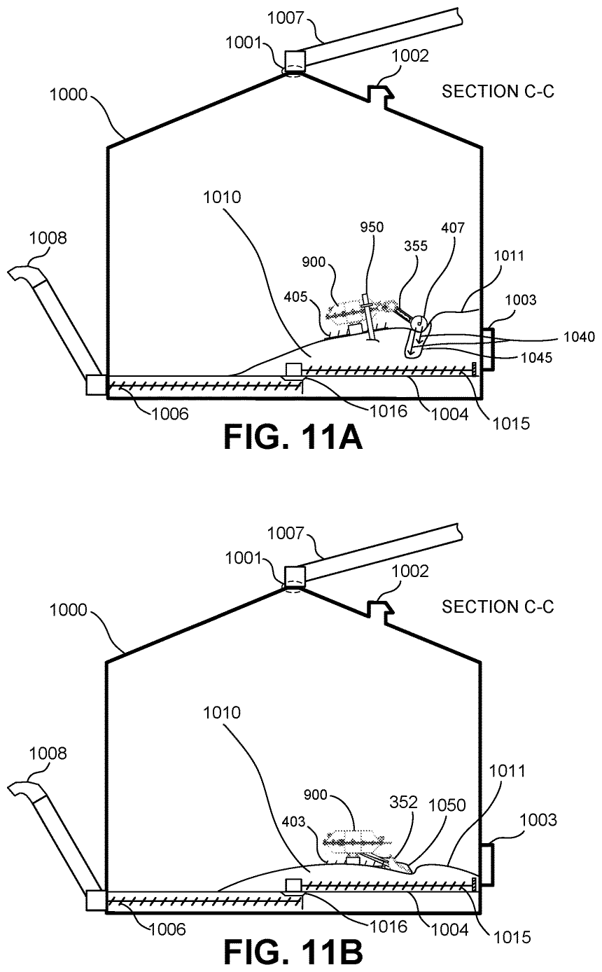

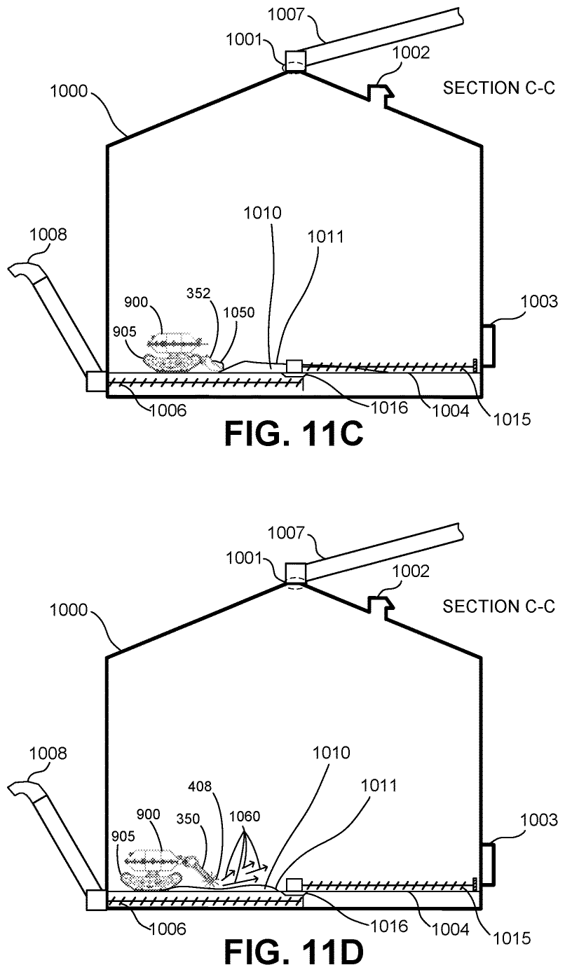

FIGS. 11A-11D illustrate diagrams of a granular material management robot 900 with an interchangeable drive system and a variety of interchangeable payload implements being used for cleanout tasks in a bulk store 1000 for granular material, in accordance with various embodiments. As illustrated, robotic device 900 is designed to assist with cleanout operations in a bulk store, such as bulk store 1000, containing granular material.

The robotic device 900 is equipped with an interchangeable drive system, as has previously been described, that can be configured as either an auger-based drive system or a continuous tread drive system. The auger-based drive system is designed to traverse and agitate granular material, making it particularly effective for operating on piled granular material during the initial stages of cleanout, as illustrated in FIG. 11A and FIG. 11B. The continuous tread drive system, on the other hand, is optimized for traversing solid or semi-solid surfaces, such as the exposed floor 1004 of the bulk store 1000, and is used during later stages of cleanout, as illustrated in FIG. 11C and FIG. 11D. The ability to switch between these drive systems allows the robotic device 900 to adapt to different surface types and cleanout tasks during the cleanout of a bulk store.

To further enhance its versatility, the robotic device 900 includes interchangeable front-mounted payload implements. In some embodiments, these payloads include a rotating auger payload 355, a shovel payload 352, and a rotating brush payload 350.

With reference to FIG. 11A, a rotating auger payload 355 is depicted on a robot 900 equipped with an auger-based drive system, in accordance with various embodiments. The rotating auger payload 355 is configured to discharge granular material perpendicular to the direction of travel of robot 900 (e.g., it discharges laterally with respect to a distal end of the rotatable auger component 407), making it ideal for moving large amounts of material toward an egress location during the initial stages of cleanout. In some embodiments, robot 900 may further be equipped with an anchoring device, such as spud 950, which can be lowered into (and raised from) the pile of granular material 1010 by an electric motor to assist robot 900 in maintaining a stationary position on pile 1010. As depicted, auger payload 355 is engaging granular material 1010 and discharging granular material laterally (as represented by arrows 1040) toward sweep auger 1015. In some embodiments, agitation by the rotatable auger component 407 and/or the impact of laterally discharged material incite sediment gravity flow, as illustrated by sediment gravity flow 1045. In some embodiments, FIG. 11A depicts a first course of action during cleanout of a bulk store.

With reference to FIG. 11B, a shovel payload 352 is depicted on a robot 900 equipped with an auger-based drive system, in accordance with various embodiments. Shovel payload 352 is designed to lift, carry, and push granular material 1050, making it suitable for leveling operations and feeding the moved granular material 1050 into a sweep auger 1015 or sump auger 1006 during cleanout. The use of the auger-based drive system is employed when granular material is deep (e.g., more than a foot deep, more than a few inches deep) or when no bare portions of floor 1004 are visible. In some embodiments, FIG. 11B depicts a second course of action during cleanout of a bulk store.

With reference to FIG. 11C, a shovel payload 352 is depicted on a robot 900 equipped with a continuous tread drive system, in accordance with various embodiments. Shovel payload 352 is designed to lift, carry, and push granular material 1050, making it suitable for leveling operations and feeding the moved granular material 1050 into a sweep auger 1015 or sump auger 1006 during cleanout. Use of the continuous tread drive system is employed when granular material is shallow (e.g., less than a foot deep, less than a few inches deep) or scattered with bare portions of floor 1004 visible. In some embodiments, FIG. 11C depicts a third course of action during cleanout of a bulk store.

With reference to FIG. 11D, a rotating brush payload 350 is depicted on a robot 900 equipped with a continuous tread drive system, in accordance with various embodiments. The rotating brush payload 350 is used to sweep scattered granular material forward or backward, effectively cleaning the exposed floor 1004 of the bulk store during the final stages of cleanout by sweeping granular material (illustrated by arrows 1060) toward an egress point such as sweep auger 1015. In some embodiments, FIG. 11D depicts a fourth course of action during cleanout of a bulk store.

As can be seen in FIGS. 11A-11D, both the drive systems and the payload implements on robot 900 can be interchanged as needed to optimize performance during different cleanout tasks and conditions.

### Example Method of Cleanout Operations in a Bulk Store

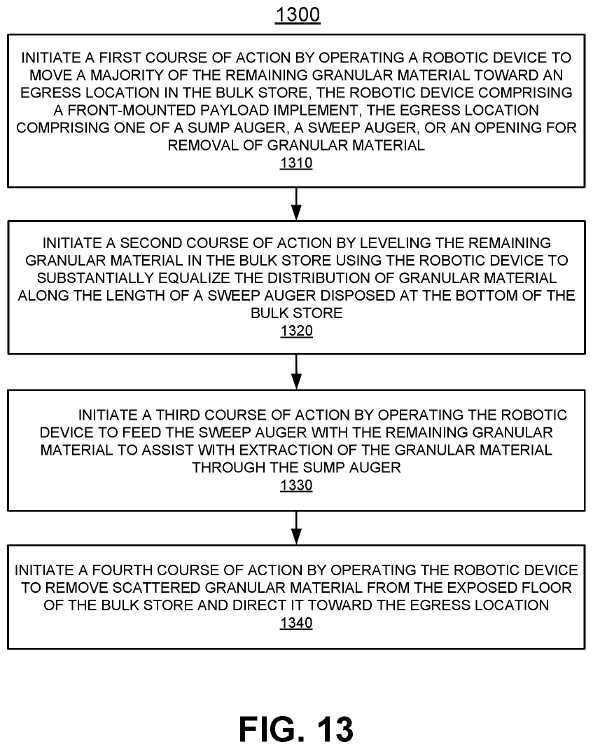

FIG. 13 illustrates a flow diagram 1300 of an example method of cleanout operations in a bulk store. It should be appreciated that the method may include fewer procedures than those illustrated or additional procedures to those illustrated.

The method illustrated by flow diagram 1300 begins at 1310 with initiating a first course of action, wherein the robotic device 100/900 operates to move the majority of the remaining granular material toward an egress location in the bulk store. This course of action is initiated when most (e.g., more than 90%) of the granular material has been removed and the main mechanism for removal (e.g., a sump auger) has become ineffective, such that secondary methods, such as using a sweep auger, have been employed or are about to be employed. The robotic device 100/900 is equipped with a payload implement, which may include a rotating auger payload 355, a shovel payload 352, or a rotating brush payload 350. The payload may be front-mounted. The egress location comprises one of a sump auger, a sweep auger, or an opening for removal of granular material. During this operation, the robotic device traverses the surface of the granular material, engaging the payload implement to efficiently discharge or push the granular material toward the egress location. For example, the rotating auger payload may discharge granular material perpendicular to the direction of travel, ensuring rapid and effective movement of material toward the extraction point.

At 1320, a second course of action is initiated. The second course of action involves leveling the remaining granular material in the bulk store to substantially equalize its distribution along the length of a sweep auger disposed at the bottom of the bulk store. The robotic device 100/900 traverses the surface of the granular material, using the front-mounted payload implement to redistribute the material evenly. This leveling operation prevents imbalanced loading on the sweep auger during extraction, ensuring smooth and efficient operation. In some embodiments, the robotic device maps the surface of the granular material during this course of action to determine the distribution of material and adjust leveling operations accordingly. By autonomously or remotely controlling the robotic device, the leveling process is performed without requiring human entry into the bulk store, enhancing safety and efficiency.

At 1330, a third course of action is initiated. The third course of action involves operating the robotic device 100/900 to feed a sweep auger with the remaining granular material to assist with extraction through the sump auger. The robotic device uses a shovel payload to push granular material toward the sweep auger, ensuring continuous feeding and preventing interruptions in the extraction process. In some embodiments, the robotic device is configured to assist with rehydration of granular material prior to extraction, optimizing the material's condition for removal. This operation ensures that the sweep auger can efficiently handle the remaining granular material without overloading or underfeeding.

At 1340, a fourth course of action is initiated. The fourth course of action involves operating the robotic device 100/900 to remove scattered granular material from the exposed floor of the bulk store and direct it toward the egress location. The robotic device employs a rotating brush payload to sweep the scattered material, ensuring that the floor is thoroughly cleaned and all remaining material is collected for extraction. In some embodiments, the robotic device may collect granular material samples from the exposed floor during this operation, providing valuable data for quality assessment or inventory management. The rotation speed and direction of the rotating brush payload can be controlled to optimize the sweeping process based on the type and quantity of scattered material.

The robotic device 100/900 is configured to interchange the payload implement between the first, second, third, and fourth courses of action to optimize cleanout operations. For example, the rotating auger payload may be used during the first course of action to move large quantities of granular material, while the shovel payload may be employed during the third course of action to feed the sweep auger. Similarly, the rotating brush payload is utilized during the fourth course of action to sweep scattered material from the exposed floor. This modularity allows the robotic device to adapt to different tasks and surface conditions, ensuring efficient and thorough cleanout operations.

In some embodiments, a robotic device 900 is configured to switch its drive system between an auger-based surface interface portion and a continuous tread surface interface portion based on the surface type encountered during the cleanout operations. The auger-based drive system is well-suited for traversing deep granular material, while the continuous tread system provides better mobility on exposed floors or semi-solid surfaces. This capability enhances the versatility of the robotic device, allowing it to perform cleanout operations in a variety of environments.

The robotic device 100/900 operates autonomously or under remote control during the cleanout operations, ensuring flexibility and safety. Autonomous operation allows the robotic device to perform tasks based on pre-programmed instructions or real-time sensor data, while remote control enables an operator to direct the device's actions from outside the bulk store. This dual-mode functionality ensures that the cleanout operations can be tailored to specific requirements while minimizing human exposure to hazardous environments.

The robotic device 100/900 performs the cleanout operations without requiring human entry into the bulk store, significantly enhancing safety. By automating tasks such as leveling, feeding the sweep auger, and sweeping scattered material, the robotic device reduces the risk of accidents and exposure to dust or other harmful conditions. Additionally, the ability to map the surface of the granular material and measure environmental characteristics such as temperature, moisture, and humidity ensures that the cleanout operations are performed efficiently and effectively.

Throughout the cleanout operations, the rotation speed and direction of the rotating auger payload or the rotating brush payload can be controlled to optimize performance. For example, higher rotation speeds may be used to discharge granular material quickly during the first course of action, while slower speeds may be employed during the fourth course of action to ensure precise sweeping. This level of control allows the robotic device to adapt to varying conditions and requirements, ensuring that the cleanout operations are completed thoroughly and efficiently.

The method is applicable to cleanout of various types of granular materials, including grain (e.g., small hard and typically edible seeds or beans such as soybean seeds, peas, garbanzo beans, pinto beans, corn kernels, wheat, rice, etc.), non-grain plant seeds (e.g., flower seeds and grass seeds), nuts (e.g., shelled or unshelled tree nuts or ground nuts), nut shells, sand, animal litter, concrete mix, cement, dry fertilizer, pelletized products (e.g., wood pellets, plastic pellets, hemp pellets, fish food pellets, etc.) and granular milled/ground products (e.g., flour, soy meal, sugar, coffee, cocoa, guar gum, sodium bicarbonate, alumina, and granular mineral/rock aggregates/products, etc.), among others.

### Example Method of Cleanout Operations in a Bulk Store

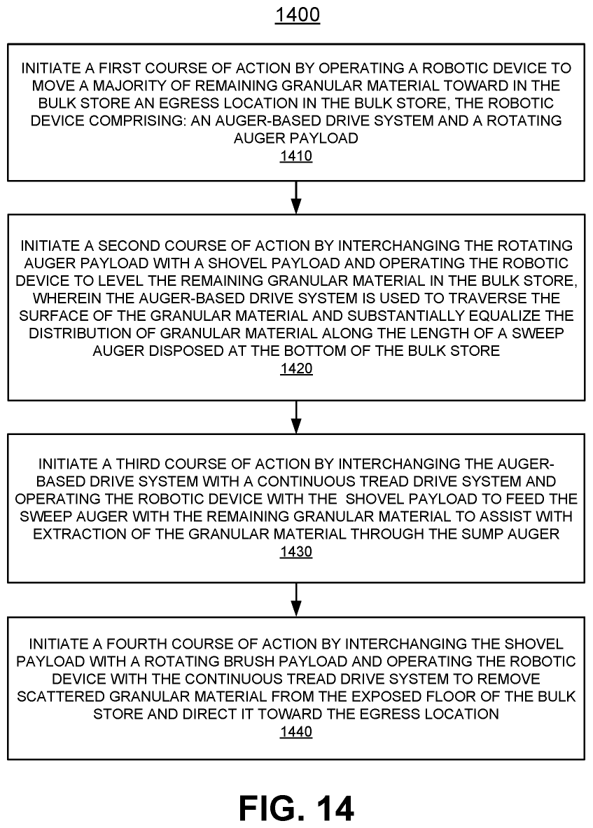

FIG. 14 illustrates a flow diagram 1400 of an example method of cleanout operations in a bulk store. It should be appreciated that the method may include fewer procedures than those illustrated or additional procedures to those illustrated.

At 1410 of flow diagram 1400, a first course of action is initiated by operating a robotic device 900 to move a majority of remaining granular material toward an egress location in the bulk store. The robotic device 900 comprises: an auger-based drive system configured to traverse the surface of the granular material; a rotating auger payload 355 configured to discharge granular material perpendicular to the direction of travel of the robotic device toward the egress location. This first course of action is initiated when most (e.g., more than 90%) of the granular material has been removed and the main mechanism for removal (e.g., a sump auger) has become ineffective, such that secondary methods, such as using a sweep auger, have been employed or are about to be employed.

At 1420, a second course of action is initiated by interchanging the rotating auger payload 355 with a shovel payload 352 and operating the robotic device 900 to level the remaining granular material in the bulk store, wherein the auger-based drive system is used to traverse the surface of the granular material and substantially equalize the distribution of granular material along the length of a sweep auger disposed at the bottom of the bulk store.

At 1430, a third course of action is initiated by interchanging the auger-based drive system with a continuous tread drive system and operating the robotic device 900 with the shovel payload 352 to feed the sweep auger with the remaining granular material to assist with extraction of the granular material through the sump auger; and

At 1440, a fourth course of action is initiated by interchanging the shovel payload 352 with a rotating brush payload 350 and operating the robotic device 900 with the continuous tread drive system to remove scattered granular material from the exposed floor of the bulk store and direct it toward the egress location.

The robotic device 900 operates autonomously or under remote control during the cleanout operations, ensuring flexibility and safety. Autonomous operation allows the robotic device to perform tasks based on pre-programmed instructions or real-time sensor data, while remote control enables an operator to direct the device's actions from outside the bulk store. This dual-mode functionality ensures that the cleanout operations can be tailored to specific requirements while minimizing human exposure to hazardous environments.

The robotic device 900 performs the cleanout operations without requiring human entry into the bulk store, significantly enhancing safety. By automating tasks such as leveling, feeding the sweep auger, and sweeping scattered material, the robotic device reduces the risk of accidents and exposure to dust or other harmful conditions. Additionally, the ability to map the surface of the granular material and measure environmental characteristics such as temperature, moisture, and humidity ensures that the cleanout operations are performed efficiently and effectively.

Throughout the cleanout operations, the rotation speed and direction of the rotating auger payload or the rotating brush payload can be controlled to optimize performance. For example, higher rotation speeds may be used to discharge granular material quickly during the first course of action, while slower speeds may be employed during the fourth course of action to ensure precise sweeping. This level of control allows the robotic device to adapt to varying conditions and requirements, ensuring that the cleanout operations are completed thoroughly and efficiently.

The method is applicable to cleanout of various types of granular materials, including grain (e.g., small hard and typically edible seeds or beans such as soybean seeds, peas, garbanzo beans, pinto beans, corn kernels, wheat, rice, etc.), non-grain plant seeds (e.g., flower seeds and grass seeds), nuts (e.g., shelled or unshelled tree nuts or ground nuts), nut shells, sand, animal litter, concrete mix, cement, dry fertilizer, pelletized products (e.g., wood pellets, plastic pellets, hemp pellets, fish food pellets, etc.) and granular milled/ground products (e.g., flour, soy meal, sugar, coffee, cocoa, guar gum, sodium bicarbonate, alumina, and granular mineral/rock aggregates/products, etc.), among others.

### Succinct Description of Various Aspects

Aspect 1. A method for inciting sediment gravity flow in a pile of granular material using a robotic device, the method comprising: positioning the robotic device proximate to the pile of granular material, wherein the robotic device comprises: a body, an auger-based drive system including a plurality of augers configured to propel and maneuver the robotic device, and an articulable auger payload coupled to the body, the auger payload comprising: a rotatable auger component, and a motorized system configured to control rotation of the rotatable auger component; orienting the rotatable auger component of the auger payload substantially parallel to a slope of the pile of granular material; rotating the rotatable auger component in a first direction to engage the granular material; agitating the granular material via the rotation of the rotatable auger component to incite sediment gravity flow in the pile of granular material; and discharging the engaged granular material downslope from the rotatable auger component to incite/trigger additional sediment gravity flow of the granular material on the pile.

Aspect 2. The method of Aspect 1, wherein the auger payload further comprises a lift arm configured to raise and lower the rotatable auger component, and the method further comprises: lowering the rotatable auger component into the pile of granular material using the lift arm.

Aspect 3. The method of Aspect 1, wherein the robotic device remains stationary while the rotatable auger component operates to discharge granular material downslope.

Aspect 4. The method of Aspect 1, further comprising deploying an anchor or spud from the robotic device into the pile of granular material to assist in maintaining a stationary position of the robotic device.

Aspect 5. The method of Aspect 1, wherein the robotic device traverses crosswise or perpendicular to the slope of the pile of granular material using the auger-based drive system while simultaneously operating the rotatable auger component to discharge granular material downslope.

Aspect 6. The method of Aspect 1, further comprising breaking up crusts or chunks of granular material encountered during traversal of the pile of granular material using the rotatable auger component.

Aspect 7. The method of Aspect 1, wherein the rotatable auger component is configured to discharge granular material to a first lateral side when rotated in a first direction and to a second lateral side when rotated in a second direction opposite to the first direction.

Aspect 8. The method of Aspect 1, further comprising controlling the speed of rotation of the rotatable auger component to adjust the rate of granular material discharge.

Aspect 9. The method of Aspect 1, wherein the robotic device maps the slope of the pile of granular material prior to positioning the rotatable auger component downslope or substantially parallel to the slope.

Aspect 10. The method of Aspect 1, further comprising measuring environmental characteristics of the granular material, including temperature, moisture, or humidity, during operation of the robotic device.

Aspect 11. The method of Aspect 1, wherein the granular material comprises grain, non-grain plant seeds, nuts, pelletized products, or granular mineral products.

Aspect 12. A non-transitory computer-readable medium storing instructions that, when executed by a processor of a robotic device, cause the robotic device to perform a method for inciting sediment gravity flow in a pile of granular material, the method comprising: positioning the robotic device proximate to the pile of granular material, wherein the robotic device comprises: a body, an auger-based drive system including a plurality of augers configured to propel and maneuver the robotic device, and an articulable auger payload coupled to the body, the auger payload comprising: a rotatable auger component, a lift arm configured to raise and lower the rotatable auger component, and a motorized system configured to control rotation of the rotatable auger component; orienting the rotatable auger component of the auger payload downslope or substantially parallel to a slope of the pile of granular material; lowering the rotatable auger component into the pile of granular material using the lift arm; rotating the rotatable auger component in a first direction to engage the granular material and discharge the granular material downslope of the pile; agitating the granular material with the rotatable auger component to incite sediment gravity flow in the pile of granular material; and discharging the granular material downslope to trigger additional sediment gravity flow or an avalanche of the granular material.

Aspect 13. A robotic device for inciting sediment gravity flow in a pile of granular material, the device comprising: a body; an auger-based drive system coupled to the body, the auger-based drive system comprising: a plurality of augers configured to propel and maneuver the robotic device relative to the pile of granular material; an articulable auger payload coupled to the body, the auger payload comprising: a rotatable auger component configured to engage and discharge granular material, a lift arm configured to raise and lower the rotatable auger component, a motorized system configured to control rotation of the rotatable auger component, including the direction and speed of rotation; and a processor communicatively coupled to the auger-based drive system and the articulable auger payload, the processor configured to: control movement of the robotic device via the auger-based drive system, such that the rotatable auger component of the auger payload is oriented downslope or substantially parallel to a slope of the pile of granular material, lower the rotatable auger component into the pile of granular material using the lift arm, rotate the rotatable auger component to discharge granular material downslope, and incite sediment gravity flow in the pile of granular material by agitating the granular material with the rotatable auger component.

Aspect 14. The robotic device of Aspect 13, further comprising an anchor or spud configured to deploy into the pile of granular material to assist in maintaining a stationary position of the robotic device during operation of the articulable auger payload.

Aspect 15. The robotic device of Aspect 13, wherein the processor is further configured to control the robotic device to traverse crosswise or perpendicular to the slope of the pile of granular material using the auger-based drive system while simultaneously operating the rotatable auger component to discharge granular material downslope.

Aspect 16. The robotic device of Aspect 13, wherein the rotatable auger component is configured to discharge granular material to a first lateral side when rotated in a first direction and to a second lateral side when rotated in a second direction opposite to the first direction.

Aspect 17. The robotic device of Aspect 13, wherein the processor is further configured to control the speed of rotation of the rotatable auger component to adjust the rate of granular material discharge.

Aspect 18. The robotic device of Aspect 13, wherein the auger-based drive system comprises bilateral augers configured to propel the robotic device atop the pile of granular material.

Aspect 19. The robotic device of Aspect 13, wherein the granular material comprises grain, non-grain plant seeds, nuts, pelletized products, or granular mineral products.

Aspect 20. A robot comprising: a body; an auger-based drive system coupled to the body and comprising a plurality of augers configured to propel and maneuver the robot relative to a pile of granular material; an auger payload coupled to the body and comprising: a rotatable auger component configured to engage granular material and discharge the engaged granular material; a motorized control system configured to control rotation of the rotatable auger component; a processor coupled to the auger-based drive system, the auger payload, and the anchor and configured to: control the auger-based drive system to position the rotatable auger component downslope or substantially parallel to the slope of the pile of granular material; and control rotation of the rotatable auger component to discharge granular material downslope from a lateral side of the rotatable auger.

Aspect 22. The robotic device of Aspect 20, further comprising an anchor or spud configured to deploy into the pile of granular material to assist in maintaining a stationary position of the robotic device during operation of the articulable auger payload.

Aspect 23. A method for performing cleanout operations in a bulk store containing granular material, comprising: initiating a first course of action by operating a robotic device to move a majority of the remaining granular material toward an egress location in the bulk store, the robotic device comprising a front-mounted payload implement, the egress location comprising one of a sump auger, a sweep auger, or an opening for removal of granular material; initiating a second course of action by leveling the remaining granular material in the bulk store using the robotic device to substantially equalize the distribution of granular material along the length of a sweep auger disposed at the bottom of the bulk store; initiating a third course of action by operating the robotic device to feed the sweep auger with the remaining granular material to assist with extraction of the granular material through the sump auger; and initiating a fourth course of action by operating the robotic device to remove scattered granular material from the exposed floor of the bulk store and direct it toward the egress location. This method facilitates moving and managing granular material in a bulk store. Such cleanout operations are typically performed when more than 90 percent of the granular material has been removed from a bulk store; for example, they would be employed during and/or just before the employment of a sweep auger to feed a sump auger in a bulk store. One or more portions of this method may be implemented as a non-transitory computer-readable medium upon which instructions are stored, and the stored instructions, when executed by one or more processors, cause a robotic device to perform aspects of the method.

Aspect 24. The method of Aspect 23, wherein the front-mounted payload implement comprises one of a rotating auger payload, a shovel payload, or a rotating brush payload.

Aspect 25. The method of Aspect 23, wherein the robotic device is configured to interchange the front-mounted payload implement between the first, second, third, and fourth courses of action to optimize cleanout operations.

Aspect 26. The method of Aspect 23, wherein the first course of action comprises: operating the rotating auger payload to discharge granular material perpendicular to the direction of travel of the robotic device toward the egress location.

Aspect 27. The method of Aspect 23, wherein the second course of action comprises: operating the robotic device to traverse the surface of the granular material and level the granular material using the front-mounted payload implement.

Aspect 28. The method of Aspect 23, wherein the third course of action comprises: operating the shovel payload to push granular material toward the sweep auger to assist with extraction.

Aspect 29. The method of Aspect 23, wherein the fourth course of action comprises: operating the rotating brush payload to sweep scattered granular material toward the egress location.

Aspect 30. The method of Aspect 23, further comprising: switching the drive system of the robotic device between an auger-based surface interface portion and a continuous tread surface interface portion based on the surface type encountered during the cleanout operations.

Aspect 31. The method of Aspect 23, wherein the leveling operation in the second course of action prevents imbalanced loading on the sweep auger during extraction.

Aspect 32. The method of Aspect 23, wherein the robotic device operates autonomously or under remote control during the cleanout operations.

Aspect 33. The method of Aspect 23, further comprising: mapping the surface of the granular material during the second course of action to determine the distribution of granular material and adjust leveling operations accordingly.

Aspect 34. The method of Aspect 23, wherein the robotic device performs the cleanout operations without requiring human entry into the bulk store.

Aspect 35. The method of Aspect 23, further comprising: controlling the rotation speed and direction of the rotating auger payload or the rotating brush payload during the cleanout operations.

Aspect 36. The method of Aspect 23, wherein the robotic device is configured to assist with rehydration of granular material prior to extraction during the third course of action.

Aspect 37. The method of Aspect 23, wherein the robotic device is configured to perform the fourth course of action by collecting granular material samples from the exposed floor of the bulk store.

Aspect 38. A system for cleanout of a bulk store containing granular material, comprising: a robotic device configured to traverse a surface of the granular material, the robotic device comprising: a body; a drive system coupled to the body, the drive system comprising one of an auger-based surface interface portion or a continuous tread surface interface portion, wherein the auger-based surface interface portion and the continuous tread surface interface portion are interchangeable to adapt the robotic device to different operating conditions; a front-mounted payload implement coupled to the body, the front-mounted payload implement comprising one of a rotating auger payload, a shovel payload, or a rotating brush payload, wherein the front-mounted payload implement is configured to move granular material toward an egress location in the bulk store; a processor coupled to the body and configured to control the drive system and the front-mounted payload implement; and a memory coupled to the processor, the memory storing instructions executable by the processor to: direct the robotic device to traverse the surface of the granular material; operate the front-mounted payload implement to move granular material toward the egress location; and perform cleanout operations in the bulk store.

Aspect 39. The system of Aspect 38, wherein the front-mounted payload implement is configured to be articulable in at least one dimension, such that the robotic device can raise or lower the front-mounted payload implement.

Aspect 40. The system of Aspect 38, wherein the rotating auger payload is configured to discharge granular material perpendicular to the direction of travel of the robotic device.

Aspect 41. The system of Aspect 38, wherein the shovel payload is configured to lift, carry, and push granular material toward the egress location.

Aspect 42. The system of Aspect 38, wherein the rotating brush payload is configured to sweep granular material forward or backward relative to the direction of travel of the robotic device.

Aspect 43. The system of Aspect 38, wherein the drive system is configured to switch between the auger-based surface interface portion and the continuous tread surface interface portion based on the surface type in the bulk store.

Aspect 44. The system of Aspect 38, wherein the memory further stores instructions executable by the processor to perform a leveling operation to substantially equalize the distribution of granular material along the length of a sweep auger disposed at the bottom of the bulk store.

Aspect 45. The system of Aspect 38, wherein the memory further stores instructions executable by the processor to perform a cleanout operation comprising: removing scattered granular material from the exposed floor of the bulk store; and directing the granular material toward the egress location.

Aspect 46. The system of Aspect 38, wherein the robotic device is configured to interchange the front-mounted payload implement to adapt to different cleanout operations.

Aspect 47. The system of Aspect 38, wherein the processor is configured to control the rotation speed and direction of the rotating auger payload or the rotating brush payload.

Aspect 48. The system of Aspect 38, wherein the robotic device is configured to operate autonomously or under remote control to perform cleanout operations.

Aspect 49. The system of Aspect 38, wherein the egress location comprises a sump auger, and the robotic device is configured to feed granular material into the sump auger during cleanout operations.

Aspect 50. The system of Aspect 38, wherein the robotic device is configured to map the surface of the granular material during traversal and adjust its operations based on the mapped surface contours.

Aspect 51. The system of Aspect 38, wherein the robotic device is configured to prevent imbalanced loading on the sweep auger during cleanout operations by equalizing the distribution of granular material along the sweep auger.

Aspect 52. The system of Aspect 38, wherein the robotic device is configured to perform cleanout operations without requiring human entry into the bulk store.

Aspect 53. A method for performing cleanout operations in a bulk store containing granular material, comprising: initiating a first course of action by operating a robotic device to move a majority of remaining granular material toward the bulk store's egress location in the bulk store, the robotic device comprising: an auger-based drive system configured to traverse the surface of the granular material; and a front-mounted rotating auger payload configured to discharge granular material perpendicular to the direction of travel of the robotic device toward the egress location; initiating a second course of action by interchanging the front-mounted rotating auger payload with a front-mounted shovel payload and operating the robotic device to level the remaining granular material in the bulk store, wherein the auger-based drive system is used to traverse the surface of the granular material and substantially equalize the distribution of granular material along the length of a sweep auger disposed at the bottom of the bulk store; initiating a third course of action by interchanging the auger-based drive system with a continuous tread drive system and operating the robotic device with the front-mounted shovel payload to feed the sweep auger with the remaining granular material to assist with extraction of the granular material through the sump auger; and initiating a fourth course of action by interchanging the front-mounted shovel payload with a front-mounted rotating brush payload and operating the robotic device with the continuous tread drive system to remove scattered granular material from the exposed floor of the bulk store and direct it toward the egress location. This method facilitates moving and managing granular material in a bulk store. Such cleanout operations are typically performed when more than 90 percent of the granular material has been removed from a bulk store; for example, they would be employed during and/or just before the employment of a sweep auger to feed a sump auger in a bulk store. One or more portions of this method may be implemented as a non-transitory computer-readable medium upon which instructions are stored and the stored instructions, when executed by one or more processors, cause a robotic device to perform aspects of the method.

### Conclusion

The examples set forth herein were presented in order to best explain, to describe particular applications, and to thereby enable those skilled in the art to make and use embodiments of the described examples. However, those skilled in the art will recognize that the foregoing description and examples have been presented for the purposes of illustration and example only. The description as set forth is not intended to be exhaustive or to limit the embodiments to the precise form disclosed. Rather, the specific features and acts described above are disclosed as example forms of implementing the claims.

Reference throughout this document to “one embodiment,” “certain embodiments,” “an embodiment,” “various embodiments,” “some embodiments,” or similar term means that a particular feature, structure, or characteristic described in connection with the embodiment is included in at least one embodiment. Thus, the appearances of such phrases in various places throughout this specification are not necessarily all referring to the same embodiment. Furthermore, the particular features, structures, or characteristics of any embodiment may be combined in any suitable manner with one or more other features, structures, or characteristics of one or more other embodiments without limitation.

What is claimed:

1. A method for moving granular material using a robotic device, the method comprising:
positioning the robotic device proximate to a pile of granular material, wherein the robotic device comprises:
a body,
an auger-based drive system coupled with the body and including a plurality of augers configured to propel and maneuver the robotic device, and
an auger payload coupled with the body, the auger payload comprising:
a rotatable auger component, and
a motorized system configured to control rotation of the rotatable auger component;
orienting the rotatable auger component of the auger payload substantially parallel to a slope of the pile of granular material;
rotating the rotatable auger component in a first direction to engage the granular material;
agitating the granular material with the rotation of the rotatable auger component to incite sediment gravity flow in the pile of granular material; and
discharging the engaged granular material downslope from the rotatable auger component to both move material downslope and incite additional sediment gravity flow of the granular material on the pile of granular material.

2. The method of claim 1, wherein the auger payload further comprises a lift arm configured to raise and lower the rotatable auger component, and the method further comprises:
lowering the rotatable auger component into the pile of granular material using the lift arm.

3. The method of claim 1, wherein the robotic device remains substantially stationary while the rotatable auger component operates to discharge granular material downslope.

4. The method of claim 1, further comprising:
deploying a spud to anchor the robotic device into the pile of granular material to assist in maintaining a substantially stationary position of the robotic device.

5. The method of claim 1, further comprising:
traversing crosswise to the slope of the pile of granular material using the auger-based drive system while simultaneously operating the rotatable auger component to discharge granular material downslope.

6. The method of claim 1, further comprising:
breaking up crusts or chunks of granular material, of the pile of granular material, encountered during traversal of the pile of granular material using the rotatable auger component.

7. The method of claim 1, wherein the rotatable auger component is configured to discharge the engaged granular material to a first lateral side when rotated in the first direction and to a second lateral side when rotated in a second direction opposite to the first direction.

8. A non-transitory computer-readable medium storing instructions that, when executed by a processor of a robotic device, cause the robotic device to perform a method of moving granular material, the method comprising:
positioning the robotic device proximate to a pile of granular material, wherein the robotic device comprises:
a body,
an auger-based drive system coupled with the body and including a plurality of augers configured to propel and maneuver the robotic device, and
an auger payload coupled with the body, the auger payload comprising:
a rotatable auger component,
a lift arm configured to raise and lower the rotatable auger component, and
a motorized system configured to control rotation of the rotatable auger component;
orienting the rotatable auger component of the auger payload substantially parallel to a slope of the pile of granular material;
lowering the rotatable auger component into the pile of granular material using the lift arm;
rotating the rotatable auger component in a first direction to engage the granular material;
agitating the granular material with the rotatable auger component to incite sediment gravity flow in the pile of granular material; and
discharging the engaged granular material downslope to trigger additional sediment gravity flow of the granular material.

9. The non-transitory computer-readable medium as recited in claim 8, further comprising:
deploying a spud to anchor the robotic device into the pile of granular material to assist in maintaining a substantially stationary position of the robotic device.

10. The non-transitory computer-readable medium as recited in claim 8, further comprising:
traversing crosswise to the slope of the pile of granular material using the auger-based drive system while simultaneously operating the rotatable auger component to discharge granular material downslope.

11. The non-transitory computer-readable medium as recited in claim 8, further comprising:
breaking up crusts or chunks of granular material, of the pile of granular material, encountered during traversal of the pile of granular material using the rotatable auger component.

12. A robotic device for inciting sediment gravity flow in a pile of granular material, the robotic device comprising:
a body;
an auger-based drive system coupled with the body and comprising a plurality of augers configured to propel and maneuver the robotic device relative to the pile of granular material;
an auger payload coupled to the body and comprising:
a rotatable auger component configured to engage and discharge granular material, and
a motorized system configured to control rotation of the rotatable auger component, including a direction and a speed of rotation; and
a processor communicatively coupled to the auger-based drive system and the auger payload, the processor configured to:
control movement of the robotic device via the auger-based drive system, such that the rotatable auger component of the auger payload is oriented substantially parallel to a slope of the pile of granular material,
rotate the rotatable auger component to engage the granular material and discharge the engaged granular material downslope, and
incite sediment gravity flow in the pile of granular material by agitating the granular material with the rotatable auger component.

13. The robotic device of claim 12, further comprising a lift arm coupled with the auger payload and configured to raise and lower the rotatable auger component relative to the pile of granular material.

14. The robotic device of claim 12, further comprising a spud configured to deploy into the pile of granular material to assist in maintaining a substantially stationary position of the robotic device during operation of the auger payload.

15. The robotic device of claim 12, wherein the processor is further configured to control the auger-based drive system to perform station keeping to maintain a substantially stationary position of the robotic device during operation of the auger payload.

16. The robotic device of claim 12, wherein the processor is further configured to control the robotic device to traverse crosswise to the slope of the pile of granular material using the auger-based drive system while simultaneously operating the rotatable auger component to discharge the engaged granular material downslope.

17. The robotic device of claim 12, wherein the rotatable auger component is configured to discharge granular material to a first lateral side when rotated in a first direction and to a second lateral side when rotated in a second direction opposite to the first direction.

18. The robotic device of claim 12, wherein the processor is further configured to control the speed of rotation of the rotatable auger component to adjust a rate of discharge of the engaged granular material.

19. The robotic device of claim 12, wherein the auger-based drive system comprises bilateral augers configured to propel the robotic device atop the pile of granular material.

20. The robotic device of claim 12, wherein the granular material comprises one of grain, non-grain plant seeds, nuts, pelletized products, or granular mineral products.
